(19) United States
(12) Patent Application Publication
(10) Pub. No.: US 2026/0112311 A1
(43) Pub. Date: Apr. 23, 2026

(54) DISPLAY PANEL AND DISPLAY DEVICE

(71) Applicant: Xiamen Tianma Optoelectronics Co., Ltd., Xiamen (CN)

(72) Inventors: Mingshui Cai, Xiamen (CN); Hongtao Huang, Xiamen (CN); Dongquan Hou, Xiamen (CN); Yong Zeng, Xiamen (CN); Huasheng Yan, Xiamen (CN)

(73) Assignee: Xiamen Tianma Optoelectronics Co., Ltd., Xiamen (CN)

(21) Appl. No.: 19/428,602

(22) Filed: Dec. 22, 2025

(30) Foreign Application Priority Data
Aug. 26, 2025 (CN) 202511202724.9

(51) Int. Cl. G09G 3/32

(52) U.S. Cl. CPC G09G 3/32; G09G 2300/0426; G09G 2300/0842; G09G 2310/0286; G09G 2310/08; G09G 2330/021; G09G 2340/0435

(57) ABSTRACT

A display panel includes a shift register, multiple stage transfer clock lines and scan clock lines. The shift register includes multiple cascaded shift register units each including an input circuit, a stage transfer output circuit and a scan output circuit. The input circuit is electrically connected to an input terminal and a first node. The stage transfer output circuit is electrically connected to the first node, a stage transfer clock terminal, and a stage transfer output terminal. The stage transfer output terminal of the i-th stage shift register unit is electrically connected to the input terminal of the j-th stage shift register unit. The scan output circuit is electrically connected to the first node, a scan clock terminal, and a scan output terminal. The stage transfer clock terminal is electrically connected to the stage transfer clock line, and the scan clock terminal is electrically connected to the scan clock line.

### CROSS-REFERENCE TO RELATED APPLICATION

The present application claims priority to Chinese Patent Application No. 202511202724.9, filed with the China National Intellectual Property Administration (CNIPA) on Aug. 26, 2025, the disclosure of which is incorporated herein by reference in its entirety.

### TECHNICAL FIELD

The present disclosure relates to the field of display technology and, in particular, to a display panel and a display device.

### BACKGROUND

The existing display panel usually includes at least one shift register. One shift register consists of multiple cascaded shift register units. When the display panel displays an image, the multiple shift register units of the shift register output scan signals that are shifted in sequence, thereby achieving the row-by-row refresh of the pixels.

In the existing architecture, to ensure that all the shift register units can work normally, all the shift register units need to output effective pulses of the scan signals, that is, during the pixel refresh time of one display frame, the shift register refreshes all the pixel rows, making it impossible to selectively refresh or hold arbitrary pixel rows of the display panel, resulting in higher power consumption.

### SUMMARY

The present disclosure provides a display panel and a display device to achieve the high-frequency or low-frequency refresh of any row, thereby reducing the power consumption of the display panel.

According to an aspect of the present disclosure, a display panel is provided. The display panel includes a shift register, multiple stage transfer clock lines, and multiple scan clock lines, where the shift register includes multiple cascaded shift register units, the stage transfer clock line is used for transmitting a stage transfer clock signal, and the scan clock line is used for transmitting a scan clock signal.

The shift register unit includes an input circuit, a stage transfer output circuit, and a scan output circuit.

The input circuit is electrically connected to an input terminal and a first node separately, and the input circuit is used for controlling a signal at the first node according to an input signal at the input terminal.

The stage transfer output circuit is electrically connected to the first node, a stage transfer clock terminal, and a stage transfer output terminal separately, and the stage transfer output circuit is used for controlling, according to the signal at the first node and a signal at the stage transfer clock terminal, a stage transfer signal output from the stage transfer output terminal, where the stage transfer output terminal of the i-th stage shift register unit is electrically connected to the input terminal of the j-th stage shift register unit, i≠j, and i and j are both positive integers.

The scan output circuit is electrically connected to the first node, a scan clock terminal, and a scan output terminal separately, and the scan output circuit is used for controlling, according to the signal at the first node and a signal at the scan clock terminal, a scan signal output from the scan output terminal.

The stage transfer clock terminal is electrically connected to the stage transfer clock line, and the scan clock terminal is electrically connected to the scan clock line.

According to another aspect of the present disclosure, a display device is provided. The display device includes the preceding display panel.

In the technical solutions of the present disclosure, the stage transfer output circuit and the scan output circuit are disposed in the shift register unit, the stage transfer output circuit is connected to the stage transfer clock line via the stage transfer clock terminal, and the scan output circuit is connected to the scan clock line via the scan clock terminal so that the stage transfer output circuit and the scan output circuit can receive different clock signals (the stage transfer clock signal and the scan clock signal). Therefore, the stage transfer signal from the stage transfer output terminal and the scan signal from the scan output terminal can be independent of each other and do not affect each other. That is, during the pixel refresh time of one display frame, the scan signal is at an invalid level, the normal transition of the stage transfer signal to a valid level is not affected, and the sequential driving of the shift register units is not affected. In this manner, during the pixel refresh time of the display frame, when any shift register unit stops outputting the effective pulse of the scan signal, it can still be ensured that all shift register units can work normally. While the display requirements of smooth video display are satisfied, high frequency or low frequency for any row can be achieved, which is conducive to the low power consumption of the display panel.

It is to be understood that the content described in this section is neither intended to identify key or critical features of the embodiments of the present disclosure nor intended to limit the scope of the present disclosure. Other features of the present disclosure become easily understood through the description provided below.

### BRIEF DESCRIPTION OF DRAWINGS

To illustrate the technical solutions in the embodiments of the present disclosure more clearly, the drawings used in the description of the embodiments are briefly described below. Apparently, the drawings described below illustrate part of the embodiments of the present disclosure, and those of ordinary skill in the art may obtain other drawings based on the drawings described below on the premise that no creative work is done.

FIG. 1 is top diagram one of a display panel according to an embodiment of the present disclosure.

FIG. 2 is schematic diagram one of a circuit structure of a pixel according to an embodiment of the present disclosure.

FIG. 3 is schematic diagram two of a circuit structure of a pixel according to an embodiment of the present disclosure.

FIG. 4 is schematic diagram one of circuit structures of shift register units according to an embodiment of the present disclosure.

FIG. 5 is timing diagram one of a shift register according to an embodiment of the present disclosure.

FIG. 6 is timing diagram one of a display panel in a multi-frequency drive display mode according to an embodiment of the present disclosure.

FIG. 7 is timing diagram two of a display panel in a multi-frequency drive display mode according to an embodiment of the present disclosure.

FIG. 8 is timing diagram one of a shift register unit according to an embodiment of the present disclosure.

FIG. 9 is schematic diagram two of a circuit structure of a shift register unit according to an embodiment of the present disclosure.

FIG. 10 is schematic diagram three of circuit structures of shift register units according to an embodiment of the present disclosure.

FIG. 11 is schematic diagram one of a circuit structure of a shift register according to an embodiment of the present disclosure.

FIG. 12 is schematic diagram two of a circuit structure of a shift register according to an embodiment of the present disclosure.

FIG. 13 is schematic diagram three of a circuit structure of a shift register according to an embodiment of the present disclosure.

FIG. 14 is schematic diagram four of a circuit structure of a shift register according to an embodiment of the present disclosure.

FIG. 15 is timing diagram two of a shift register according to an embodiment of the present disclosure.

FIG. 16 is timing diagram three of a shift register according to an embodiment of the present disclosure.

FIG. 17 is timing diagram four of a shift register according to an embodiment of the present disclosure.

FIG. 18 is timing diagram five of a shift register according to an embodiment of the present disclosure.

FIG. 19 is timing diagram six of a shift register according to an embodiment of the present disclosure.

FIG. 20 is timing diagram seven of a shift register according to an embodiment of the present disclosure.

FIG. 21 is timing diagram eight of a shift register according to an embodiment of the present disclosure.

FIG. 22 is schematic diagram four of a circuit structure of a shift register unit according to an embodiment of the present disclosure.

FIG. 23 is timing diagram two of a shift register unit according to an embodiment of the present disclosure.

FIG. 24 is schematic diagram five of a circuit structure of a shift register unit according to an embodiment of the present disclosure.

FIG. 25 is schematic diagram six of a circuit structure of a shift register unit according to an embodiment of the present disclosure.

FIG. 26 is schematic diagram seven of a circuit structure of a shift register unit according to an embodiment of the present disclosure.

FIG. 27 is schematic diagram eight of a circuit structure of a shift register unit according to an embodiment of the present disclosure.

FIG. 28 is schematic diagram five of a circuit structure of a shift register according to an embodiment of the present disclosure.

FIG. 29 is schematic diagram six of a circuit structure of a shift register according to an embodiment of the present disclosure.

FIG. 30 is schematic diagram seven of a circuit structure of a shift register according to an embodiment of the present disclosure.

FIG. 31 is top diagram two of a display panel according to an embodiment of the present disclosure.

FIG. 32 is top diagram three of a display panel according to an embodiment of the present disclosure.

FIG. 33 is schematic diagram one of a film structure of a display panel according to an embodiment of the present disclosure.

FIG. 34 is schematic diagram two of a film structure of a display panel according to an embodiment of the present disclosure.

FIG. 35 is schematic diagram three of a film structure of a display panel according to an embodiment of the present disclosure.

FIG. 36 is a structural view of a display device according to an embodiment of the present disclosure.

### DETAILED DESCRIPTION

To make the technical solutions of the present disclosure better understood by those skilled in the art, the technical solutions in the embodiments of the present disclosure are described below clearly and completely in conjunction with the drawings in the embodiments of the present disclosure. Apparently, the embodiments described below are part, not all, of the embodiments of the present disclosure. Based on the embodiments of the present disclosure, all other embodiments obtained by those of ordinary skill in the art are within the scope of the present disclosure on the premise that no creative work is done.

It is to be noted that the terms “first”, “second”, and the like in the description, claims, and preceding drawings of the present disclosure are used to distinguish between similar objects and are not necessarily used to describe a particular order or sequence. It is to be understood that data used in this manner are interchangeable where appropriate so that the embodiments of the present disclosure described herein can be implemented in an order not illustrated or described herein. In addition, terms “comprising”, “including” and any variation thereof are intended to encompass a non-exclusive inclusion. For example, a process, method, system, product, or device that includes a series of steps or units not only includes the expressly listed steps or units, but may also include other steps or units that are not expressly listed or are inherent to such a process, method, product, or device.

As mentioned in the background, when the display panel displays an image, during the pixel refresh time of one display frame, all shift register units of the shift register may work normally to control all pixel rows to be refreshed; or all shift register units of the shift register may stop working to control all pixel rows to stop being refreshed. During the pixel refresh time of one display frame, the refresh frequency of all pixel rows of the display panel is consistent. If the refresh frequency of the display panel is reduced to reduce the power consumption of the display panel, although the power consumption can be reduced, the display requirements of smooth video display cannot be satisfied. If the display requirements of smooth video display are satisfied, the refresh frequency of all pixel rows of the display panel needs to be increased, which is detrimental to reducing the power consumption of the display panel.

To solve the preceding technical problems, the embodiment of the present disclosure provides a display panel. The display panel includes a shift register, multiple stage transfer clock lines, and multiple scan clock lines. The shift register includes multiple cascaded shift register units. The stage transfer clock line is used for transmitting a stage transfer clock signal. The scan clock line is used for transmitting a scan clock signal. The shift register unit includes an input circuit, a stage transfer output circuit, and a scan output circuit. The input circuit is electrically connected to an input terminal and a first node separately. The input circuit is used for controlling a signal at the first node according to an input signal at the input terminal. The stage transfer output circuit is electrically connected to the first node, a stage transfer clock terminal, and a stage transfer output terminal separately. The stage transfer output circuit is used for controlling, according to the signal at the first node and a signal at the stage transfer clock terminal, a stage transfer signal output from the stage transfer output terminal. The stage transfer output terminal of the i-th stage shift register unit is electrically connected to the input terminal of the j-th stage shift register unit, i≠j, and i and j are both positive integers. The scan output circuit is electrically connected to the first node, a scan clock terminal, and a scan output terminal separately. The scan output circuit is used for controlling, according to the signal at the first node and a signal at the scan clock terminal, a scan signal output from the scan output terminal. The stage transfer clock terminal is electrically connected to the stage transfer clock line, and the scan clock terminal is electrically connected to the scan clock line.

The preceding technical solutions are adopted. The stage transfer output circuit and the scan output circuit are disposed in the shift register unit, the stage transfer output circuit is connected to the stage transfer clock line via the stage transfer clock terminal, and the scan output circuit is connected to the scan clock line via the scan clock terminal so that the stage transfer output circuit and the scan output circuit can receive different clock signals (the stage transfer clock signal and the scan clock signal). Therefore, the stage transfer signal from the stage transfer output terminal and the scan signal from the scan output terminal can be independent of each other and do not affect each other. That is, during the pixel refresh time of one display frame, the scan signal is at an invalid level, the normal transition of the stage transfer signal to a valid level is not affected, and the sequential driving of the shift register units is not affected. In this manner, during the pixel refresh time of the display frame, when any shift register unit stops outputting the effective pulse of the scan signal, it can still be ensured that all shift register units can work normally. While the display requirements of smooth video display are satisfied, high frequency or low frequency for any row can be achieved, which is conducive to the low power consumption of the display panel.

The preceding is the core idea of the present disclosure. Based on the embodiments of the present disclosure, all other embodiments obtained by those of ordinary skill in the art are within the scope of the present disclosure on the premise that no creative work is done. The technical solutions in the embodiments of the present disclosure are described clearly and completely in conjunction with the drawings in the embodiments of the present disclosure.

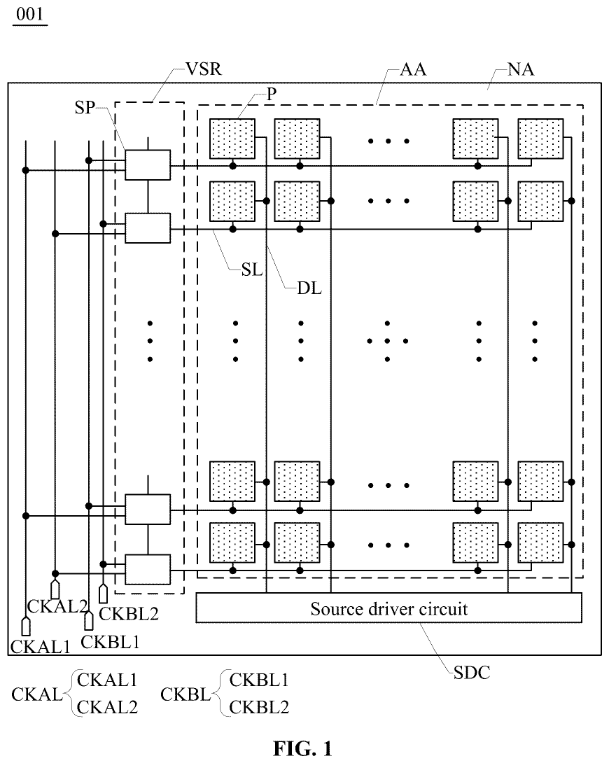

FIG. 1 is top diagram one of a display panel according to an embodiment of the present disclosure. Referring to FIG. 1, a display panel 001 includes a shift register VSR located in a non-display region NA, multiple stage transfer clock lines CKAL (CKAL1 and CKAL2), and multiple scan clock lines CKBL (CKBL1 and CKBL2). The shift register VSR includes multiple cascaded shift register units SP. One shift register unit SP is electrically connected to both the stage transfer clock line CKAL and the scan clock line CKBL. Multiple shift register units SP may be electrically connected to the same stage transfer clock line CKAL or the same scan clock line CKBL. The stage transfer clock line CKAL is used for transmitting a stage transfer clock signal, and the scan clock line CKBL is used for transmitting a scan clock signal.

The display panel 001 further includes multiple pixels P in a display region AA, multiple scan lines SL, and multiple data lines DL. At least some of the pixels P located in the same row may be electrically connected to the same scan line SL, and at least some of the pixels P located in the same column may be electrically connected to the same data line DL. The scan line SL is used for transmitting a scan signal, and the data line DL is used for transmitting a data signal.

In the shift register VSR, one or more shift register units located at the head end or the tail end (for example, a shift register including both forward scanning and reverse scanning) can receive a start signal as a start input signal. For example, the case where one stage shift register unit can receive the start signal as the start input signal is used as an example. The first stage shift register unit SP may receive the start signal as the start input signal. Starting from the second stage, the start input signal of each stage shift register unit SP may come from the previous stage shift register unit SP, but is not limited to the previous stage shift register unit SP. The scan signals output by the shift register units SP can be shifted in sequence. The shift register unit SP is electrically connected to at least one scan line SL to provide the scan signal for the scan line SL. For example, when the scan signal transmitted by the scan line SL is at a valid level, the switching devices in one row of pixels P electrically connected to the scan line SL may be controlled to be turned on so that the one row of pixels P electrically connected to the scan line SL can receive data signals transmitted by the data lines DL and display corresponding grayscale according to the data signals, thereby refreshing the pixels P electrically connected to the scan line SL.

In one or more embodiments, the display panel 001 further includes a source driver circuit SDC located in the non-display region NA and the source driver circuit SDC is electrically connected to the multiple data lines DL to provide data signals for the data lines DL. For example, during the pixel refresh time of one row of pixels P, the source driver circuit SDC can provide multiple data signals for the multiple data lines DL so that the data signal voltage provided by the source driver circuit SDC is written into each pixel P in this row. During the pixel refresh time of the next row of pixels P, the source driver circuit SDC can provide multiple data signals for the multiple data lines DL so that the data signal voltage provided by the source driver circuit SDC is written into each pixel P in the next row.

It is to be noted that FIG. 1 only exemplarily shows that the shift register VSR is located in the non-display region NA outside the display region AA. In other feasible embodiments, the shift register VSR may be located in the display region AA. In addition, the figure only exemplarily shows that the shift register VSR is located on the left side of the display region AA. In other feasible embodiments, the shift register VSR may be located on another side of the display region AA, or shift registers VSR are located on at least two sides of the left side, the right side, the top side, and the bottom side of the display region AA. In the embodiment in which the shift registers VSR are located on the left side and the right side of the display region AA separately, the same scan line SL may be connected to the shift registers VSR located on the left side and the right side of the display region AA separately; or the same scan line SL is connected to one of the shift register VSR located on the left side of the display region AA or the shift register VSR located on the right side of the display region AA, and the scan lines SL connected to the shift register VSR located on the left side of the display region AA and the scan lines SL connected to the shift register VSR located on the right side of the display region AA are alternately arranged in the display region. The specific position of the shift register VSR is not specifically limited in the embodiment of the present disclosure.

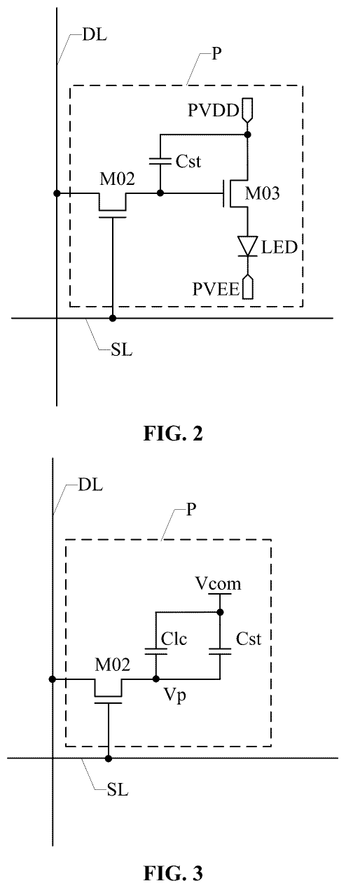

FIG. 2 is schematic diagram one of a circuit structure of a pixel according to an embodiment of the present disclosure. FIG. 3 is schematic diagram two of a circuit structure of a pixel according to an embodiment of the present disclosure. If the display panel 001 operates as a light-emitting diode (LED) display, the pixel P may include a write transistor M02, a drive transistor M03, a storage capacitor Cst, an LED, a first power supply terminal PVDD, and a second power supply terminal PVEE. In this case, the pixel P may receive the scan signal from the scan line SL, the data signal from the data line DL, a first power signal from a first power line (not shown in the figure), and a second power signal from a second power line (not shown in the figure). As shown in FIG. 2, controlled by the scan signal from the scan line SL, the write transistor M02 can write the data signal from the data line DL into the gate of the drive transistor M03. According to the data signal, the drive transistor M03 provides the corresponding drive current for the LED to drive the LED to emit light so that the pixel P displays the corresponding grayscale. If the display panel 001 operates as a liquid crystal display, the pixel P may include a write transistor M02, a liquid crystal capacitor Clc, a pixel electrode Vp, and a common electrode Vcom. In this case, the pixel P receives the scan signal from the scan line SL, the data signal from the data line DL, and a common electrode signal. As shown in FIG. 3, controlled by the scan signal, the write transistor M02 can write the data signal into the pixel electrode Vp, the liquid crystal capacitor Clc can store the data signal on the pixel electrode Vp, and an electric field is formed between the pixel electrode Vp and the common electrode Vcom and can control the rotation of the liquid crystal molecules (not shown in the figure) to adjust the luminous flux so that the pixel P displays the corresponding grayscale.

It is to be noted that FIGS. 2 and 3 each exemplarily illustrate the circuit structure of the pixel P. In other feasible embodiments, the pixel P may include other components. Embodiments of the present disclosure do not limit the type of display panel or the specific structure of the pixel P.

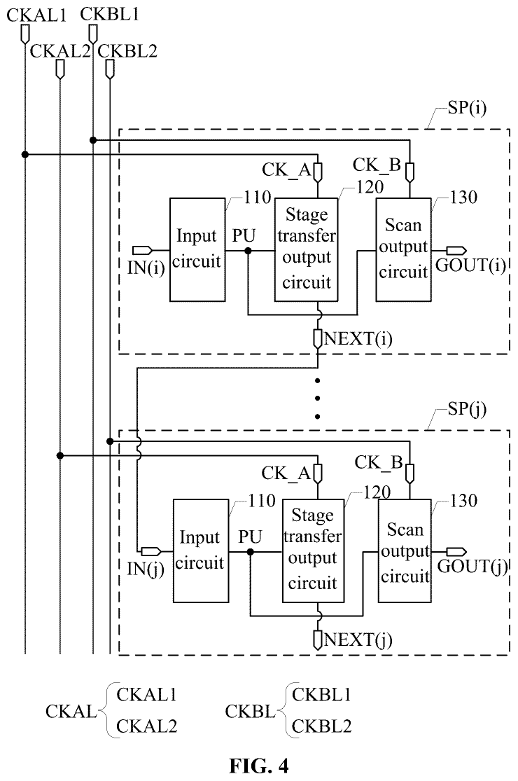

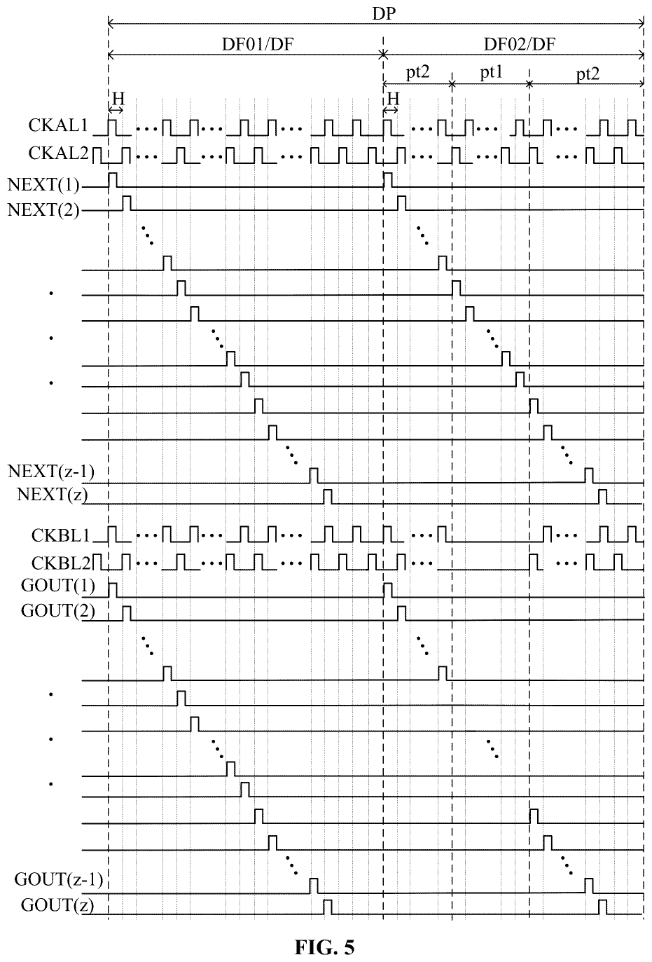

FIG. 4 is schematic diagram one of circuit structures of shift register units according to an embodiment of the present disclosure. Referring to FIG. 4, the shift register unit SP includes an input circuit 110, a stage transfer output circuit 120, and a scan output circuit 130. The input circuit 110 is electrically connected to an input terminal IN and a first node PU separately, and the input circuit 110 is used for controlling a signal at the first node PU according to an input signal at the input terminal IN. The stage transfer output circuit 120 is electrically connected to the first node PU, a stage transfer clock terminal CK_A, and a stage transfer output terminal NEXT separately. The stage transfer output circuit 120 is used for controlling, according to the signal at the first node PU and a signal at the stage transfer clock terminal CK_A, a stage transfer signal output from the stage transfer output terminal NEXT. The stage transfer output terminal NEXT(i) of the i-th stage shift register unit SP(i) is electrically connected to the input terminal IN(j) of the j-th stage shift register unit SP(j), i≠j, and i and j are both positive integers. In one or more embodiments, i<j. The scan output circuit 130 is electrically connected to the first node PU, a scan clock terminal CK_B, and a scan output terminal GOUT separately, and the scan output circuit 130 is used for controlling, according to the signal at the first node PU and a signal at the scan clock terminal CK_B, a scan signal output from the scan output terminal GOUT. The stage transfer clock terminal CK_A is electrically connected to the stage transfer clock line CKAL, and the scan clock terminal CK_B is electrically connected to the scan clock line CKBL.

The electrical connection between the stage transfer output circuit 120 and the first node PU and the electrical connection between the scan output circuit 130 and the first node PU may be understood as direct electrical connections or indirect electrical connections. For the indirect electrical connections, a transistor, such as a normally-on transistor, may be disposed between the stage transfer output circuit 120 and the first node PU, and/or a transistor, such as a normally-on transistor, may be disposed between the scan output circuit 130 and the first node PU. Two ends of the normally-on transistor are connected to the stage transfer output circuit 120 and the first node PU, respectively, and/or two ends of the normally-on transistor are connected to the scan output circuit 130 and the first node PU, respectively. The gate of the normally-on transistor is connected to an enable signal line. In the working stage of the shift register, the signal of the enable signal line is at a constant level, and the constant level controls the normally-on transistor to be in a normally-on state.

The stage transfer clock signal transmitted by the stage transfer clock line CKAL and the scan clock signal transmitted by the scan clock line CKBL may both be pulse signals with alternate high-level and low-level signals, and the stage transfer clock signal at the stage transfer clock terminal CK_A and the scan clock signal at the scan clock terminal CK_B of the same shift register unit SP may be different.

Specifically, in the same shift register unit SP, the input signal at the input terminal IN is used for controlling the input circuit 110. When the input signal at the input terminal IN is at a valid level, at least some of the transistors in the input circuit 110 may be controlled to be turned on so that the input circuit 110 can control the signal at the first node PU to be at a valid level. The signal at the first node PU is used for controlling the stage transfer output circuit 120 and the scan output circuit 130. When the signal at the first node PU is at a valid level, at least some of the transistors in the stage transfer output circuit 120 may be controlled to be turned on so that the stage transfer output circuit 120 can transmit the stage transfer clock signal at the stage transfer clock terminal CK_A to the stage transfer output terminal NEXT; and at least some of the transistors in the scan output circuit 130 may be controlled to be turned on so that the scan output circuit 130 can transmit the scan clock signal at the scan clock terminal CK_B to the scan output terminal GOUT.

The stage transfer signal at the stage transfer output terminal NEXT(i) of the i-th stage shift register unit SP(i) may control the input circuit 110 of the j-th stage shift register unit SP(j). When the stage transfer signal at the stage transfer output terminal NEXT(i) is at a valid level, the signal at the first node PU of the j-th stage shift register unit SP(j) may be at a valid level so that the stage transfer output circuit 120 of the j-th stage shift register unit SP(j) can transmit the stage transfer clock signal at the stage transfer clock terminal CK_A to the stage transfer output terminal NEXT(j), thereby shifting the stage transfer signal; and/or the scan output circuit 130 of the j-th stage shift register unit SP(j) can transmit the scan clock signal at the scan clock terminal CK_B to the scan output terminal GOUT(j), thereby shifting the scan signal.

The scan signal at the scan output terminal GOUT(i) of the i-th stage shift register unit SP(i) may control some pixels P. When the scan signal at the scan output terminal GOUT(i) is at a valid level, at least some transistors in some pixels P may be controlled to be turned on so that data signals are written into some pixels P, thereby controlling the pixels P to display corresponding grayscale. In one or more embodiments, the stage transfer clock signal at the stage transfer clock terminal CK_A and the scan clock signal at the scan clock terminal CK_B of the same shift register unit SP may be different so that the stage transfer signal at the stage transfer output terminal NEXT and the scan signal at the scan output terminal GOUT of the same shift register unit SP may be different, that is, when the scan signal at the scan output terminal GOUT is at an invalid level, the transition of the stage transfer signal at the stage transfer output terminal NEXT to a valid level is not affected, thereby shifting the effective pulses of the stage transfer signal. In this manner, the shift register units SP can be driven in sequence.

One or more scan output circuits may be included in each stage shift register unit. If more scan output circuits are included in each stage shift register unit, the multiple scan output circuits are connected to different scan clock lines, respectively so that controlled by the same input circuit, the scan output terminals of the scan output circuits output scan signals in sequence.

It is to be understood that the valid level may be a high level or a low level, and whether the valid level is a high level or a lower level is related to the specific structure of the circuit the valid level controls. For example, when the circuit the valid level controls includes a transistor, the valid level controls the transistor to be turned on, and the invalid level controls the transistor to be turned off. When the transistor is a P-type transistor, the valid level is a low level, and the high level is an invalid level. When the circuit the valid level controls includes a transistor and the transistor is an N-type transistor, the valid level is a high level, and the low level is an invalid level. In the embodiment of the present disclosure, whether the valid level is a high level or a lower level may be defined according to actual needs, and whether the valid level of the signal is a high level or a low level is not limited. Moreover, the valid levels of different ports may be different, that is, the valid levels of some ports may be high levels, and the valid levels of some ports may be low levels. Whether the valid levels of different ports are the same is not limited.

It may also be understood as that a high level or a low level refers to a voltage for controlling the transistor in the circuit to be turned on or off, but is not limited to a fixed voltage. For example, electrical signals ranging from +15 V to +30 V that can control the circuit to be in the same state may all be high-level signals, and electrical signals ranging from −10 V to −5 V that can control the circuit to be in the same state may all be low-level signals.

For the convenience of description, unless otherwise specified, the case where the transistor is an N-type transistor and the valid level is a high level is used as an example in the embodiments of the present disclosure for an exemplary description of the technical solutions of the embodiments of the present disclosure.

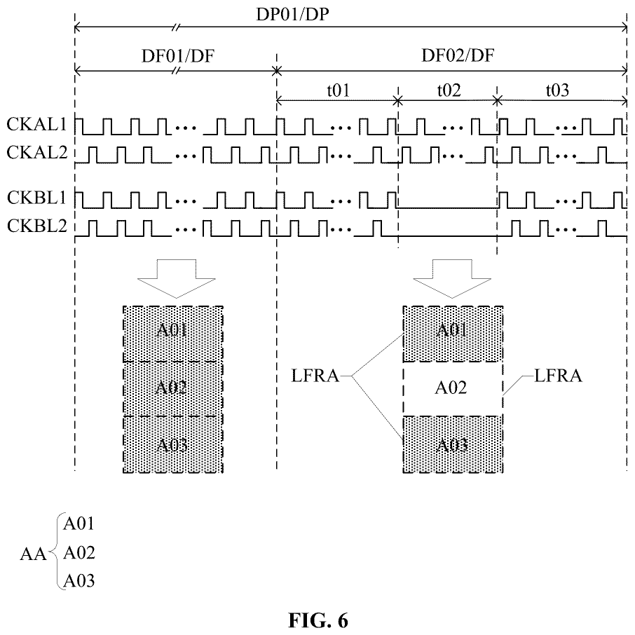

For example, the case where the valid levels of the stage transfer signal and the scan signal are both high levels and the shift register VSR includes z cascaded shift register units SP is used as an example. FIG. 5 is timing diagram one of a shift register according to an embodiment of the present disclosure. Referring to FIGS. 4 and 5, during the portion of the pixel refresh time pt1 of the partial display frame DF, the potential of the stage transfer signal output from the stage transfer output terminal NEXT and the potential of the scan signal output from the scan output terminal GOUT of the same shift register unit SP may be different. The pixel refresh time of one display frame DF may represent a period from the end of light emission of the last row of pixels P in the previous display frame to the end of light emission of the last row of pixels P in the current display frame, or the pixel refresh time of one display frame DF may represent a period in which the shift register units SP of the shift register VSR are driven in sequence (the input signals at the input terminals IN of the shift register units SP transition to a valid level in sequence, or the stage transfer output terminals NEXT of the shift register units SP output effective pulses in sequence).

With continued reference to FIGS. 4 and 5, during the refresh time of one display frame DF, the stage transfer output terminal NEXT of each shift register unit SP can output the effective pulse of the stage transfer signal, and the effective pulses of the stage transfer signals output from the shift register units SP are shifted in sequence. During the portion of the pixel refresh time pt2 of the partial display frame DF, the stage transfer clock signals on the stage transfer clock lines CKAL include effective pulses, the scan clock signals on the scan clock lines CKBL include effective pulses, the stage transfer output terminals NEXT and the scan output terminals GOUT of some shift register units SP may output effective pulses, and the effective pulses of the stage transfer signals and the effective pulses of the scan signals are shifted in sequence so that some shift register units SP can be driven in sequence, the pixels P in a part of the display region AA can be refreshed row by row, and this part of the display region AA can be refreshed at a higher frequency. During the portion of the pixel refresh time pt1 of the partial display frame DF, the stage transfer clock signals on the stage transfer clock lines CKAL include effective pulses, the scan clock signals on the scan clock lines CKBL are at invalid levels, the stage transfer output terminals NEXT of some shift register units SP may output the effective pulses of the stage transfer signals, and the scan output terminals GOUT of these shift register units SP stop outputting the effective pulses of the scan signals, that is, during the portion of the pixel refresh time pt1 of the partial display frame DF, the scan output terminals GOUT of all the shift register units SP do not output the effective pulses of the scan signals so that the pixels P in a part of the display region AA stop being refreshed, and this part of the display region AA can be refreshed at a lower frequency, thereby achieving high frequency or low frequency for any row, which is conducive to the low power consumption of the display panel 001.

For example, with continued reference to FIGS. 2, 4, and 5, during the pixel refresh time of one display frame DF, except for the last stage shift register unit SP, the stage transfer output circuit 120 of each stage shift register unit SP can output the effective pulse of the stage transfer signal as the input signal at the input terminal IN of the next stage shift register unit SP connected to the stage shift register unit SP, thereby shifting the effective pulses of the stage transfer signals in sequence, that is, driving the shift register units SP in sequence. During the portion of the pixel refresh time pt1 of the partial display frame DF, some shift register units SP stop outputting the effective pulses of the scan signals, but these shift register units SP can still output the effective pulses of the stage transfer signals so that these shift register units SP can still work normally (can still be driven in sequence). Moreover, when the scan clock signals include effective pulses during the subsequent portion of the pixel refresh time pt2, the subsequent shift register units SP can still work normally (can still be driven in sequence) and output the effective pulses of the scan signals, thereby achieving the high-frequency or low-frequency refresh of any row of the display panel 01.

In the embodiments of the present disclosure, the stage transfer output circuit and the scan output circuit are disposed in the shift register unit, the stage transfer output circuit is connected to the stage transfer clock line via the stage transfer clock terminal, and the scan output circuit is connected to the scan clock line via the scan clock terminal so that the stage transfer output circuit and the scan output circuit can receive different clock signals (the stage transfer clock signal and the scan clock signal). Therefore, the stage transfer signal from the stage transfer output terminal and the scan signal from the scan output terminal can be independent of each other and do not affect each other. That is, during the pixel refresh time of one display frame, the scan signal is at an invalid level, the normal transition of the stage transfer signal to a valid level is not affected, and the sequential driving of the shift register units is not affected. In this manner, during the pixel refresh time of the display frame, when any shift register unit stops outputting the effective pulse of the scan signal, it can still be ensured that all shift register units can work normally. While the display requirements of smooth video display are satisfied, high frequency or low frequency for any row can be achieved, which is conducive to the low power consumption of the display panel.

In one or more embodiments, referring to FIG. 5, during the pixel refresh time of the display frame DF, the stage transfer clock signals transmitted on the stage transfer clock lines CKAL (CKAL1 and CKAL2) include effective pulses, and the effective pulses of the stage transfer signals output from the stage transfer output terminals NEXT of the shift register units SP are shifted in sequence.

Specifically, during the pixel refresh time of the display frame DF, the stage transfer clock signals transmitted on the stage transfer clock lines CKAL (CKAL1 and CKAL2) each include multiple effective pulses, and in the valid level stage of the first node PU of any shift register unit SP, the stage transfer clock signal at the stage transfer clock terminal CK_A of the same shift register unit SP includes a valid level.

For example, the pixel refresh time of the display frame DF includes multiple row refresh stages H, the row refresh stage H may be the cycle of row trigger pulses (not shown in the figure) of a row synchronization signal, that is, the period between the start moments of two adjacent row trigger pulses, which is the refresh time for one row of pixels P. During the row refresh stage H, when the scan signal includes the effective pulse, the data signals may be written into one row of pixels P.

The case where the stage transfer clock lines CKAL include the first stage transfer clock line CKAL1 and the second stage transfer clock line CKAL2 is used as an example. Referring to FIGS. 2, 4, and 5, during any row refresh stage H in the pixel refresh time of the display frame DF, the stage transfer clock signal transmitted on at least one stage transfer clock line CKAL (CKAL1 or CKAL2) includes effective pulses; during any two adjacent row refresh stages H in the pixel refresh time of the display frame DF, the stage transfer clock signals transmitted on the stage transfer clock lines CKAL (CKAL1 and CKAL2) each include effective pulses. In this manner, when the first node PU of any shift register unit SP is at a valid level, the stage transfer output terminal NEXT of the same shift register unit SP can output the effective pulse of the stage transfer clock signal as the effective pulse of the stage transfer signal, thereby driving the next stage shift register unit SP and shifting the effective pulses of the stage transfer signals in sequence. In this manner, except for the first stage shift register unit SP, the shift register units SP can receive the input signals with the effective pulses shifted in sequence, respectively, thereby driving the shift register units SP in sequence. When the scan clock signals transmitted on the scan clock lines CKBL (CKBL1 and CKBL2) include the effective pulses, the pixels P can be refreshed row by row.

In one or more embodiments, the stage transfer clock lines CKAL may include three, four, or other numbers of clock lines. In this case, during any row refresh stage H in the pixel refresh time of the display frame DF, the stage transfer clock signal transmitted on at least one stage transfer clock line CKAL includes effective pulses; during any adjacent three, four or other numbers of row refresh stages H in the pixel refresh time of one display frame DF, the stage transfer clock signals transmitted on the stage transfer clock lines CKAL each include effective pulses, thereby driving the shift register units SP in sequence. When the scan clock signal transmitted on the scan clock line CKBL includes effective pulses, the pixels P can be refreshed row by row.

In addition, the stage transfer clock signals transmitted by the stage transfer clock lines CKAL may be pulse signals with alternate high-level and low-level signals. Usually, one high-level signal and one consecutive low-level signal form a transition cycle, which is also the stage transfer clock cycle of each stage transfer clock line CKAL. In one or more embodiments, during the pixel refresh time of the display frame DF, the transition cycles of the stage transfer clock lines CKAL are the same, and within the stage transfer clock cycle of the stage transfer clock line CKAL, the stage transfer clock signal transmitted on each stage transfer clock line CKAL includes valid levels. In this manner, within the stage transfer clock cycle of the stage transfer clock line CKAL, multiple valid levels of the stage transfer clock signal can be generated, thereby driving the shift register units SP in sequence, which is conducive to the sequential driving of the shift register units SP, so that when the scan clock signal transmitted on the scan clock line CKBL includes valid levels, the pixels P can be refreshed row by row.

In one or more embodiments, with continued reference to FIG. 5, the display panel 001 includes a multi-frequency drive display mode, the multi-frequency drive display mode includes multiple display periods DPs, and the display cycle includes a first display frame DF01 and a second display frame DF02. During the portion of the pixel refresh time pt2 of the second display frame DF02, the scan clock signals transmitted on the scan clock lines CKBL (CKBL1 and CKBL2) each include effective pulses; and during the portion of the pixel refresh time pt1 of the second display frame DF02, the scan clock signals transmitted on the scan clock lines CKBL are all at invalid levels.

Specifically, during the portion of the pixel refresh time pt2 of the second display frame DF02, the scan clock signals transmitted on the scan clock lines CKBL (CKBL1 and CKBL2) each include multiple effective pulses, and in the valid level stage of the first node PU of any shift register unit SP, the scan clock signal at the scan clock terminal CK_B of the shift register unit SP includes a valid level; during the portion of the pixel refresh time pt1 of the second display frame DF02, the scan clock signals transmitted on the scan clock lines CKBL (CKBL1 and CKBL2) are all at invalid levels, and in the valid level stage of the first node PU of any shift register unit SP, the scan clock signal at the scan clock terminal CK_B of the shift register unit SP is at an invalid level.

For example, the case where the scan clock lines CKBL include the first scan clock line CKBL1 and the second scan clock line CKBL2 is used as an example. Referring to FIGS. 2, 4, and 5, during any row refresh stage H in the portion of the pixel refresh time pt2 of the second display frame DF02, the scan clock signal transmitted on at least one scan clock line CKBL (CKBL1 or CKBL2) includes effective pulses; during any two adjacent row refresh stages H in the portion of the pixel refresh time pt2 of the second display frame DF02, the scan clock signals transmitted on the scan clock lines CKBL (CKBL1 and CKBL2) each include effective pulses; during the partial pixel refresh time pt1 of the second display frame DF02, the scan clock signals transmitted on the scan clock lines CKBL (CKBL1 and CKBL2) are all at invalid levels. In this manner, during the portion of the pixel refresh time pt2 of the second display frame DF02, when the first node PU of the shift register unit SP is at a valid level, the scan output terminal GOUT can output the effective pulse of the scan clock signal as the effective pulse of the scan signal, thereby driving some pixels P row by row; during the portion of the pixel refresh time pt1 of the second display frame DF02, when the first node PU of the shift register unit SP is at a valid level, the scan output terminal GOUT can output the invalid level of the scan clock signal as the invalid level of the scan signal so that some pixels P can maintain the display grayscale of the previous display frame.

In one or more embodiments, the scan clock lines CKBL may include three, four, or other numbers of clock lines. In this case, during any row refresh stage H in the portion of the pixel refresh time pt2 of the second display frame DF02, the scan clock signal transmitted on at least one scan clock line CKBL includes effective pulses; during any adjacent three, four or other numbers of row refresh stages H in the portion of the pixel refresh time pt2 of the second display frame DF02, the scan clock signals transmitted on the scan clock lines CKBL each include effective pulses, thereby refreshing some pixels P row by row.

In addition, the scan clock signals transmitted by the scan clock lines CKBL may be pulse signals with alternate high-level and low-level signals. Usually, one high-level signal and one consecutive low-level signal form a transition cycle, which is also the scan clock cycle of the scan clock line CKBL. In one or more embodiments, during the portion of the pixel refresh time pt2 of the second display frame DF02, the transition cycles of the scan clock lines CKBL are the same, and within the scan clock cycle of the scan clock line CKBL, the scan clock signal transmitted on each scan clock line CKBL includes valid levels. In this manner, within the scan clock cycle of the scan clock line CKBL, multiple valid levels of the scan clock signal can be generated, thereby refreshing some pixels P row by row.

It is to be noted that the figure only exemplarily shows that the display period DP includes the first first display frame DF01 and the first second display frame DF02, which is not limited thereto. The display period DP may include multiple first display frames DF01 and/or multiple second display frames DF02.

In one or more embodiments, with continued reference to FIG. 5, the first display frame DF01 is before the second display frame DF02. During the pixel refresh time of the first display frame DF01, the scan clock signals transmitted on the scan clock lines CKBL (CKBL1 and CKBL2) each include effective pulses, and the effective pulses of the scan signals output from the scan output terminals GOUT of the shift register units SP are shifted in sequence.

Specifically, during the pixel refresh time of the first display frame DF01, the scan clock signals transmitted on the scan clock lines CKBL (CKBL1 and CKBL2) each include multiple effective pulses, and in the valid level stage of the first node PU of any shift register unit SP, the scan clock signal at the scan clock terminal CK_B of this shift register unit SP includes a valid level.

For example, the case where the scan clock lines CKBL include the first scan clock line CKBL1 and the second scan clock line CKBL2 is used as an example. Referring to FIGS. 2, 4, and 5, during any row refresh stage H in the pixel refresh time of the first display frame DF01, the scan clock signal transmitted on at least one scan clock line CKBL (CKBL1 or CKBL2) includes effective pulses; during any two adjacent row refresh stages H in the pixel refresh time of the first display frame DF01, the scan clock signals transmitted on the scan clock lines CKBL (CKBL1 and CKBL2) each include effective pulses. In this manner, during the pixel refresh time of the first display frame DF01, all the pixels P in the display region AA can be refreshed row by row.

From the above content, it can be seen that in the multi-frequency drive display mode, during the pixel refresh time of the first display frame DF01 of the same display period DP, the scan output terminals GOUT of the shift register units SP can output the effective pulses of the scan signals in sequence so that all the pixels P in the display region AA can be refreshed row by row, the data signals can be rewritten into all the pixels P, and the pixels are refreshed to the display grayscale of the current display frame. During the pixel refresh time of the second display frame DF02 of the same display period DP, the scan output terminals GOUT of some shift register units SP can output the effective pulses of the scan signals so that some pixels P in the display region AA can be refreshed, and the data signals can be rewritten into some pixels P, thereby achieving high-frequency refresh; and the scan output terminals GOUT of some shift register units SP do not output the effective pulses so that the data signals are not rewritten into some pixels P, and the pixels maintain the same display grayscale as the previous frame, thereby achieving low-frequency refresh. In this manner, different regions of the display region AA of the display panel 001 can be refreshed at different frequencies. For example, the display region AA may include a high-frequency display region and a low-frequency display region. In the second display frame DF02, the pixels P in the high-frequency display region can be refreshed to the display grayscale of the current display frame, and the pixels P in the low-frequency display region can maintain the display grayscale of the previous display frame.

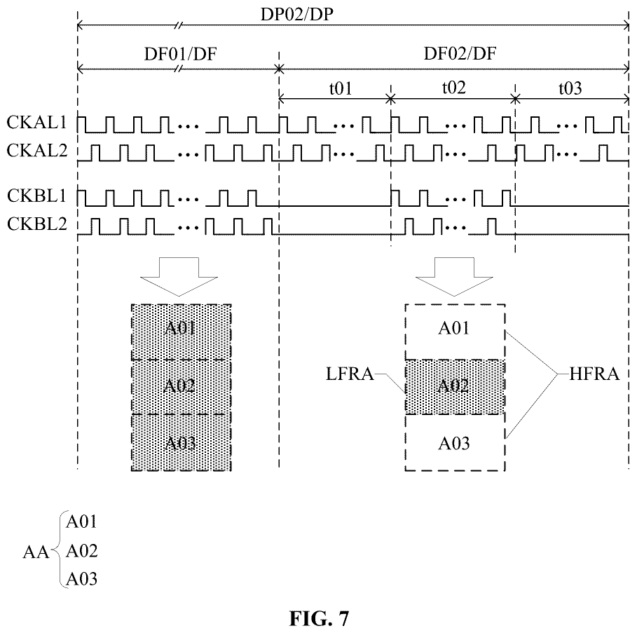

In one or more embodiments, FIG. 6 is timing diagram one of a display panel in a multi-frequency drive display mode according to an embodiment of the present disclosure, and FIG. 7 is timing diagram two of a display panel in a multi-frequency drive display mode according to an embodiment of the present disclosure. Referring to FIGS. 6 and 7, the pixel refresh time of the second display frame DF02 includes a first period t01, a second period t02, and a third period t03, the first period t01 is before the second period t02, and the third period t03 is after the second period t02. The display region AA of the display panel 001 includes a first display region A01, a second display region A02, and a third display region A03. In the f-th period, the stage transfer signal output from the stage transfer output terminal NEXT of the shift register unit SP connected to the pixel circuit P in the f-th display region includes a valid level, and f is a positive integer less than or equal to 3.

In the display period DP of the multi-frequency drive display mode, the display panel 001 further includes a low-frequency display region LFRA. The low-frequency display region LFRA includes the f-th display region, and in the f-th period, the scan clock signals transmitted on the scan clock lines CKBL are all at invalid levels; and/or the low-frequency display region LFRA includes the z-th display region, and in the z-th period, the scan clock signals transmitted on the scan clock lines CKBL are all at invalid levels, where z is a positive integer less than or equal to 3, and z≠f.

It is to be understood that the pattern filling of the display region AA in FIGS. 6 and 7 is only used for indicating that the data signals stored in the pixels P in this region are refreshed during the pixel refresh time of the current display frame. No pattern filling indicates that the data signals stored in the pixels P in this region are not refreshed during the pixel refresh time of the current display frame. Pattern filling is not used for distinguishing between display regions.

Specifically, referring to FIGS. 1, 6, and 7, f=1, 2, or 3, in the first period t01, the shift register units SP electrically connected to the pixels P in the first display region A01 are driven in sequence. If the scan clock signals transmitted on the scan clock lines CKBL include effective pulses in the first period t01, the shift register units SP electrically connected to the pixels P in the first display region A01 can output the effective pulses of the scan signals, thereby refreshing the pixels P in the first display region A01. In the second period t02, the shift register units SP electrically connected to the pixels P in the second display region A02 are driven in sequence. If the scan clock signals transmitted on the scan clock lines CKBL include effective pulses in the second period t02, the shift register units SP electrically connected to the pixels P in the second display region A02 can output the effective pulses of the scan signals, thereby refreshing the pixels P in the second display region A02. In the third period t03, the shift register units SP electrically connected to the pixels Pin the third display region A03 are driven in sequence. If the scan clock signals transmitted on the scan clock lines CKBL include effective pulses in the third period t03, the shift register units SP electrically connected to the pixels P in the third display region A03 can output the effective pulses of the scan signals, thereby refreshing the pixels P in the third display region A03.

In the multi-frequency drive display mode, in any one or two periods among the first period t01, the second period t02, and the third period t03 of the pixel refresh time of the second display frame DF02, the scan clock signals transmitted on the scan clock lines CKBL are all at invalid levels so that the scan signals of some shift register units SP in the pixel refresh time of the second display frame DF02 are kept at invalid levels; in at least one and at most two of the first period t01, the second period t02, and the third period t03, the scan clock signals transmitted on the scan clock lines CKBL include effective pulses so that some shift register units SP in the pixel refresh time of the second display frame DF02 can output the effective pulses of the scan signals. In this manner, each of any one or two of the first display region A01, the second display region A02, and the third display region A03 may be the low-frequency display region LFRA, and each of at least one and at most two of the first display region A01, the second display region A02, and the third display region A03 may be a high-frequency display region HFRA, thereby achieving high-frequency refresh or low-frequency refresh for any row, which is conducive to the low power consumption of the display panel 001.

For example, with continued reference to FIGS. 1, 6, and 7, in the multi-frequency drive display mode, in the same display period DP, during the pixel refresh time of the first display frame DF01, the pixels P in the first display region A01, the second display region A02, and the third display region A03 are all refreshed; during the pixel refresh time of the second display frame DF02, the pixels P in any one or two of the first display region A01, the second display region A02, and the third display region A03 are not refreshed, thereby achieving the low-frequency refresh of any region in the display region AA and reducing the power consumption of the display panel 001.

In one or more embodiments, with continued reference to FIGS. 1, 6, and 7, the display panel 001 includes the first display region A01 and the second display region A02, and the multi-frequency drive display mode includes a first display period DP01 and a second display period DP02. During the pixel refresh time of the second display frame DF02 of the first display period DP01, during the pixel refresh time of the first display region A01, the scan clock signals transmitted on the scan clock lines CKBL each include effective pulses; during the pixel refresh time of the second display frame DF02 of the second display period DP02, during the pixel refresh time of the first display region A01, the scan clock signals transmitted on the scan clock lines CKBL are all at invalid levels; and/or during the pixel refresh time of the second display frame DF02 of the first display period DP01, during the pixel refresh time of the second display region A02, the scan clock signals transmitted on the scan clock lines are all at invalid levels; during the pixel refresh time of the second display frame DF02 of the second display period DP02, during the pixel refresh time of the second display region A02, the scan clock signals transmitted on the scan clock lines CKBL include effective pulses.

The first display period DP01 and the second display period DP02 of the multi-frequency drive display mode each include the high-frequency display region HFRA and the low-frequency display region LFRA. In an embodiment, the refresh frequency of the high-frequency display region HFRA of the first display period DP01 and the refresh frequency of the high-frequency display region HFRA of the second display period DP02 are different. In another embodiment, the refresh frequency of the low-frequency display region LFRA of the first display period DP01 and the refresh frequency of the low-frequency display region LFRA of the second display period DP02 are different. In another embodiment, the low-frequency display region LFRA of the first display period DP01 and the low-frequency display region LFRA of the second display period DP02 are different. In another embodiment, the high-frequency display region HFRA of the first display period DP01 is the low-frequency display region LFRA of the second display period DP02, and the low-frequency display region LFRA of the first display period DP01 is the high-frequency display region HFRA of the second display period DP02.

For example, with continued reference to FIGS. 1, 6, and 7, during the pixel refresh time of the second display frame DF02 of the first display period DP01, during the pixel refresh time of the first display region A01, the shift register units SP electrically connected to the pixels P in the first display region A01 can output the effective pulses of the stage transfer signals, and the scan clock signals transmitted on the scan clock lines CKBL each include effective pulses so that the shift register units SP electrically connected to the pixels P in the first display region A01 can output the effective pulses of the scan signals, the pixels P in the first display region A01 can be refreshed, and the first display region A01 is the high-frequency display region HFRA; during the pixel refresh time of the second display frame DF02 of the second display period DP02, during the pixel refresh time of the first display region A01, the shift register units SP electrically connected to the pixels P in the first display region A01 can output the effective pulses of the stage transfer signals, and the scan clock signals transmitted on the scan clock lines CKBL are all at invalid levels so that the scan signals of the shift register units SP electrically connected to the pixels P in the first display region A01 are kept at invalid levels, the pixels P in the first display region A01 are not refreshed, and the first display region A01 is the low-frequency display region LFRA.

During the pixel refresh time of the second display frame DF02 of the first display period DP01, during the pixel refresh time of the second display region A02, the shift register units SP electrically connected to the pixels P in the second display region A02 can output the effective pulses of the stage transfer signals, and the scan clock signals transmitted on the scan clock lines CKBL are all at invalid levels so that the scan signals of the shift register units SP electrically connected to the pixels P in the second display region A02 are kept at invalid levels, the pixels P in the second display region A02 are not refreshed, and the second display region A02 is the low-frequency display region LFRA; during the pixel refresh time of the second display frame DF02 of the second display period DP02, during the pixel refresh time of the second display region A02, the shift register units SP electrically connected to the pixels P in the second display region A02 can output the effective pulses of the stage transfer signals, and the scan clock signals transmitted on the scan clock lines CKBL each include effective pulses so that the shift register units SP electrically connected to the pixels P in the second display region A02 can output the effective pulses of the scan signals, the pixels P in the second display region A02 can be refreshed, and the second display region A02 is the high-frequency display region HFRA.

To sum up, for the same display region (the first display region A01 or the second display region A02) in the display region AA, switching between the state of the high-frequency display region HFRA and the state of the low-frequency display region LFRA can be performed in different display periods DPs. Moreover, the specific positions of the first display region A01 and the second display region A02 are not limited in the embodiments of the present disclosure, that is, any region in the display region AA may be the high-frequency display region HFRA or the low-frequency display region LFRA, and arbitrary switching between the state of the high-frequency display region HFRA and the state of the low-frequency display region LFRA can be performed in different display periods DPs according to display requirements, which is conducive to reducing the power consumption of the display panel 001 while achieving high-quality display (smooth video display).

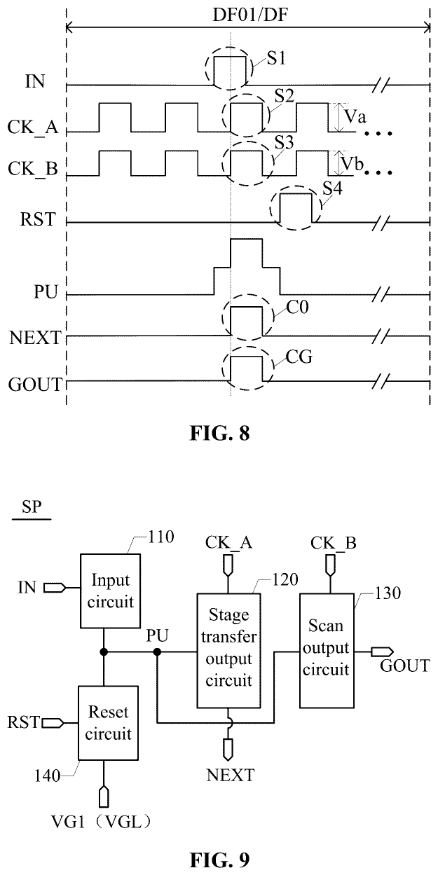

In one or more embodiments, FIG. 8 is timing diagram one of a shift register unit according to an embodiment of the present disclosure. Referring to FIGS. 4, 7, and 8, during the pixel refresh time of one display frame DF, in each of at least some shift register units SP, the input signal received by the input terminal IN includes a first effective pulse S1, the stage transfer clock signal received by the stage transfer clock terminal CK_A includes a second effective pulse S2, and the scan clock signal received by the scan clock terminal CK_B includes a third effective pulse S3. During the pixel refresh time of one display frame DF, in the same shift register unit SP receiving the third effective pulse S3, the start moment of the first effective pulse S1 is before the start moment of the second effective pulse S2, and the start moment of the first effective pulse S1 is before the start moment of the third effective pulse S3. In one or more embodiments, the start moment of the effective pulse is the moment when the signal starts to transition from the invalid level to the valid level.

For example, the case where the valid levels are all high levels is used as an example. Referring to FIGS. 4, 7, and 8, during the pixel refresh time of all the display frames DF, each shift register unit SP can receive the first effective pulse S1 of the input signal and the second effective pulse S2 of the stage transfer clock signal; during the pixel refresh time of the first display frame DF01 or during the pixel refresh time of the high-frequency display region HFRA in the pixel refresh time of the second display frame DF02, each of at least some shift register units SP can receive the third effective pulse S3 of the scan clock signal. Before the stage transfer clock signal received by the stage transfer clock terminal CK_A transitions to the valid level (the second effective pulse S2) and the scan clock signal received by the scan clock terminal CK_B transitions to the valid level (the third effective pulse S3), the input signal received by the input terminal IN first transitions to the valid level (the first effective pulse S1 starts to transition first), thereby ensuring that when the stage transfer clock signal transitions to the valid level (when the second effective pulse S2 starts to transition) and when the scan clock signal transitions to the valid level (when the third effective pulse S3 starts to transition), the voltage of the first node PU has been pulled up by the input circuit 110 so that the stage transfer output circuit 120 can output the complete effective pulse (the second effective pulse S2) of the stage transfer clock signal and the scan output circuit 130 can output the complete effective pulse (the third effective pulse S3) of the scan clock signal. In this manner, it is ensured that the start moment of the effective pulse C0 of the stage transfer signal output from the stage transfer output terminal NEXT of the stage transfer output circuit 120 is not shifted later than the start moment of the second effective pulse S2, and the start moment of the effective pulse CG of the scan signal output from the scan output terminal GOUT of the scan output circuit 130 is not shifted later than the start moment of the third effective pulse S3, thereby avoiding the following: the start moment of the effective pulse C0 and the start moment of the effective pulse CG are shifted later, the start moment of the driving period of the subsequent stage shift register unit SP is shifted later (the start moment of the effective pulse C0 of the stage transfer signal is shifted later) and/or the start moment when the data signal is written into the pixel P is shifted later (the start moment of the effective pulse CG of the scan signal is shifted later), a chain reaction is caused, and the pulse width of the effective pulse CG of the scan signal, the charging time for writing the data signal into the pixel P, or the accurate writing of the data signal into the pixel P is affected.

In one or more embodiments, with continued reference to FIG. 8, during the pixel refresh time of one display frame DF, in the same shift register unit SP receiving the third effective pulse S3, the effective period of the second effective pulse S2 and the effective period of the third effective pulse S3 at least partially overlap.

For example, the case where the valid levels are all high levels is used as an example. With continued reference to FIGS. 4 and 8, the shift register unit SP may be electrically connected to both the first stage transfer clock line CKAL1 and the first scan clock line CKBL1, and the stage transfer clock signal transmitted on the first stage transfer clock line CKAL1 and the scan clock signal transmitted on the first scan clock line CKBL1 may be set correspondingly (the effective period of the effective pulse of the stage transfer clock signal and the effective period of the effective pulse of the scan clock signal completely overlap) so that during the pixel refresh time of the first display frame DF01 or during the pixel refresh time of the high-frequency display region HFRA in the pixel refresh time of the second display frame DF02, the stage transfer clock signal and the scan clock signal received by the same shift register unit SP may be at valid levels at the same time, thereby ensuring that the sequential driving of the shift register units SP and the row-by-row scanning of the pixels P can be performed synchronously and the shift register VSR and the pixels P in the display region AA can cooperate with each other and work stably. Moreover, the effective pulses of the stage transfer clock signal and the scan clock signal received by the same shift register unit SP overlap, that is, the effective period of the second effective pulse S2 and the effective period of the third effective pulse S3 overlap, thereby shortening the duration during which the first node PU is kept at a higher level and reducing the potential instability of the first node PU caused by current leakage, which is conducive to improving the reliability of the circuit.

In one or more embodiments, FIG. 9 is schematic diagram two of a circuit structure of a shift register unit according to an embodiment of the present disclosure. Referring to FIGS. 8 and 9, the shift register unit SP further includes a reset circuit 140 electrically connected to a reset terminal RST, a first voltage terminal VG1, and the first node PU separately, and the reset circuit 140 is used for controlling, according to a reset signal at the reset terminal RST, the transmission path on which the signal at the first voltage terminal VG1 is transmitted to the first node PU. During the pixel refresh time of one display frame DF, the reset signal received by the reset terminal RST of the shift register unit SP includes a fourth effective pulse S4. During the pixel refresh time of one display frame DF, in the same shift register unit SP receiving the third effective pulse S3, the start moment of the fourth effective pulse S4 is after the end moment of the third effective pulse S3. In one or more embodiments, the start moment of the effective pulse is the moment when the transition of the signal from the valid level to the invalid level ends.

Specifically, in the same shift register unit SP, the reset signal at the reset terminal RST is used for controlling the reset circuit 140. When the reset signal at the reset terminal RST is at a valid level, at least some transistors in the reset circuit 140 may be controlled to be turned on so that the reset circuit 140 can transmit the signal at the first voltage terminal VG1 to the first node PU and reset the voltage of the first node PU, thereby restoring the voltage of the first node PU to an invalid level.

For example, the case where the valid levels are all high levels is used as an example, and the signal at the first voltage terminal VG1 may be a low-level signal (VGL). With continued reference to FIGS. 8 and 9, during the pixel refresh time of all the display frames DF, each shift register unit SP may receive the fourth effective pulse S4 of the reset signal; during the pixel refresh time of the first display frame DF01 or during the pixel refresh time of the high-frequency display region HFRA in the pixel refresh time of the second display frame DF02, each of at least some shift register units SP may receive the third effective pulse S3 of the scan clock signal. After the scan clock signal received by the scan clock terminal CK_B transitions to the invalid level (after the third effective pulse S3), the reset signal received by the reset terminal RST transitions to the valid level (the fourth effective pulse S4) to ensure that when the scan clock signal at the scan clock terminal CK_B is at the transition edge where the scan clock signal transitions to the invalid level (the falling edge of the third effective pulse S3), the signal at the first node PU has not been pulled down to the low-level signal at the first voltage terminal VG1 by the reset circuit 140 so that the scan output circuit 130 can output the low-level signal after outputting the effective pulse CG of the scan signal, thereby avoiding the following: the cutoff between the scan clock terminal CK_B and the scan output terminal GOUT occurs before the scan output terminal GOUT is pulled down, the end moment of the effective pulse CG is shifted later than the end moment of the third effective pulse S3, the effective period of the effective pulse CG is extended, the data signals of other rows are still written into the pixels P that should have stopped being refreshed, display deviation occurs, and the display effect is affected.

In one or more embodiments, the reset circuit 140 may be coupled to the stage transfer output terminal NEXT and the scan output terminal GOUT (not shown in FIG. 9), and the reset circuit 140 is further used for resetting the voltage of the stage transfer output terminal NEXT and the voltage of the scan output terminal GOUT to the invalid levels according to the reset signal at the reset terminal RST. During the pixel refresh time of one display frame DF, in the same shift register unit SP receiving the third effective pulse S3, the start moment of the fourth effective pulse S4 is after the end moment of the third effective pulse S3, thereby ensuring that the reset circuit 140 resets the scan signal at the scan output terminal GOUT to the invalid level after the scan clock signal received by the scan clock terminal CK_B transitions from the valid level to the invalid level (after the third effective pulse S3). In this manner, the scan output circuit 130 can output the complete effective pulse (the third effective pulse S3) of the scan clock signal, that is, the effective duration of the effective pulse CG output by the scan output terminal GOUT is the same as the effective duration of the third effective pulse S3, thereby avoiding the following: the end moment of the effective pulse CG of the scan signal output by the scan output circuit 130 is shifted earlier than the end moment of the third effective pulse S3, the pulse width of the effective pulse CG of the scan signal is narrowed, the charging time for writing the data signal into the pixel P is shortened, the charging rate of the node potential storing the data signal in the pixel P is affected, and display distortion occurs.

Based on the preceding embodiments, during the pixel refresh time of one display frame DF, in the same shift register unit SP, the start moment of the fourth effective pulse S4 may be after the end moment of the second effective pulse S2. In this manner, it can be ensured that when the stage transfer clock signal at the stage transfer clock terminal CK_A is at the transition edge where the stage transfer clock signal transitions to the invalid level (the falling edge of the second effective pulse S2), the signal at the first node PU has not been pulled down to the low-level signal at the first voltage terminal VG1 by the reset circuit 140, and the reset circuit 140 resets the stage transfer signal at the stage transfer output terminal NEXT to the invalid level after the stage transfer clock signal received by the stage transfer clock terminal CK_A transitions from the valid level to the invalid level (after the second effective pulse S2) so that the stage transfer output circuit 120 can output the invalid-level signal after outputting the effective pulse C0 of the stage transfer signal. Moreover, the stage transfer output circuit 120 can output the complete effective pulse (the second effective pulse S2) of the stage transfer clock signal, thereby avoiding the following: the cutoff between the stage transfer clock terminal CK_A and the stage transfer output terminal NEXT occurs before the stage transfer output terminal NEXT outputs an invalid level and/or the stage transfer output terminal NEXT is reset to an invalid level before the end moment of the second effective pulse S2, the end moment of the effective pulse C0 is shifted later or earlier than the end moment of the second effective pulse S2, the driving durations of other shift register units SP are affected, a chain reaction is caused, and display distortion occurs.

It is to be understood that the embodiment merely takes into account that the end moment of the effective pulse C0 of the stage transfer signal at the stage transfer output terminal NEXT cannot be shifted too much earlier or later than the end moment of the second effective pulse S2. Therefore, in one or more embodiments, the start moment of the fourth effective pulse S4 is defined to be after the end moment of the second effective pulse S2. However, when the effective duration of the second effective pulse S2 is longer and the reset circuit 140 can reset the voltage of the stage transfer output terminal NEXT to an invalid level according to the reset signal at the reset terminal RST, in the same shift register unit SP, the start moment of the fourth effective pulse S4 may overlap with the second effective pulse S2. In this case, in the same shift register unit SP receiving the third effective pulse S3, the end moment of the second effective pulse S2 should be after the end moment of the third effective pulse S3 (not shown in FIG. 8), and the overlap between the effective period of the third effective pulse S3 and the effective period of the fourth effective pulse can be avoided as much as possible.

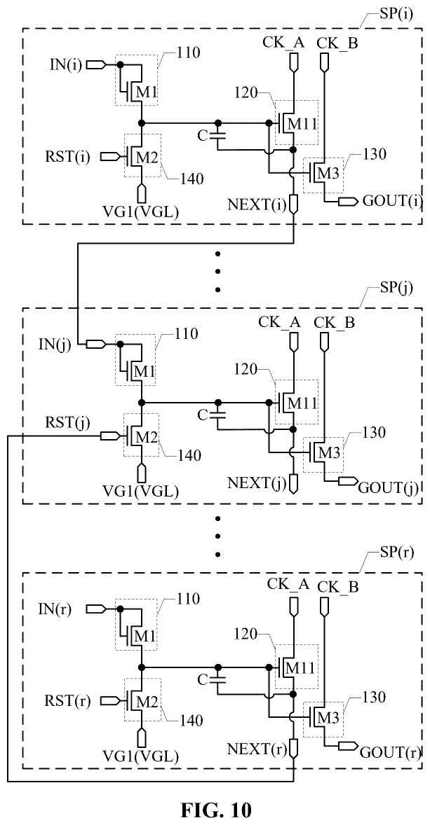

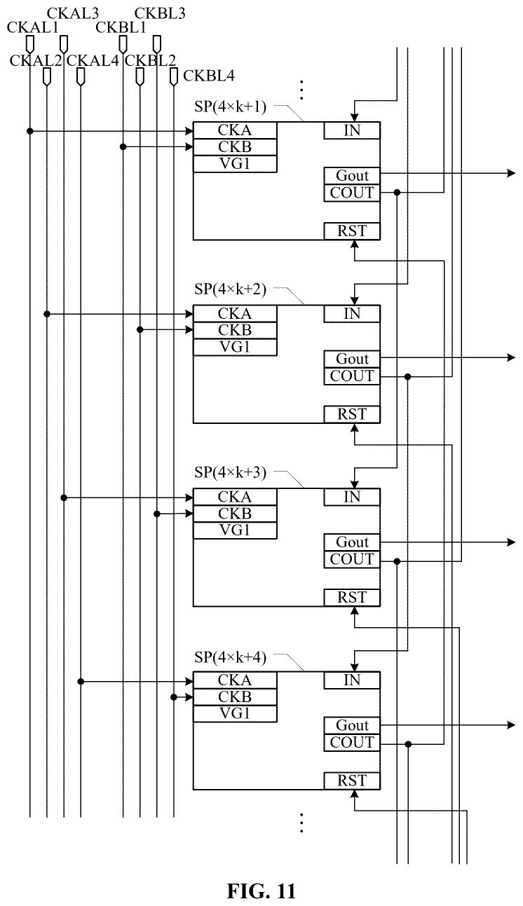

In one or more embodiments, FIG. 10 is schematic diagram three of circuit structures of shift register units according to an embodiment of the present disclosure. Referring to FIG. 10, the input circuit 110 includes an input transistor M1, the gate and the first electrode of the input transistor M1 are both electrically connected to the input terminal IN, and the second electrode of the input transistor M1 is electrically connected to the first node PU.

For example, the case where the input transistor M1 is an N-type transistor and the valid levels are all high levels is used as an example. Referring to FIGS. 8 and 10, when the input signal at the input terminal IN is at a low level, the input transistor M1 is turned off, and the potential of the first node PU remains unchanged and is still at a low level; when the input signal at the input terminal IN is at a high level, the input transistor M1 is turned on, and the input transistor M1 may transmit the high-level signal of the first electrode to the first node PU so that the voltage of the first node PU transitions to a high level.

In one or more embodiments, referring to FIGS. 8 and 10, in the same shift register unit SP, the effective period of the first effective pulse S1 of the input signal and the effective period of the second effective pulse S2 of the stage transfer clock signal overlap.

For example, the case where the input transistor M1 is an N-type transistor and the valid levels are all high levels is used as an example. Referring to FIGS. 8 and 10, when the stage transfer clock signal at the stage transfer clock terminal CK_A transitions from a low level to a high level (the rising edge of the second effective pulse S2), the input signal at the input terminal IN has not transitioned from a high level to a low level, and the input signal at the input terminal IN is still at a high level. In this case, the voltage boost at the stage transfer clock terminal CK_A may pull up the voltage of the first node PU by coupling through the stage transfer output circuit 120 so that the gate-source voltage of the input transistor M1 is less than zero, and the input transistor M1 is turned off. In the process of the input signal at the input terminal IN transitioning from a high level to a low level (the falling edge of the first effective pulse S1), the input transistor M1 remains in the off state, thereby avoiding the following: the voltage of the input terminal IN is pulled down, the voltage of the first node PU is also pulled down, and the output of effective pulses by the stage transfer output circuit 120 and the scan output circuit 130 is affected.

It is to be understood that in one or more embodiments, in the same shift register unit, the effective period of the first effective pulse of the input signal and the effective period of the second effective pulse of the stage transfer clock signal may not overlap. For example, the first electrode of the input transistor may receive a fixed signal (not shown in FIG. 10), the gate of the input transistor may receive the input signal, and the second electrode of the input transistor is electrically connected to the first node. When the input signal transitions to an invalid level, the voltage of the first node does not transition to an invalid level accordingly, and the voltage of the first node may still be a valid level so that the stage transfer output terminal can output a valid level while being coupled to the voltage of the first node.

In one or more embodiments, with continued reference to FIG. 10, the stage transfer output circuit 120 includes a stage transfer output transistor M11, the gate of the stage transfer output transistor M11 is electrically connected to the first node PU, the first electrode of the stage transfer output transistor M11 is electrically connected to the stage transfer clock terminal CK_A, and the second electrode of the stage transfer output transistor M11 is electrically connected to the stage transfer output terminal NEXT. The scan output circuit 130 includes a scan output transistor M3, the gate of the scan output transistor M3 is electrically connected to the first node PU, the first electrode of the scan output transistor M3 is electrically connected to the scan clock terminal CK_B, and the second electrode of the scan output transistor M3 is electrically connected to the scan output terminal GOUT. The shift register unit SP further includes a capacitor C, the first electrode of the capacitor C is electrically connected to the first node PU, and the second electrode of the capacitor C is electrically connected to the stage transfer output terminal NEXT.

For example, the case where the stage transfer output transistor M11 and the scan output transistor M3 are N-type transistors and the valid levels are all high levels is used as an example. Referring to FIGS. 8 and 10, when the voltage at the first node PU is at a high level, the stage transfer output transistor M11 and the scan output transistor M3 are both turned on. When the stage transfer clock signal at the stage transfer clock terminal CK_A transitions from a low level to a high level (the rising edge of the second effective pulse S2), the stage transfer signal at the stage transfer output terminal NEXT also transitions from a low level to a high level (the rising edge of the effective pulse C0). The voltage of the first node PU may be pulled up by coupling through the capacitor C so that the voltage at the first node PU continues increasing based on the original high level, thereby increasing the gate-source voltages of the stage transfer output transistor M11 and the scan output transistor M3, which is conducive to increasing the saturation currents of the stage transfer output transistor M11 and the scan output transistor M3 and improving the output efficiency of the stage transfer signal and the scan signal. In one or more embodiments, during the pixel refresh time of one display frame DF, in the same shift register unit SP receiving the third effective pulse S3, the effective period of the third effective pulse S3 and the effective period of the second effective pulse S2 may overlap so that when the voltage of the first node PU is pulled up by coupling through the capacitor C, the scan output transistor M3 can output the valid level of the scan signal with a higher output efficiency, thereby improving the driving capability for the pixels P.

Moreover, no capacitor may be provided between the first node PU and the scan output terminal GOUT, thereby avoiding the following: during the pixel refresh time of some display frames DF, the scan output terminal GOUT of each of some shift register units SP is at an invalid level, the voltage boost at the first node PU by coupling is affected, the output efficiency of the stage transfer signal and the scan signal is affected, a signal delay is caused, and the reliability of the circuit is affected.

In one or more embodiments, the channel width of the scan output transistor M3 is greater than the channel width of the stage transfer output transistor M11. Specifically, the channel width of the scan output transistor M3 is larger so that the saturation current of the scan output transistor M3 is larger and the output capacity is stronger. When the scan output terminal GOUT is connected to one or more rows of pixels P, the capability of driving the load is also stronger, which is conducive to reducing the signal delay and improving the charging duration and charging efficiency of the data signal.

Based on the preceding embodiments, the channel width of the stage transfer output transistor M11 may be greater than the channel widths of the other transistors in the shift register unit SP except the scan output transistor M3 so that the output capability of the stage transfer output transistor M11 can be improved, thereby improving the driving capability of the stage transfer output terminal NEXT and reducing the signal delay when the stage transfer output terminal NEXT is connected to the input terminal IN of another stage shift register unit SP.

In one or more embodiments, the absolute value of the valid level of the stage transfer clock signal received by the stage transfer clock terminal CK_A is greater than the absolute value of the valid level of the scan clock signal received by the scan clock terminal CK_B.

For example, with continued reference to FIGS. 8 and 10, the case where the valid levels are all high levels and the low levels of the stage transfer clock signal and the scan clock signal are both 0 V is used as an example, the voltage difference between the high level and the low level of the stage transfer clock signal is Va, and the voltage difference between the high level and the low level of the scan clock signal is Vb, where Va>Vb. By setting the high level of the stage transfer clock signal to be higher, the high level of the stage transfer signal at the stage transfer output terminal NEXT is also higher. When the voltage of the first node PU is pulled up by coupling the stage transfer output terminal NEXT with the capacitor C, the voltage of the first node PU may be pulled up to a larger value by coupling, which is conducive to further increasing the saturation currents of the stage transfer output transistor M11 and the scan output transistor M3 and improving the output efficiency of the stage transfer signal and the scan signal. Moreover, only the voltage amplitude when the stage transfer clock signal is at a high level is increased, and the voltage amplitude when the scan clock signal is at a high level does not need to be increased, which is conducive to reducing power consumption.

It is to be understood that when the valid level is a high level, the low level of the stage transfer clock signal and the low level of the scan clock signal are not limited to 0 V. In one or more embodiments, the low level of the stage transfer clock signal and the low level of the scan clock signal may be other voltage values.

Further, it is to be understood that the preceding embodiment is merely an illustrative description with the case where the valid level is a high level as an example. In one or more embodiments, the valid level may be a low level.

In one or more embodiments, with continued reference to FIG. 10, the shift register unit SP further includes the reset circuit 140; the reset circuit 140 is electrically connected to the reset terminal RST, the first voltage terminal VG1, and the first node PU separately; the reset circuit 140 is used for controlling, according to the reset signal at the reset terminal RST, the transmission path on which the signal at the first voltage terminal VG1 is transmitted to the first node PU. The stage transfer output terminal NEXT(r) of the r-th stage shift register unit SP(r) is electrically connected to the reset terminal RST(j) of the j-th stage shift register unit SP(j), r≠j, and r and j are both positive integers. In one or more embodiments, r>j.

Specifically, referring to FIGS. 8 and 10, the stage transfer signal at the stage transfer output terminal NEXT(r) of the r-th stage shift register unit SP(r) may control the reset circuit 140 of the j-th stage shift register unit SP(j). When the stage transfer signal at the stage transfer output terminal NEXT(r) is at a valid level, the voltage of the first node PU of the j-th stage shift register unit SP(j) may be reset to an invalid level, thereby preventing the stage transfer output circuit 120 of the j-th stage shift register unit SP(j) from outputting multiple effective pulses of the stage transfer clock signal, preventing the scan output circuit 130 of the j-th stage shift register unit SP(j) from outputting multiple effective pulses of the scan clock signal, and preventing the sequential driving of the shift register units SP and the row-by-row refresh of the pixels P from being affected.

Based on the preceding embodiments, with continued reference to FIGS. 8 and 10, the reset circuit 140 includes a reset transistor M2, the gate of the reset transistor M2 is electrically connected to the reset terminal RST, the first electrode of the reset transistor M2 is electrically connected to the first voltage terminal VG1, and the second electrode of the reset transistor M2 is electrically connected to the first node PU.

For example, the case where the reset transistor M2 is an N-type transistor and the valid levels are all high levels is used as an example, and the signal at the first voltage terminal VG1 may be a low-level signal (VGL). Referring to FIGS. 8 and 10, when the reset signal at the reset terminal RST is at a low level, the reset transistor M2 is turned off; when the reset signal at the reset terminal RST is at a high level, the reset transistor M2 is turned on. The reset transistor M2 may transmit the low-level signal at the first voltage terminal VG1 to the first node PU so that the voltage of the first node PU transitions to a low level.

It can be seen from the above content that the same shift register unit SP may be connected to one stage transfer clock line CKAL and one scan clock line CKBL. In the multi-frequency drive display mode, in at least some pixel refresh periods, the stage transfer clock signal and the scan clock signal received by the same shift register unit SP may be different. Different shift register units SP may be connected to the same stage transfer clock line CKAL and/or the same scan clock line CKBL. In one or more embodiments, the shift register VSR is electrically connected to m stage transfer clock lines CKAL, and the shift register VSR is also electrically connected to n scan clock lines CKBL, where m and n are both positive integers; the stage transfer clock terminal CK_A of the (m×k+w)-th stage shift register unit SP(m×k+w) is electrically connected to the w-th stage transfer clock line CKALw; the scan clock terminal CK_B of the (n×k+q)-th stage shift register unit SP(n×k+q) is electrically connected to the q-th scan clock line CKBLq; k is 0 or a positive integer, w is a positive integer less than or equal to m, and q is a positive integer less than or equal to n.

For example, the case where m=4 is used as an example. FIG. 11 is schematic diagram one of a circuit structure of a shift register according to an embodiment of the present disclosure. Referring to FIG. 11, w=1, 2, 3, or 4, the stage transfer clock terminal CK_A of the (4×k+1)-th stage shift register unit SP(4×k+1) is electrically connected to the first stage transfer clock line CKAL1, the stage transfer clock terminal CK_A of the (4×k+2)-th stage shift register unit SP(4×k+2) is electrically connected to the second stage transfer clock line CKAL2, the stage transfer clock terminal CK_A of the (4×k+3)-th stage shift register unit SP(4×k+3) is electrically connected to the third stage transfer clock line CKAL3, and the stage transfer clock terminal CK_A of the (4×k+4)-th stage shift register unit SP(4×k+4) is electrically connected to the fourth stage transfer clock line CKAL4.

The case where n=4 is used as an example. With continued reference to FIG. 11, q=1, 2, 3, or 4, the scan clock terminal CK_B of the (n×k+1)-th stage shift register unit SP(n×k+1) is electrically connected to the first scan clock line CKBL1, the scan clock terminal CK_B of the (n×k+2)-th stage shift register unit SP(n×k+2) is electrically connected to the second scan clock line CKBL2, the scan clock terminal CK_B of the (n×k+3)-th stage shift register unit SP(n×k+3) is electrically connected to the third scan clock line CKBL3, and the scan clock terminal CK_B of the (n×k+4)-th stage shift register unit SP(n×k+4) is electrically connected to the fourth scan clock line CKBL4.

It is to be noted that FIG. 11 only exemplarily shows that the stage transfer output terminal NEXT(j−2) of the (j−2)-th stage shift register unit SP(j−2) is electrically connected to the input terminal IN(j) of the j-th stage shift register unit SP(j), and the stage transfer output terminal NEXT(j+3) of the (j+3)-th stage shift register unit SP(j+3) is electrically connected to the reset terminal RST(j) of the j-th stage shift register unit SP(j), which is not limited thereto.

In one or more embodiments, m=n, and the scan clock terminal CK_B of the (m×k+w)-th stage shift register unit SP(m×k+w) is electrically connected to the w-th scan clock line CKBLw.

Specifically, in the m continuously cascaded shift register units SP, different shift register units SP are electrically connected to different stage transfer clock lines CKAL, and different shift register units SP are electrically connected to different scan clock lines CKBL, that is, the same stage transfer clock line CKAL is connected to one shift register unit SP, and the same scan clock line CKBL is connected to one shift register unit SP.

For example, with continued reference to FIG. 11, m=n=4, the (4×k+1)-th stage shift register unit SP(4×k+1) is electrically connected to the first stage transfer clock line CKAL1 and the first scan clock line CKBL1 separately, the (4×k+2)-th stage shift register unit SP(4×k+2) is electrically connected to the second stage transfer clock line CKAL2 and the second scan clock line CKBL2 separately, the (4×k+3)-th stage shift register unit SP(4×k+3) is electrically connected to the third stage transfer clock line CKAL3 and the third scan clock line CKBL3 separately, and the (4×k+4)-th stage shift register unit SP(4×k+4) is electrically connected to the fourth stage transfer clock line CKAL4 and the fourth scan clock line CKBL4 separately. In this manner, the connection relationship of all the stage transfer clock lines CKAL of the shift register units SP can be the same as the connection relationship of all the scan clock lines CKBL of the shift register units SP, which is conducive to simplifying the layout design and reducing the layout difficulty; moreover, the number of stage transfer clock lines CKAL is equal to the number of scan clock lines CKBL, which is conducive to simplifying the timing design. In one or more embodiments, it is also feasible that m=n=3, 5, 6, 7, or 8.

In one or more embodiments, m=n×2, and the scan clock terminals CK_B of the (m×k+q)-th stage shift register unit SP(m×k+q) and the (m×k+q+n)-th stage shift register unit SP(m×k+q+n) are electrically connected to the q-th scan clock line CKBLq.

Specifically, in the m continuously cascaded shift register units SP, different shift register units SP are electrically connected to different stage transfer clock lines CKAL, and shift register units SP that are spaced by n stages are electrically connected to the same scan clock line CKBL, that is, the same stage transfer clock line CKAL is connected to one shift register unit SP, and the same scan clock line CKBL is connected to two shift register units SP.

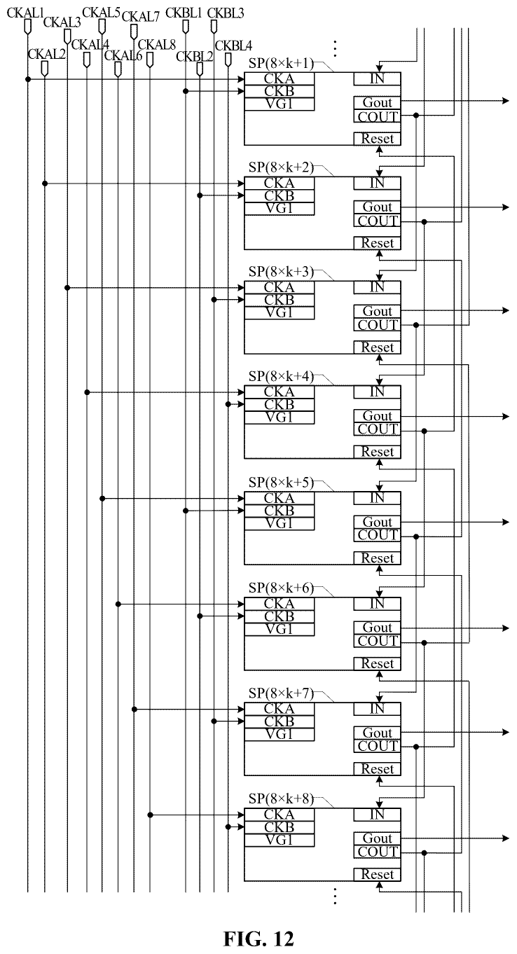

For example, the case where m=8 and n=4 is used as an example. FIG. 12 is schematic diagram two of a circuit structure of a shift register according to an embodiment of the present disclosure. Referring to FIG. 12, w=1, 2, 3, 4, 5, 6, 7, or 8, q=1, 2, 3, or 4, the (8×k+1)-th stage shift register unit SP(8×k+1) is electrically connected to the first stage transfer clock line CKAL1 and the first scan clock line CKBL1 separately, the (8×k+2)-th stage shift register unit SP(8×k+2) is electrically connected to the second stage transfer clock line CKAL2 and the second scan clock line CKBL2 separately, the (8×k+3)-th stage shift register unit SP(8×k+3) is electrically connected to the third stage transfer clock line CKAL3 and the third scan clock line CKBL3 separately, the (8×k+4)-th stage shift register unit SP(8×k+4) is electrically connected to the fourth stage transfer clock line CKAL4 and the fourth scan clock line CKBL4 separately, the (8×k+5)-th stage shift register unit SP(8×k+5) is electrically connected to the fifth stage transfer clock line CKAL5 and the first scan clock line CKBL1 separately, the (8×k+6)-th stage shift register unit SP(8×k+6) is electrically connected to the sixth stage transfer clock line CKAL6 and the second scan clock line CKBL2 separately, the (8×k+7)-th stage shift register unit SP(8×k+7) is electrically connected to the seventh stage transfer clock line CKAL7 and the third scan clock line CKBL3 separately, and the (8×k+8)-th stage shift register unit SP(8×k+8) is electrically connected to the eighth stage transfer clock line CKAL8 and the fourth scan clock line CKBL4 separately. In one or more embodiments, m=4 and n=2; or m=6 and n=3.

n<m and n×2=m, which is conducive to reducing the number of scan clock lines CKBL; moreover, the connection relationship between the scan clock lines CKBL and the shift register units SP can be simplified, and the minimum repeating unit of the connection relationship between the shift register units SP, the stage transfer clock lines CKAL, and the scan clock lines CKBL can be smaller, which is conducive to simplifying the layout design and reducing the layout difficulty.

It is to be noted that FIG. 12 only exemplarily shows that the stage transfer output terminal NEXT(j−2) of the (j−2)-th stage shift register unit SP(j−2) is electrically connected to the input terminal IN(j) of the j-th stage shift register unit SP(j), and the stage transfer output terminal NEXT(j+3) of the (j+3)-th stage shift register unit SP(j+3) is electrically connected to the reset terminal RST(j) of the j-th stage shift register unit SP(j), which is not limited thereto.

In one or more embodiments, m×2=n, and the stage transfer clock terminals of the (n×k+w)-th stage shift register unit SP(n×k+w) and the (n×k+w+m)-th stage shift register unit SP(n×k+w+m) are electrically connected to the w-th stage transfer clock line CKALw.

Specifically, in the m continuously cascaded shift register units SP, shift register units SP that are spaced by m stages are electrically connected to the same stage transfer clock line CKAL, and different shift register units SP are electrically connected to different scan clock lines CKBL, that is, the same stage transfer clock line CKAL is connected to two shift register units SP, and the same scan clock line CKBL is connected to one shift register unit SP.

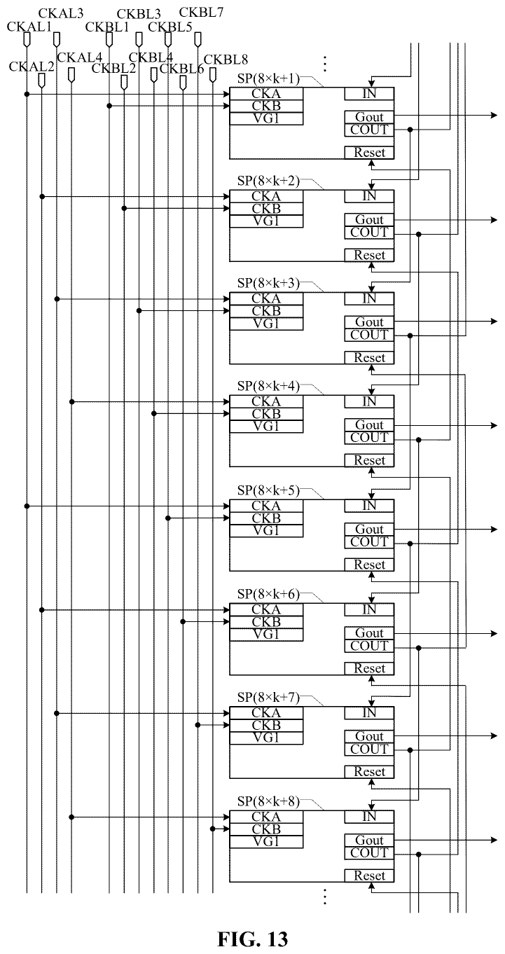

For example, the case where m=4 and n=8 is used as an example. FIG. 13 is schematic diagram three of a circuit structure of a shift register according to an embodiment of the present disclosure. Referring to FIG. 13, w=1, 2, 3, or 4, q=1, 2, 3, 4, 5, 6, 7, or 8, the (8×k+1)-th stage shift register unit SP(8×k+1) is electrically connected to the first stage transfer clock line CKAL1 and the first scan clock line CKBL1 separately, the (8×k+2)-th stage shift register unit SP(8×k+2) is electrically connected to the second stage transfer clock line CKAL2 and the second scan clock line CKBL2 separately, the (8×k+3)-th stage shift register unit SP(8×k+3) is electrically connected to the third stage transfer clock line CKAL3 and the third scan clock line CKBL3 separately, the (8×k+4)-th stage shift register unit SP(8×k+4) is electrically connected to the fourth stage transfer clock line CKAL4 and the fourth scan clock line CKBL4 separately, the (8×k+5)-th stage shift register unit SP(8×k+5) is electrically connected to the first stage transfer clock line CKAL1 and the fifth scan clock line CKBL5 separately, the (8×k+6)-th stage shift register unit SP(8×k+6) is electrically connected to the second stage transfer clock line CKAL2 and the sixth scan clock line CKBL6 separately, the (8×k+7)-th stage shift register unit SP(8×k+7) is electrically connected to the third stage transfer clock line CKAL3 and the seven scan clock line CKBL7 separately, and the (8×k+8)-th stage shift register unit SP(8×k+8) is electrically connected to the fourth stage transfer clock line CKAL4 and the eighth scan clock line CKBL8 separately. In one or more embodiments, m=2 and n=4; or m=3 and n=6.

m<n and m×2=n, which is conducive to reducing the number of stage transfer clock lines CKAL; moreover, the connection relationship between the stage transfer clock lines CKAL and the shift register units SP can be simplified, and the minimum repeating unit of the connection relationship between the shift register units SP, the stage transfer clock lines CKAL, and the scan clock lines CKBL can be smaller, which is conducive to simplifying the layout design and reducing the layout difficulty.

It is to be noted that FIG. 13 only exemplarily shows that the stage transfer output terminal NEXT(j−2) of the (j−2)-th stage shift register unit SP(j−2) is electrically connected to the input terminal IN(j) of the j-th stage shift register unit SP(j), and the stage transfer output terminal NEXT(j+3) of the (j+3)-th stage shift register unit SP(j+3) is electrically connected to the reset terminal RST(j) of the j-th stage shift register unit SP(j), which is not limited thereto.

In one or more embodiments, n>m; in the m×n continuously cascaded shift register units SP, the same stage transfer clock line is connected to n shift register units SP, and the same scan clock line is connected to m shift register units SP.

Specifically, in the m×n continuously cascaded shift register units SP, shift register units SP that are spaced by m stages are electrically connected to the same stage transfer clock line CKAL, and shift register units SP that are spaced by n stages are electrically connected to the same scan clock line CKBL.

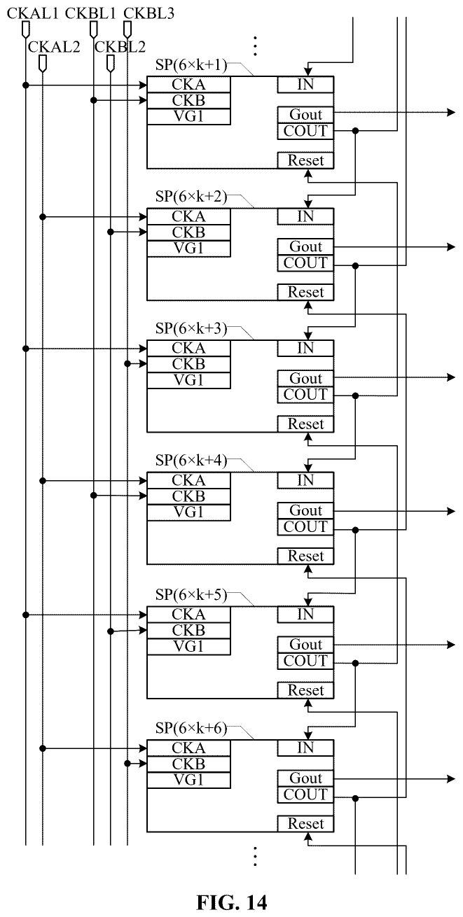

For example, the case m=2 and n=3 is used as an example. FIG. 14 is schematic diagram four of a circuit structure of a shift register according to an embodiment of the present disclosure. Referring to FIG. 14, the (6×k+1)-th stage shift register unit SP(6×k+1) is electrically connected to the first stage transfer clock line CKAL1 and the first scan clock line CKBL1 separately, the (6×k+2)-th stage shift register unit SP(6×k+2) is electrically connected to the second stage transfer clock line CKAL2 and the second scan clock line CKBL2 separately, the (6×k+3)-th stage shift register unit SP(6×k+3) is electrically connected to the first stage transfer clock line CKAL1 and the third scan clock line CKBL3 separately, the (6×k+4)-th stage shift register unit SP(6×k+4) is electrically connected to the second stage transfer clock line CKAL2 and the first scan clock line CKBL1 separately, the (6×k+5)-th stage shift register unit SP(6×k+5) is electrically connected to the first stage transfer clock line CKAL1 and the second scan clock line CKBL2 separately, and the (6×k+6)-th stage shift register unit SP(6×k+6) is electrically connected to the second stage transfer clock line CKAL2 and the third scan clock line CKBL3 separately. In one or more embodiments, m=3 and n=4; or m=3 and n=8.

n>m, which is conducive to reducing the number of shift register units SP connected to the same scan clock line CKBL, reducing the loads connected to the scan clock line CKBL, and reducing the signal delay of the scan clock signal on the scan clock line CKBL, thereby improving the driving capability of the scan output terminal GOUT, increasing the charging time for writing the data signal into the pixel P, and improving the charging rate.

It is to be noted that FIG. 14 only exemplarily shows that the stage transfer output terminal NEXT(j−1) of the (j−1)-th stage shift register unit SP(j−1) is electrically connected to the input terminal IN(j) of the j-th stage shift register unit SP(j), and the stage transfer output terminal NEXT(j+2) of the (j+2)-th stage shift register unit SP(j+2) is electrically connected to the reset terminal RST(j) of the j-th stage shift register unit SP(j), which is not limited thereto.

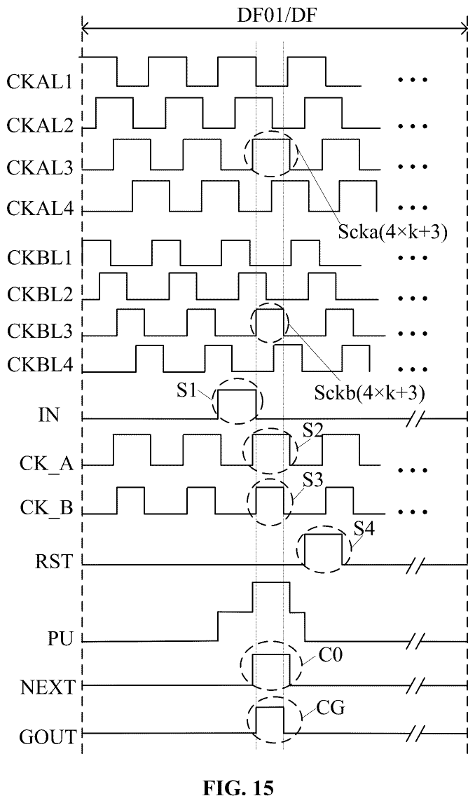

In one or more embodiments, FIG. 15 is timing diagram two of a shift register according to an embodiment of the present disclosure. Referring to FIG. 15, the effective duration of the effective pulse of the stage transfer clock signal is greater than or equal to the effective duration of the scan clock signal.

For example, the case where the valid levels are all high levels is used as an example. Referring to FIGS. 10 and 15, the effective duration of the effective pulse of the stage transfer clock signal on the stage transfer clock line CKAL is greater than or equal to the effective duration of the effective pulse of the scan clock signal on the scan clock line CKBL so that the effective duration of the second effective pulse S2 at the stage transfer clock terminal CK_A of the shift register unit SP is greater than or equal to the effective duration of the third effective pulse S3 at the scan clock terminal CK_B. In this manner, the duration during which the stage transfer output terminal NEXT outputs a high-level signal and the voltage of the first node PU is pulled up by coupling is greater than or equal to the duration during which the scan output terminal GOUT outputs a high level, which is conducive to improving the output efficiency of the scan output transistor M3 when the scan output terminal GOUT outputs a valid level, thereby improving the driving capability of the scan signal at the scan output terminal GOUT for the pixel P.

In one or more embodiments, with continued reference to FIG. 15, during at least part of the pixel refresh time of the display frame DF, in the stage transfer clock line CKAL and the scan clock line CKBL connected to the j-th stage shift register unit SP(j), the effective pulse of the stage transfer clock signal overlapping with the effective pulse C0 of the stage transfer signal output by the j-th stage shift register unit SP(j) is the j-th stage transfer clock pulse Scka(j), and the effective pulse of the scan clock signal overlapping with the effective pulse CG of the scan signal output by the j-th stage shift register unit SP(j) is the j-th scan clock pulse Sckb(j), where j is a positive integer. The start moment of the j-th stage transfer clock pulse Scka(j) is before the start moment of the j-th scan clock pulse Sckb(j), and/or the end moment of the j-th stage transfer clock pulse Scka(j) is after the end moment of the j-th scan clock pulse Sckb(j).

For example, referring to FIGS. 11 and 15, the case where the valid levels are all high levels and j=4×k+3 is used as an example. The third stage transfer clock line CKAL3 and the third scan clock line CKBL3 are electrically connected to the (4×k+3)-th stage shift register unit SP(4×k+3); the stage transfer clock signal transmitted on the third stage transfer clock line CKAL3 includes the (4×k+3)-th stage transfer clock pulse Scka(4×k+3), that is, the second effective pulse S2 at the stage transfer clock terminal CK_A of the (4×k+3)-th stage shift register unit SP(4×k+3); the scan clock signal transmitted on the third scan clock line CKBL3 includes the (4×k+3)-th scan clock pulse Sckb(4×k+3), that is, the third effective pulse S3 at the scan clock terminal CK_B of the (4×k+3)-th stage shift register unit SP(4×k+3).

The start moment of the j-th stage transfer clock pulse Scka(j) is before the start moment of the j-th scan clock pulse Sckb(j), and/or the end moment of the j-th stage transfer clock pulse Scka(j) is after the end moment of the j-th scan clock pulse Sckb(j) so that in the same shift register unit SP, the start moment of the second effective pulse S2 is before the start moment of the third effective pulse S3, and/or the end moment of the second effective pulse S2 is after the end moment of the third effective pulse S3. In this manner, at the moment when the scan signal at the scan output terminal GOUT transitions from the invalid level to the valid level and/or at the moment when the scan signal transitions from the valid level to the invalid level, the voltage of the first node PU is at a valid level and is coupled to a state in which an absolute value is increased, that is, the scan output terminal GOUT can output the complete effective pulse CG of the scan signal with a higher output efficiency, thereby improving the driving capability and reducing the signal delay.

It is to be understood that when the effective duration of the j-th stage transfer clock pulse Scka(j) is the same as the effective duration of the j-th stage scan clock pulse Sckb(j), to ensure that the scan signal at the scan output terminal GOUT transitions from the valid level to the invalid level without trailing and the refresh of the pixels P in the next row is not affected, the start moment of the j-th stage transfer clock pulse Scka(j) is after the start moment of the j-th scan clock pulse Sckb(j) (not shown in FIG. 15), thereby ensuring that the end moment of the j-th stage transfer clock pulse Scka(j) is after the end moment of the j-th scan clock pulse Sckb(j), which is conducive to increasing the speed at which the scan signal at the scan output terminal GOUT transitions from the valid level to the invalid level. In this manner, the effective pulse CG of the scan signal does not exhibit trailing.

Based on the preceding embodiments, with continued reference to FIG. 15, in the stage transfer clock line CKAL and the scan clock line CKBL connected to the j-th stage shift register unit SP(j), the effective period of the j-th stage transfer clock pulse Scka(j) of the stage transfer clock signal overlaps with only the effective period of the j-th scan clock pulse Sckb(j) of the scan clock signal.

For example, referring to FIGS. 11 and 15, the case where the valid levels are all high levels and j=4×k+3 is used as an example, the third stage transfer clock line CKAL3 and the third scan clock line CKBL3 are electrically connected to the (4×k+3)-th stage shift register unit SP(4×k+3), and the (4×k+3)-th stage transfer clock pulse Scka(4×k+3) transmitted on the third stage transfer clock line CKAL3 overlaps with only the (4×k+3)-th scan clock pulse Sckb(4×k+3) transmitted on the third scan clock line CKBL3 and does not overlap with the previous effective pulse and the subsequent effective pulse of the (4×k+3)-th scan clock pulse Sckb(4×k+3) transmitted on the third scan clock line CKBL3. In this manner, during the effective period of the second effective pulse S2, only the effective period of the third effective pulse S3 exists; during the effective period of the second effective pulse S2, except for the effective period of the third effective pulse S3, the effective periods of other effective pulses do not exist at the scan clock terminal CK_B, thereby preventing the scan output terminal GOUT from outputting multiple effective pulses or having voltage spikes during the pixel refresh time of one display frame DF and thus preventing the row-by-row refresh of the pixels P from being affected.

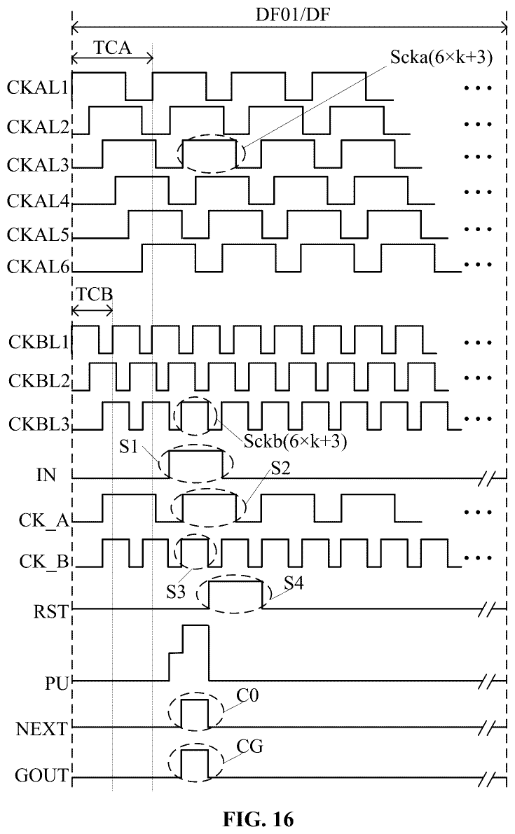

In one or more embodiments, FIG. 16 is timing diagram three of a shift register according to an embodiment of the present disclosure. Referring to FIGS. 10 and 16, in the stage transfer clock line CKAL and the scan clock line CKBL connected to the j-th stage shift register unit SP(j), the effective period of the j-th stage transfer clock pulse Scka(j) of the stage transfer clock signal overlaps with the effective period of the j-th scan clock pulse Sckb(j) of the scan clock signal, and the effective period of the j-th stage transfer clock pulse Scka(j) of the stage transfer clock signal also overlaps with the effective period of the next transition cycle of the j-th scan clock pulse Sckb(j) of the scan clock signal.

The shift register unit SP further includes the reset circuit 140; the reset circuit 140 is electrically connected to the reset terminal RST, the first voltage terminal VG1, and the first node PU separately; the reset circuit 140 is used for controlling, according to the reset signal at the reset terminal RST, the transmission path on which the signal at the first voltage terminal VG1 is transmitted to the first node PU; the start moment of the effective pulse of the reset signal at the reset terminal RST of the shift register unit SP overlaps with the effective pulse of the stage transfer clock signal connected to the shift register unit SP; the start moment of the effective pulse of the reset signal at the reset terminal RST(j) of the j-th stage shift register unit SP(j) is before the second effective pulse overlapping with the j-th stage transfer clock pulse Scka(j) in the scan clock line CKBL connected to the j-th stage shift register unit SP(j).

Usually, one high-level signal and one consecutive low-level signal form a transition cycle of the scan clock signal. The effective period of the next transition cycle of the j-th scan clock pulse Sckb(j) of the scan clock signal refers to the effective period of the adjacent effective pulse after the j-th scan clock pulse Sckb(j) in the scan clock signal transmitted on the scan clock line CKBL connected to the j-th stage shift register unit SP(j) and also refers to the effective period of the effective pulse that is after the j-th scan clock pulse Sckb(j) and spaced from the j-th scan clock pulse Sckb(j) by a low-level signal. In the scan clock line CKBL connected to the j-th stage shift register unit SP(j), the j-th scan clock pulse Sckb(j) is the first effective pulse overlapping with the j-th stage transfer clock pulse Scka(j), and the effective period of the next transition cycle of the j-th scan clock pulse Sckb(j) is the effective period of the second effective pulse overlapping with the j-th stage transfer clock pulse Scka(j); the start moment of the effective pulse of the reset signal at the reset terminal RST(j) of the j-th stage shift register unit SP(j) is before the second effective pulse overlapping with the j-th stage transfer clock pulse Scka(j) so that the start moment of the effective pulse of the reset signal at the reset terminal RST(j) overlaps with the j-th stage transfer clock pulse Scka(j).

For example, referring to FIGS. 10 and 16, the case where the valid levels are all high levels and j=6×k+3 is used as an example. The third stage transfer clock line CKAL3 and the third scan clock line CKBL3 are electrically connected to the (6×k+3)-th stage shift register unit SP(6×k+3); the stage transfer clock signal transmitted on the third stage transfer clock line CKAL3 includes the (6×k+3)-th stage transfer clock pulse Scka(6×k+3), that is, the second effective pulse S2 at the stage transfer clock terminal CK_A of the (6×k+3)-th stage shift register unit SP(6×k+3); the scan clock signal transmitted on the third scan clock line CKBL3 includes the (6×k+3)-th scan clock pulse Sckb(6×k+3), that is, the third effective pulse S3 at the scan clock terminal CK_B of the (6×k+3)-th stage shift register unit SP(6×k+3). In the third stage transfer clock line CKAL3 and the third scan clock line CKBL3, the effective period of the (6×k+3)-th stage transfer clock pulse Scka(6×k+3) is longer. When the effective period of the (6×k+3)-th stage transfer clock pulse Scka(6×k+3) overlaps with the effective period of the (6×k+3)-th scan clock pulse Sckb(6×k+3) and the effective period of the effective pulse after the (6×k+3)-th scan clock pulse Sckb(6×k+3), that is, in the (6×k+3)-th stage shift register unit SP(6×k+3), when the effective period of the second effective pulse S2 at the stage transfer clock terminal CK_A overlaps with the effective period of the third effective pulse S3 at the scan clock terminal CK_B and the effective period of the effective pulse after the third effective pulse S3, the start moment of the fourth effective pulse S4 of the reset signal at the reset terminal RST(6×k+3) is before the effective pulse after the j-th scan clock pulse Sckb(j), that is, the start moment of the fourth effective pulse S4 is before the effective pulse after the third effective pulse S3 so that before the start moment of the effective pulse after the third effective pulse S3, the voltage of the first node PU is reset to a low level, and the scan output transistor M3 is turned off. In this manner, the effective pulse after the third effective pulse S3 cannot be transmitted to the scan output terminal GOUT, thereby preventing the scan output terminal GOUT from outputting two effective pulses or having voltage spikes and thus preventing the row-by-row refresh of the pixels P from being affected.

In one or more embodiments, the start moment of the effective pulse of the reset signal at the reset terminal RST(j) of the j-th stage shift register unit SP(j) is after the j-th scan clock pulse Sckb(j), that is, the start moment of the fourth effective pulse S4 is after the third effective pulse S3, thereby preventing the reset circuit 140 from prematurely resetting the first node PU to an invalid level and thus preventing the output of a valid level by the scan output terminal GOUT from being affected.

In one or more embodiments, with continued reference to FIG. 16, the transition cycles of the stage transfer clock signals transmitted on the stage transfer clock lines CKAL are the same; the transition cycles of the scan clock signals transmitted on the scan clock lines CKBL are the same; the ratio of the transition cycle of the stage transfer clock signal to the transition cycle of the scan clock signal is m/n.

For example, the case where the shift register VSR is electrically connected to six stage transfer clock lines CKAL and three scan clock lines CKBL and the valid levels are all high levels is used as an example. Referring to FIG. 16, during the transition stage in which the stage transfer clock signal transmitted on the stage transfer clock line CKAL undergoes one high-level signal transition and one low-level signal transition, the scan clock signal transmitted on the scan clock line CKBL has undergone two high-level signal transitions and two low-level signal transitions. The ratio of the transition cycle of the stage transfer clock signal to the transition cycle of the scan clock signal is 6/3. During the transition stage in which the stage transfer clock signal transmitted on the stage transfer clock line CKAL undergoes the (e×2)-th high-level signal transition and the (e×2)-th low-level signal transition, the scan clock signal transmitted on the scan clock line CKBL may undergo the e-th high-level signal transition and the e-th low-level signal transition, where e is a positive integer. In this manner, it can be ensured that the effective pulses on the stage transfer clock line CKAL and the scan clock line CKBL connected to the same shift register unit SP can overlap accordingly, thereby avoiding misalignment or changes in overlap duration after multiple transition cycles and thus preventing the output of effective pulses CG with the same pulse width by the scan output terminals GOUT of the shift register units SP from being affected.

In one or more embodiments, with continued reference to FIG. 16, the shift register VSR is electrically connected to m stage transfer clock lines CKAL and n scan clock lines CKBL, and m and n are both positive integers; the effective pulses of the stage transfer clock signals transmitted on the m stage transfer clock lines CKAL are shifted in sequence; the pixel refresh time of one display frame DF includes multiple stage transfer clock cycles TCA, and in one stage transfer clock cycle TCA, the stage transfer clock signals on the m stage transfer clock lines CKAL transition to the valid level in sequence; the effective pulses of the scan clock signals transmitted on the n scan clock lines CKBL are shifted in sequence; the pixel refresh time of one display frame DF includes at least one scan clock cycle TCB, and in one scan clock cycle TCB, the scan clock signals on the n scan clock lines CKBL transition to the valid level in sequence.

The stage transfer clock cycle TCA is the transition cycle of the stage transfer clock signal. In the transition cycle of the stage transfer clock signal on a certain stage transfer clock line CKAL, the effective pulses of the stage transfer clock signal on this stage transfer clock line CKAL and the valid levels of the stage transfer clock signals on other stage transfer clock lines CKAL are further included. The sequential transitions of the stage transfer clock signals on the stage transfer clock lines CKAL to the valid level form one stage transfer clock cycle TCA. In one or more embodiments, the transition cycles of the stage transfer clock signals on the stage transfer clock lines CKAL are the same so that the stage transfer clock cycles TCA are the same, and the time intervals between the sequential transitions of the stage transfer clock signals on the stage transfer clock lines CKAL to the valid level in the same stage transfer clock cycle TCA are the same.

Similarly, the scan clock cycle TCB is the transition cycle of the scan clock signal. In the transition cycle of the scan clock signal on a certain scan clock line CKBL, the effective pulses of the scan clock signal on this scan clock line CKBL and the valid levels of the scan clock signals on other scan clock lines CKBL are further included. The sequential transitions of the scan clock signals on the scan clock lines CKBL to the valid level form one scan clock cycle TCB. In one or more embodiments, the transition cycles of the scan clock signals on the scan clock lines CKBL are the same so that the scan clock cycles TCB are the same, and the time intervals between the sequential transitions of the scan clock signals on the scan clock lines CKBL to the valid level in the same scan clock cycle TCB are the same.

It is to be understood that during the pixel refresh time of any display frame DF, the stage transfer clock signals on the stage transfer clock lines CKAL may always be in the stage transfer clock cycles TCA and transition to the valid level in sequence. The scan clock signals on the scan clock lines CKBL are in the scan clock cycles TCB during the pixel refresh time of the first display frame DF01 and the portion of the pixel refresh time of the second display frame DF02 and transition to the valid level in sequence. During the portion of the pixel refresh time of the second display frame DF02, each of the scan clock signals on the scan clock lines CKBL is outside the scan clock cycle TCB, and during this stage, the scan clock signals on the scan clock lines CKBL are all at invalid levels.

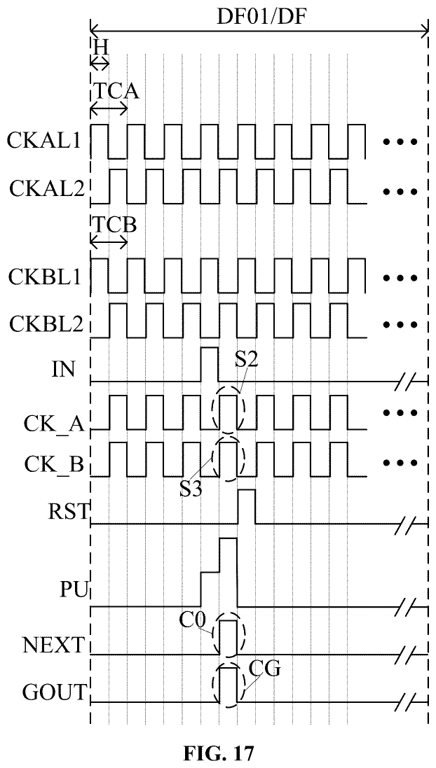

In one or more embodiments, FIG. 17 is timing diagram four of a shift register according to an embodiment of the present disclosure. Referring to FIG. 17, in one scan clock cycle TCB, the effective period of the effective pulse of one scan clock signal overlaps with one row refresh stage H; and in one or more scan clock cycles TCB, the effective periods of the effective pulses of two adjacent scan clock signals that transition to the valid level in sequence do not overlap.

The row refresh stage H may be the cycle of row trigger pulses (not shown in the figure) of a row synchronization signal, that is, the period between the start moments of two adjacent row trigger pulses, which is the refresh time for one row of pixels P.

For example, the effective pulse duration of the scan clock signal on the scan clock line CKBL is less than or equal to the duration of the row refresh stage H. The effective pulse durations of the scan clock signals on different scan clock lines CKBL do not overlap so that the effective duration of the third effective pulse S3 at the scan clock terminal CK_B of the shift register unit SP and the effective duration of the effective pulse CG at the scan output terminal GOUT are both less than or equal to the duration of the row refresh stage H. In the next row refresh stage H, when the pixels P in the next row are refreshed, refreshing for the current row of pixels P is stopped, thereby preventing the data signals of the next row of pixels P from being written into the current row of pixels P.

The case where the valid levels are all high levels and n=2 is used as an example. Referring to FIG. 17, the scan clock cycle TCB includes two row refresh stages H. The start moments of the effective pulses of two adjacent scan clock signals may be spaced by one row refresh stage H so that the start moments of the effective pulses of the scan signals of the two continuously cascaded shift register units SP are also spaced by one row refresh stage H. Within the scan clock cycle TCB, the effective period of the effective pulse of the scan clock signal on the first scan clock line CKB1 does not overlap with the effective period of the effective pulse of the scan clock signal on the second scan clock line CKB2.

In one or more embodiments, as shown in FIG. 17, the scan clock cycle TCB includes two row refresh stages H, n=2, and the duty cycle of the scan clock signal is less than or equal to 50%. Within the transition cycle, the duty cycle refers to the ratio of the duration between the start moment when the signal transitions from the invalid level to the valid level and the end moment when the signal transitions from the valid level to the invalid level to the transition cycle. When the duty cycle is 50%, the effective durations of the scan clock signals on adjacent scan clock lines CKBL do not overlap.

In one or more embodiments, the scan clock cycle may include three, four, five, six, seven, or eight row refresh stages, n=3, 4, 5, 6, 7, or 8, and the duty cycle of the scan clock signal is less than 50% (not shown in FIG. 17).

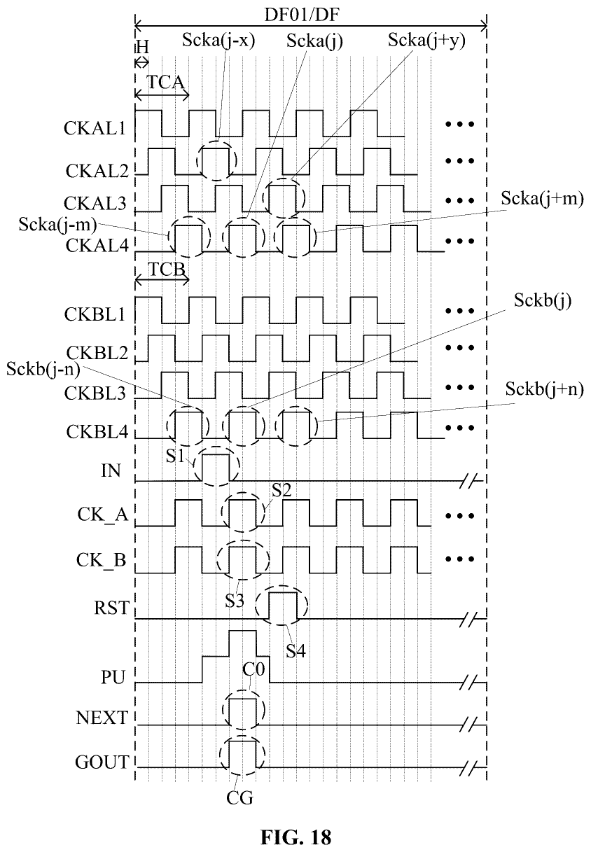

In one or more embodiments, FIG. 18 is timing diagram five of a shift register according to an embodiment of the present disclosure. Referring to FIG. 18, in the scan clock cycle TCB, the effective period of the effective pulse of one scan clock signal overlaps with two adjacent row refresh stages H; and in one or more scan clock cycles TCB, the effective periods of the effective pulses of two adjacent scan clock signals that transition to the valid level in sequence overlap.

For example, the effective pulse duration of the scan clock signal on the scan clock line CKBL is greater than the duration of one row refresh stage H and less than or equal to the duration of two row refresh stages H, and the effective pulse durations of the scan clock signals on adjacent scan clock lines CKBL overlap so that the effective period of the third effective pulse S3 at the scan clock terminal CK_B of the shift register unit SP and the effective period of the effective pulse CG at the scan output terminal GOUT each overlap with two adjacent row refresh stages H. When pixels in the previous row are being refreshed, pixels in the current row may be pre-charged with the data signals of pixels in the previous row to perform bias adjustment; and when pixels in the current row are being refreshed, pixels in the next row may be pre-charged with the data signals of pixels in the current row to perform bias adjustment. In one or more embodiments, after the scan signal received by the previous row of pixels P transitions to the invalid level, the source driver circuit SDC may provide the data signals of the current row of pixels P for the data lines DL so that the corresponding data signals can be written into the current row of pixels. Moreover, after the scan signal received by the current row of pixels P transitions to the invalid level, the source driver circuit SDC provides the data signals of the next row of pixels P for the data lines DL so that the last data signal written into the current row of pixels P is the data signal of the current row of pixels P, and the corresponding grayscale is displayed according to the data signals of the current row of pixels P.

The case where the valid levels are all high levels and n=4 is used as an example. Referring to FIG. 18, the scan clock cycle TCB includes four row refresh stages H. The start moments of the effective pulses of two adjacent scan clock signals may be spaced by one row refresh stage H so that the start moments of the effective pulses of the scan signals of the two continuously cascaded shift register units SP are also spaced by one row refresh stage H. Within the scan clock cycle TCB, the effective period of the effective pulse of the scan clock signal on the first scan clock line CKB1 overlaps with the effective period of the effective pulse of the scan clock signal on the second scan clock line CKB2, and the overlap duration is less than the duration of one row refresh stage H.

In one or more embodiments, as shown in FIG. 18, the scan clock cycle TCB includes four row refresh stages H, n=4, and the duty cycle of the scan clock signal is greater than 25% and less than or equal to 50%.

In one or more embodiments, the scan clock cycle may include three row refresh stages, n=3, and the duty cycle of the scan clock signal may be greater than 50%; or the scan clock cycle may include five, six, seven, or eight row refresh stages, n=5, 6, 7, or 8, and the duty cycle of the scan clock signal is less than 50% (not shown in FIG. 18).

Based on the preceding embodiments, referring to FIGS. 17 and 18, when m=n and the number of stage transfer clock lines CKAL is equal to the number of scan clock lines CKBL, the stage transfer clock cycle TCA may be the same as the scan clock cycle TCB so that the effective pulses of the stage transfer clock signals can overlap with the effective pulses of the scan clock signals in one-to-one correspondence, thereby matching the sequential driving of the shift register units SP and the row-by-row refresh of the pixels P. In this manner, it is ensured that the sequential driving of the shift register units SP and the row-by-row scanning of the pixels P can be performed synchronously and the shift register VSR and the pixels P in the display region AA can cooperate with each other and work stably.

In an embodiment, when m=n, the stage transfer clock cycle TCA is the same as the scan clock cycle TCB, and the duty cycle of the stage transfer clock signal may be greater than or equal to the duty cycle of the scan clock signal so that in the same shift register unit SP, the effective duration of the second effective pulse S2 may be greater than or equal to the effective duration of the third effective pulse S3, thereby improving the output efficiency when the scan output terminal GOUT outputs the valid level.

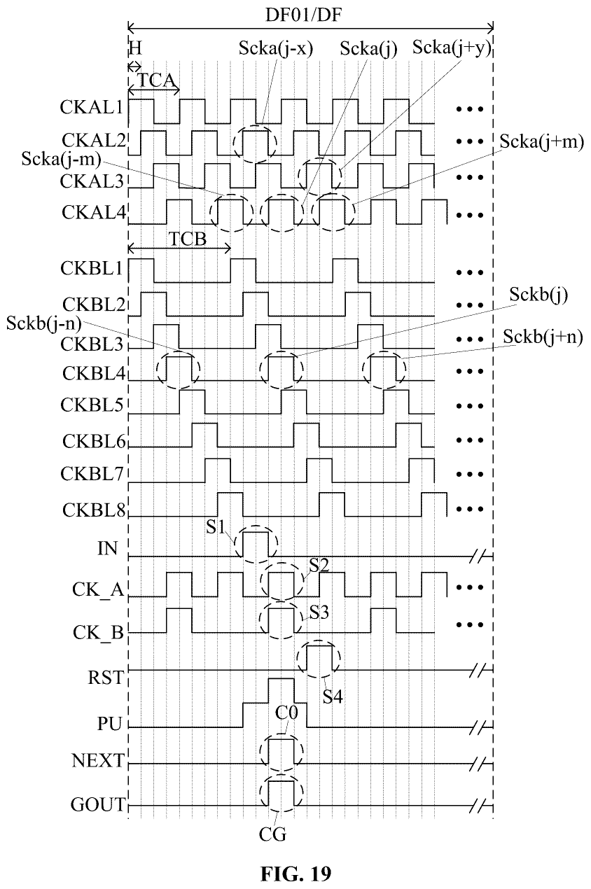

In one or more embodiments, FIG. 19 is timing diagram six of a shift register according to an embodiment of the present disclosure. Referring to FIG. 19, when m<n and the number of stage transfer clock lines CKAL is less than the number of scan clock lines CKBL, the stage transfer clock cycle TCA is less than the scan clock cycle TCB. In this manner, during the effective period of the effective pulse of each scan clock signal, at least one stage transfer clock signal including the valid level exists, thereby matching the sequential driving of the shift register units SP and the row-by-row refresh of the pixels P. Therefore, it is ensured that the sequential driving of the shift register units SP and the row-by-row scanning of the pixels P can be performed synchronously and the shift register VSR and the pixels P in the display region AA can cooperate with each other and work stably. Moreover, m<n so that the number of scan clock lines CKBL is larger and the number of shift register units SP connected to the same scan clock line CKBL is smaller, which is conducive to reducing the loads connected to the scan clock line CKBL and reducing the signal delay of the scan clock signal, thereby improving the driving capability of the scan output terminal GOUT, increasing the charging time for writing the data signal into the pixel P, and improving the charging rate.

In an embodiment, when m<n, the stage transfer clock cycle TCA is less than the scan clock cycle TCB, and the duty cycle of the stage transfer clock signal is greater than the duty cycle of the scan clock signal. For example, when the stage transfer clock cycle TCA includes four row refresh stages and the scan clock cycle TCB includes eight row refresh stages, the duty cycle of the stage transfer clock signal may be greater than or equal to 50%, and the duty cycle of the scan clock signal may be less than or equal to 25% so that in the same shift register unit SP, the effective duration of the second effective pulse S2 may be greater than or equal to the effective duration of the third effective pulse S3, thereby improving the output efficiency when the scan output terminal GOUT outputs the valid level.

In one or more embodiments, referring to FIGS. 18 and 19, the input terminal IN(j) of the j-th stage shift register unit SP(j) is electrically connected to the stage transfer output terminal NEXT(j−x) of the (j−x)-th stage shift register unit SP(j−x), where j and x are positive integers, j>x, and x≤m−1.

For example, the stage transfer output terminal NEXT(j) of the j-th stage shift register unit SP(j) may output the effective pulse of the stage transfer clock signal on a certain stage transfer clock line CKAL as the effective pulse C0(j) of the stage transfer signal, the stage transfer output terminal NEXT(j−1) of the (j−1)-th stage shift register unit SP(j−1) may output the preceding effective pulse that transitions to the valid level in the same stage transfer clock cycle TCA as the effective pulse C0(j−1) of the stage transfer signal, and the stage transfer output terminal NEXT(j−x) of the (j−x)-th stage shift register unit SP(j−x) outputs the effective pulse occurring x phases earlier that transition to the valid level in the same stage transfer clock cycle TCA to obtain the first effective pulse S1 (j) of the input signal at the input terminal IN(j) of the j-th stage shift register unit SP(j). Therefore, in the same shift register unit SP, the first effective pulse S1 at the input terminal IN and the effective pulse C0 at the stage transfer output terminal NEXT may be obtained through the effective pulses of two stage transfer clock signals with a transition sequence difference of x in the same stage transfer clock cycle TCA. For example, in the same shift register unit SP, the first effective pulse S1 at the input terminal IN may be obtained through the first effective pulse that transitions to the valid level in the stage transfer clock cycle TCA, and the effective pulse C0 at the stage transfer output terminal NEXT may be obtained through the (1+X)-th effective pulse that transitions to the valid level in the same stage transfer clock cycle TCA. In the same shift register unit SP, the start moment of the first effective pulse S1 at the input terminal IN is before the start moment of the effective pulse C0 at the stage transfer output terminal NEXT and is spaced from the start moment of the effective pulse C0 at the stage transfer output terminal NEXT by x row refresh stages H.

Referring to FIGS. 18 and 19, when m=4 and n=4 or 8, the stage transfer clock cycle TCA may include four row refresh stages H, and the scan clock cycle TCB may include four or eight row refresh stages H. If each of the duration during which the stage transfer clock signal is at a valid level and the duration during which the scan clock signal is at a valid level is greater than one row refresh stage H and less than or equal to two row refresh stages H, x may be set to 1 or 2. If each of the duration during which the stage transfer clock signal is at a valid level and the duration during which the scan clock signal is at a valid level is less than or equal to one row refresh stage H, x may be set to 3. In this manner, the start moment of the first effective pulse S1 at the input terminal IN overlaps with the invalid-level stage of the stage transfer clock terminal CK_A, and the start moment of the first effective pulse S1 at the input terminal IN overlaps with the invalid-level stage of the scan clock terminal CK_B, thereby avoiding the following: the effective period of the first effective pulse S1 at the input terminal IN overlaps with the effective period of the previous effective pulse of the second effective pulse S2 at the stage transfer clock terminal CK_A, and the effective period of the first effective pulse S1 overlaps with the effective period of the previous effective pulse of the third effective pulse S3 at the scan clock terminal CK_B, causing the stage transfer output terminal NEXT to output multiple effective pulses or have voltage spikes during the pixel refresh time of one display frame DF, or causing the scan output terminal GOUT to output multiple effective pulses or have voltage spikes during the pixel refresh time of one display frame DF.

In an embodiment, x is a positive integer. x is less than or equal to the duration during which the stage transfer clock signal is at an invalid level divided by the duration of the row refresh stage H so that it can be ensured that the effective period of the first effective pulse S1 at the input terminal IN does not overlap with the effective period of the previous effective pulse of the second effective pulse S2 at the stage transfer clock terminal CK_A; and/or x is less than or equal to the duration during which the scan clock signal is at an invalid level divided by the duration of the row refresh stage H so that it can be ensured that the effective period of the first effective pulse S1 at the input terminal IN does not overlap with the effective period of the previous effective pulse of the third effective pulse S3 at the scan clock terminal CK_B.

It is to be noted that FIGS. 18 and 19 only show the case where m=4 and n=4 or 8. In one or more embodiments, m=2, 3, 5, 6, 7, or 8, and n>m. The duty cycle of the stage transfer clock signal may be greater than 50% or less than 50%. m and the duty cycle are not limited in the embodiments of the present disclosure.

In one or more embodiments, x is the maximum integer less than or equal to m−1.

Specifically, x is the maximum integer within a range so that a longer time interval exists between the start moment of the first effective pulse S1 at the input terminal IN and the start moment of the effective pulse C0 at the stage transfer output terminal NEXT in the same shift register unit SP, the input signal at the input terminal IN can transition to a valid level earlier, and the voltage of the first node PU can transition to a valid level earlier. In this manner, the following can be avoided: the voltage of the first node PU is at an invalid level for a long time, and the transistor coupled to the first node PU is in a certain state for a long time, leading to transistor biasing and threshold voltage drift and affecting the stable operation of the circuit.

In one or more embodiments, referring to FIGS. 18 and 19, during at least part of the pixel refresh time of the display frame DF, in the stage transfer clock line CKAL and the scan clock line CKBL connected to the j-th stage shift register unit SP(j), the effective pulse of the stage transfer clock signal overlapping with the effective pulse C0 of the stage transfer signal output by the j-th stage shift register unit SP(j) is the j-th stage transfer clock pulse Scka(j), and the effective pulse of the scan clock signal overlapping with the effective pulse of the scan signal output by the j-th stage shift register unit SP(j) is the j-th scan clock pulse Sckb(j); the effective period of the (j−x)-th stage transfer clock pulse Scka(j−x) does not overlap with the effective period of the (j−n)-th scan clock pulse Sckb(j−n).

For example, the stage transfer output terminal NEXT(j−x) of the (j−x)-th stage shift register unit SP(j−x) may output the (j−x)-th stage transfer clock pulse Scka(j−x) as the first effective pulse S1 at the input terminal IN of the j-th stage shift register unit SP(j); the j-th scan clock pulse Sckb(j) is the third effective pulse S3 at the scan clock terminal CK_B of the j-th stage shift register unit SP(j), and the (j−n)-th scan clock pulse Sckb(j−n) is the effective pulse of the scan clock signal in the previous scan clock cycle TCB, that is, the effective pulse in the previous transition cycle of the third effective pulse S3 at the scan clock terminal CK_B. The start moment of the (j−x)-th stage transfer clock pulse Scka(j−x) is before the start moment of the j-th scan clock pulse Sckb(j). That is, in the same shift register unit SP(j), the start moment of the first effective pulse S1 is before the start moment of the third effective pulse S3 at the scan clock terminal CK_B. The effective period of the (j−x)-th stage transfer clock pulse Scka(j−x) does not overlap with the effective period of the (j−n)-th scan clock pulse Sckb(j−n) so that in the same shift register unit SP(j), the effective period of the first effective pulse S1 does not overlap with the effective period of the effective pulse in the previous transition cycle of the third effective pulse S3 at the scan clock terminal CK_B. In this manner, the following can be avoided: the scan output terminal GOUT of the shift register unit SP outputs multiple effective pulses or has voltage spikes, affecting the row-by-row refresh of the pixels P.

In one or more embodiments, referring to FIGS. 18 and 19, the effective period of the (j−x)-th stage transfer clock pulse Scka(j−x) does not overlap with the effective period of the (j−m)-th stage transfer clock pulse Scka(j−m) so that in the same shift register unit SP(j), the effective period of the first effective pulse S1 does not overlap with the effective period of the effective pulse in the previous transition cycle of the second effective pulse S2 at the stage transfer clock terminal CK_A. In this manner, the following can be avoided: the stage transfer output terminal NEXT of the shift register unit SP outputs multiple effective pulses or has voltage spikes, affecting the sequential driving of the shift register units SP.

In one or more embodiments, referring to FIGS. 10, 18, and 19, the shift register unit SP further includes the reset circuit 140; the reset circuit 140 is electrically connected to the reset terminal RST, the first voltage terminal VG1, and the first node PU separately; the reset circuit 140 is used for controlling, according to the reset signal at the reset terminal RST, the transmission path on which the signal at the first voltage terminal VG1 is transmitted to the first node PU. The reset terminal RST(j) of the j-th stage shift register unit SP(j) is electrically connected to the stage transfer output terminal NEXT(j+y) of the (j+y)-th stage shift register unit SP(j+y), where j and y are both positive integers, and m−1≤y<m.

For example, the stage transfer output terminal NEXT(j) of the j-th stage shift register unit SP(j) may output the effective pulse of the stage transfer clock signal on a certain stage transfer clock line CKAL as the effective pulse C0(j) of the stage transfer signal, and the stage transfer output terminal NEXT(j+y) of the (j+y)-th stage shift register unit SP(j+y) outputs the pulse that transitions to the valid level y phases later within the same TCA to obtain the fourth effective pulse S4(j) of the reset signal at the reset terminal RST(j) of the j-th stage shift register unit SP(j). Therefore, in the same shift register unit SP, the fourth effective pulse S4 at the reset terminal RST and the effective pulse C0 at the stage transfer output terminal NEXT may be obtained through the effective pulses of two stage transfer clock signals with a transition sequence difference of y in the same stage transfer clock cycle TCA. For example, in the same shift register unit SP, the effective pulse C0 at the stage transfer output terminal NEXT may be obtained through the first effective pulse that transitions to the valid level in the stage transfer clock cycle TCA, and the fourth effective pulse S4 at the reset terminal RST may be obtained through the (1+y)-th effective pulse that transitions to the valid level in the same stage transfer clock cycle TCA. In the same shift register unit SP, the start moment of the effective pulse C0 at the stage transfer output terminal NEXT is before the start moment of the fourth effective pulse S4 at the reset terminal RST and is spaced from the start moment of the fourth effective pulse S4 at the reset terminal RST by y row refresh stages H.

With continued reference to FIGS. 10, 18, and 19, when m=4 and n=4 or 8, the stage transfer clock cycle TCA may include four row refresh stages H, and the scan clock cycle TCB may include four or eight row refresh stages H. If the duration during which the stage transfer clock signal is at a valid level is greater than the duration during which the scan clock signal is at a valid level and the duration during which the scan clock signal is at a valid level is greater than one row refresh stage H and less than or equal to two row refresh stages H, y may be set to 2 or 3. If the duration during which the scan clock signal is at a valid level is less than or equal to one row refresh stage H, y may be set to 1. In this manner, the start moment of the fourth effective pulse S4 at the reset terminal RST is after the end moment of the effective pulse CG at the scan output terminal GOUT, before the effective pulse in the next transition cycle of the second effective pulse S2 at the stage transfer clock terminal CK_A, and before the effective pulse in the next transition cycle of the third effective pulse S3 at the scan clock terminal CK_B so that the following can be avoided: the stage transfer output terminal NEXT and the scan output terminal GOUT output multiple effective pulses or have voltage spikes during the pixel refresh time of one display frame DF, or the effective pulse CG of the scan signal output from the scan output terminal GOUT is narrower than the third effective pulse S3 of the scan clock signal, affecting the row-by-row refresh of the pixels P.

In an embodiment, y is a positive integer, and y is greater than or equal to the duration during which the scan clock signal is at a valid level divided by the duration of the row refresh stage H, thereby ensuring that the fourth effective pulse S4 at the reset terminal RST does not overlap with the third effective pulse S3 at the scan clock terminal CK_B.

In another embodiment, y is a positive integer. y is less than the stage transfer clock cycle TCA divided by the duration of the row refresh stage H, thereby preventing a voltage spike from occurring after the effective pulse C0 at the stage transfer output terminal NEXT; and/or y is less than the scan clock cycle TCB divided by the duration of the row refresh stage H, thereby preventing a voltage spike from occurring after the effective pulse CG at the scan output terminal GOUT.

In one or more embodiments, y is the maximum integer greater than or equal to m−1 and less than m.

Specifically, y is the maximum integer within a range so that a longer time interval exists between the start moment of the effective pulse C0 at the stage transfer output terminal NEXT and the start moment of the fourth effective pulse S4 at the reset terminal RST in the same shift register unit SP, and the voltage of the first node PU can be reset to an invalid level later. In this manner, the following can be avoided: the voltage of the first node PU is at an invalid level for a long time, and the transistor coupled to the first node PU is in a certain state for a long time, leading to transistor biasing and threshold voltage drift and affecting the stable operation of the circuit.

In one or more embodiments, with continued reference to FIGS. 10, 18, and 19, the effective period of the (j+y)-th stage transfer clock pulse Scka(j+y) does not overlap with the effective period of the j-th scan clock pulse Sckb(j).

For example, the stage transfer output terminal NEXT(j+y) of the (j+y)-th stage shift register unit SP(j+y) may output the (j+y)-th stage transfer clock pulse Scka(j+y) as the fourth effective pulse S4 at the reset terminal RST of the j-th stage shift register unit SP(j); and the j-th scan clock pulse Sckb(j) is the third effective pulse S3 at the scan clock terminal CK_B of the j-th stage shift register unit SP(j). The start moment of the (j+y)-th stage transfer clock pulse Scka(j+y) is after the start moment of the j-th scan clock pulse Sckb(j). That is, in the same shift register unit SP(j), the start moment of the fourth effective pulse S4 is after the start moment of the third effective pulse S3 at the scan clock terminal CK_B. The effective period of the (j+y)-th stage transfer clock pulse Scka(j+y) does not overlap with the effective period of the j-th scan clock pulse Sckb(j) so that in the same shift register unit SP(j), the effective period of the fourth effective pulse S4 does not overlap with the effective period of the third effective pulse S3 at the scan clock terminal CK_B. In this manner, the following can be avoided: the effective duration of the effective pulse CG output from the scan output terminal GOUT of the shift register unit SP is different from the effective duration of the third effective pulse S3, affecting the row-by-row refresh of the pixels P.

In one or more embodiments, with continued reference to FIGS. 10, 18, and 19, the start moment of the (j+y)-th stage transfer clock pulse Scka(j+y) is before the start moment of the (j+n)-th scan clock pulse Sckb(j+n) so that in the same shift register unit SP(j), the start moment of the fourth effective pulse S4 is before the start moment of the effective pulse in the next transition cycle of the third effective pulse S3 at the scan clock terminal CK_B. In this manner, the following can be avoided: the scan output terminal GOUT of the shift register unit SP outputs multiple effective pulses or has voltage spikes, affecting the row-by-row refresh of the pixels P.

In one or more embodiments, with continued reference to FIGS. 10, 18, and 19, the start moment of the (j+y)-th stage transfer clock pulse Scka(j+y) is before the start moment of the (j+m)-th stage transfer clock pulse Scka(j+m) so that in the same shift register unit SP(j), the start moment of the fourth effective pulse S4 is before the start moment of the effective pulse in the next transition cycle of the second effective pulse S2 at the stage transfer clock terminal CK_A. In this manner, the following can be avoided: the stage transfer output terminal NEXT of the shift register unit SP outputs multiple effective pulses or has voltage spikes, affecting the row-by-row refresh of the pixels P.

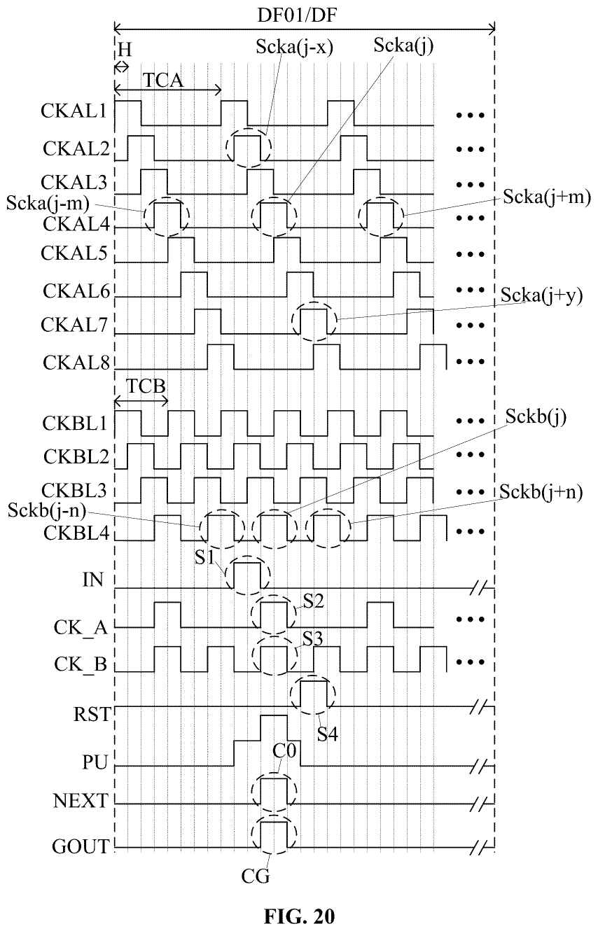

In one or more embodiments, FIG. 20 is timing diagram seven of a shift register according to an embodiment of the present disclosure. Referring to FIG. 20, when m>n and the number of stage transfer clock lines CKAL is greater than the number of scan clock lines CKBL, the stage transfer clock cycle TCA is greater than the scan clock cycle TCB. In this manner, during the effective period of the effective pulse of each stage transfer clock signal, at least one scan clock signal including the valid level exists, thereby matching the sequential driving of the shift register units SP and the row-by-row refresh of the pixels P. Therefore, it is ensured that the sequential driving of the shift register units SP and the row-by-row scanning of the pixels P can be performed synchronously and the shift register VSR and the pixels P in the display region AA can cooperate with each other and work stably.

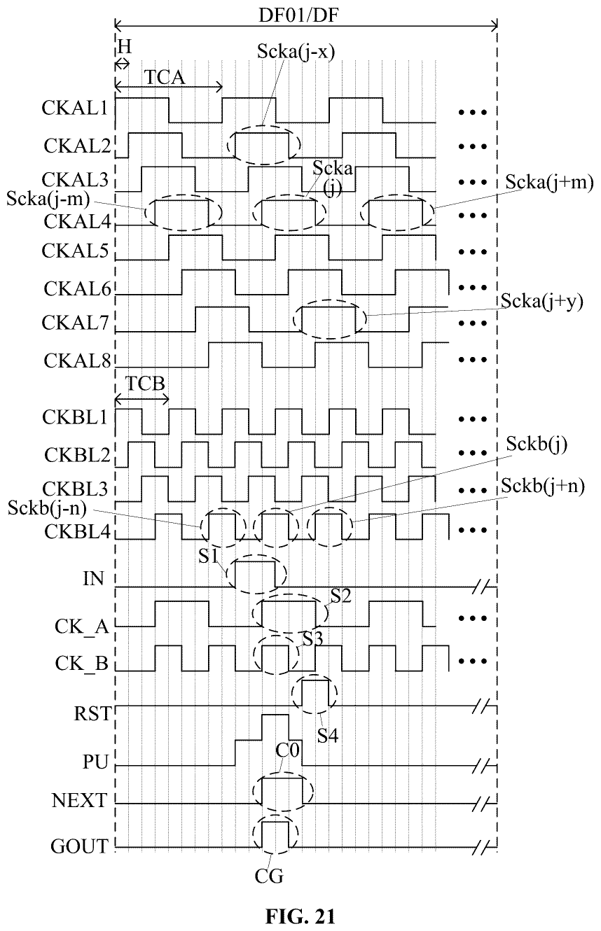

In one or more embodiments, FIG. 21 is timing diagram eight of a shift register according to an embodiment of the present disclosure. Referring to FIG. 21, the duty cycle of the stage transfer clock signal is equal to the duty cycle of the scan clock signal, and the duration of the effective pulse of the stage transfer clock signal is greater than the duration of the effective pulse of the scan clock signal.

For example, when the number of stage transfer clock lines CKAL is greater than the number of scan clock lines CKBL, the stage transfer clock cycle TCA of the stage transfer clock signal is greater than the scan clock cycle TCB of the scan clock signal, that is, the transition cycle of the stage transfer clock signal is greater than the transition cycle of the scan clock signal. In this manner, under the same duty cycle, the effective pulse width of the stage transfer clock signal is greater than the effective pulse width of the scan clock signal so that the duration during which the voltage of the first node PU is pulled up by coupling is greater than the effective duration of the effective pulse of the scan clock signal, and when the scan output terminal GOUT outputs the third effective pulse S3 at the scan clock terminal CK_B as the effective pulse CG of the scan signal, a higher output efficiency can always be maintained.

In one or more embodiments, referring to FIGS. 20 and 21, the input terminal IN(j) of the j-th stage shift register unit SP(j) is electrically connected to the stage transfer output terminal NEXT(j−x) of the (j−x)-th stage shift register unit SP(j−x), where j and x are both positive integers, j>x, and x≤n−1.

For example, in the same shift register unit SP, the first effective pulse S1 at the input terminal IN and the effective pulse C0 at the stage transfer output terminal NEXT may be obtained through the effective pulses of two stage transfer clock signals with a transition sequence difference of x in the same stage transfer clock cycle TCA. In the same shift register unit SP, the start moment of the first effective pulse S1 at the input terminal IN is before the start moment of the effective pulse C0 at the stage transfer output terminal NEXT and is spaced from the start moment of the effective pulse C0 at the stage transfer output terminal NEXT by x row refresh stages H.

Referring to FIGS. 20 and 21, when m=8 and n=4, the stage transfer clock cycle TCA may include eight row refresh stages H, and the scan clock cycle TCB may include four row refresh stages H. If the duration during which the stage transfer clock signal is at a valid level is greater than or equal to the duration during which the scan clock signal is at a valid level and the duration during which the scan clock signal is at a valid level is greater than one row refresh stage H and less than or equal to two row refresh stages H, x may be set to 1 or 2; if the duration during which the scan clock signal is at a valid level is less than or equal to one row refresh stage H, x may be set to 3. In this manner, the start moment of the first effective pulse S1 at the input terminal IN overlaps with the invalid-level stage of the stage transfer clock terminal CK_A, and the start moment of the first effective pulse S1 at the input terminal IN overlaps with the invalid-level stage of the scan clock terminal CK_B, thereby avoiding the following: the effective period of the first effective pulse S1 at the input terminal IN overlaps with the effective period of the previous effective pulse of the second effective pulse S2 at the stage transfer clock terminal CK_A, and the effective period of the first effective pulse S1 overlaps with the effective period of the previous effective pulse of the third effective pulse S3 at the scan clock terminal CK_B, causing the stage transfer output terminal NEXT to output multiple effective pulses or have voltage spikes during the pixel refresh time of one display frame DF, or causing the scan output terminal GOUT to output multiple effective pulses or have voltage spikes during the pixel refresh time of one display frame DF.

In an embodiment, x is a positive integer, x is less than or equal to the duration during which the stage transfer clock signal is at an invalid level divided by the duration of the row refresh stage H, and/or x is less than or equal to the duration during which the scan clock signal is at an invalid level divided by the duration of the row refresh stage H so that it can be ensured that the effective period of the first effective pulse S1 at the input terminal IN does not overlap with the effective period of the previous effective pulse of the second effective pulse S2 at the stage transfer clock terminal CK_A, and the effective period of the first effective pulse S1 at the input terminal IN does not overlap with the effective period of the previous effective pulse of the third effective pulse S3 at the scan clock terminal CK_B.

It is to be noted that FIGS. 20 and 21 only show the case where m=8 and n=4. In one or more embodiments, n=2, 3, 5, 6, 7, or 8, and m>n.

In one or more embodiments, x is the maximum integer less than or equal to n−1 so that a longer time interval exists between the start moment of the first effective pulse S1 at the input terminal IN and the start moment of the effective pulse C0 at the stage transfer output terminal NEXT in the same shift register unit SP. In this manner, the following can be avoided: the voltage of the first node PU is at an invalid level for a long time, and the transistor coupled to the first node PU is in a certain state for a long time, leading to transistor biasing and threshold voltage drift and affecting the stable operation of the circuit.

In one or more embodiments, referring to FIGS. 20 and 21, the effective period of the (j−x)-th stage transfer clock pulse Scka(j−x) does not overlap with the effective period of the (j−n)-th scan clock pulse Sckb(j−n); and/or the effective period of the (j−x)-th stage transfer clock pulse Scka(j−x) does not overlap with the effective period of the (j−m)-th stage transfer clock pulse Scka(j−m).

In one or more embodiments, referring to FIGS. 10, 20, and 21, the shift register unit SP further includes the reset circuit 140; the reset circuit 140 is electrically connected to the reset terminal RST, the first voltage terminal VG1, and the first node PU separately; the reset circuit 140 is used for controlling, according to the reset signal at the reset terminal RST, the transmission path on which the signal at the first voltage terminal VG1 is transmitted to the first node PU. The reset terminal RST(j) of the j-th stage shift register unit SP(j) is electrically connected to the stage transfer output terminal NEXT(j+y) of the (j+y)-th stage shift register unit SP(j+y), where j and y are both positive integers, and n−1≤y<n.

For example, in the same shift register unit SP, the fourth effective pulse S4 at the reset terminal RST and the effective pulse C0 at the stage transfer output terminal NEXT may be obtained through the effective pulses of two stage transfer clock signals with a transition sequence difference of y in the same stage transfer clock cycle TCA. In the same shift register unit SP, the start moment of the effective pulse C0 at the stage transfer output terminal NEXT is before the start moment of the fourth effective pulse S4 at the reset terminal RST and is spaced from the start moment of the fourth effective pulse S4 at the reset terminal RST by y row refresh stages H.

With continued reference to FIGS. 10, 20, and 21, when m=8 and n=4, the stage transfer clock cycle TCA may include eight row refresh stages H, and the scan clock cycle TCB may include four row refresh stages H. If the duration during which the stage transfer clock signal is at a valid level is greater than the duration during which the scan clock signal is at a valid level and the duration during which the scan clock signal is at a valid level is greater than one row refresh stage H and less than or equal to two row refresh stages H, y may be set to 2 or 3. If the duration during which the scan clock signal is at a valid level is less than or equal to one row refresh stage H, y may be set to 1. In this manner, the start moment of the fourth effective pulse S4 at the reset terminal RST is after the end moment of the effective pulse CG at the scan output terminal GOUT, before the effective pulse in the next transition cycle of the second effective pulse S2 at the stage transfer clock terminal CK_A, and before the effective pulse in the next transition cycle of the third effective pulse S3 at the scan clock terminal CK_B so that the following can be avoided: the stage transfer output terminal NEXT and the scan output terminal GOUT output multiple effective pulses or have voltage spikes during the pixel refresh time of one display frame DF, or the effective pulse CG of the scan signal output from the scan output terminal GOUT is narrower than the third effective pulse S3 of the scan clock signal, affecting the row-by-row refresh of the pixels P.

In an embodiment, y is a positive integer, and y is greater than or equal to the duration during which the scan clock signal is at a valid level divided by the duration of the row refresh stage H, thereby ensuring that the fourth effective pulse S4 at the reset terminal RST does not overlap with the third effective pulse S3 at the scan clock terminal CK_B.

In another embodiment, y is a positive integer, y is less than the stage transfer clock cycle TCA divided by the duration of the row refresh stage H, and/or y is less than the scan clock cycle TCB divided by the duration of the row refresh stage H, thereby preventing a voltage spike from occurring after the effective pulse C0 at the stage transfer output terminal NEXT and preventing a voltage spike from occurring after the effective pulse CG at the scan output terminal GOUT.

In one or more embodiments, y is the maximum integer greater than or equal to n−1 and less than n so that a longer time interval exists between the start moment of the effective pulse C0 at the stage transfer output terminal NEXT and the start moment of the fourth effective pulse S4 at the reset terminal RST in the same shift register unit SP, and the voltage of the first node PU can be reset to an invalid level later. In this manner, the following can be avoided: the voltage of the first node PU is at an invalid level for a long time, and the transistor coupled to the first node PU is in a certain state for a long time, leading to transistor biasing and threshold voltage drift and affecting the stable operation of the circuit.

In one or more embodiments, with continued reference to FIGS. 10, 20, and 21, the effective period of the (j+y)-th stage transfer clock pulse Scka(j+y) does not overlap with the effective period of the j-th scan clock pulse Sckb(j).

In one or more embodiments, with continued reference to FIGS. 10, 20, and 21, the start moment of the (j+y)-th stage transfer clock pulse Scka(j+y) is before the start moment of the (j+n)-th scan clock pulse Sckb(j+n), and/or the start moment of the (j+y)-th stage transfer clock pulse Scka(j+y) is before the start moment of the (j+m)-th stage transfer clock pulse Scka(j+m).

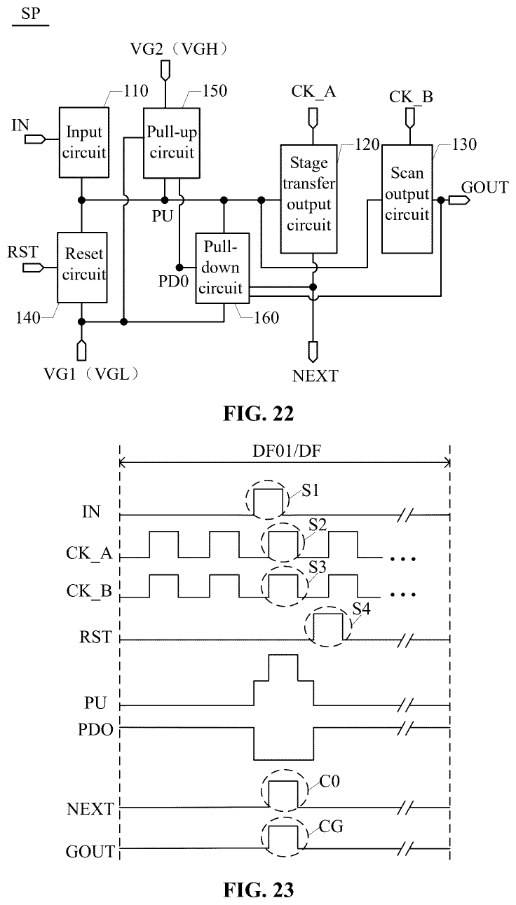

In one or more embodiments, FIG. 22 is schematic diagram four of a circuit structure of a shift register unit according to an embodiment of the present disclosure. Referring to FIG. 22, the shift register unit SP further includes a pull-up circuit 150 and a pull-down circuit 160. The pull-up circuit 150 is electrically connected to the first voltage terminal VG1, a second voltage terminal VG2, the first node PU, and a second node PDO separately. The pull-up circuit 150 is used for controlling the signal at the second node PDO according to the signal at the first node PU. The pull-down circuit 160 is electrically connected to the first voltage terminal VG1, the first node PU, and the second node PDO separately. The pull-down circuit 160 is used for controlling the signal at the first node PU according to the signal at the second node PDO.

For example, the case where the valid levels are all high levels is used as an example, the first voltage terminal VG1 may provide a low-level signal (VGL), and the second voltage terminal VG2 may provide a high-level signal (VGH). FIG. 23 is timing diagram two of a shift register unit according to an embodiment of the present disclosure. Referring to FIGS. 22 and 23, when the input signal at the input terminal IN transitions to a high level, the input circuit 110 may control the voltage of the first node PU to be at a high level. The pull-up circuit 150 may control the voltage of the second node PDO to be at a low level according to the high level of the first node PU. When the voltage of the first node PU is at a low level, the pull-up circuit 150 may pull up the voltage of the second node PDO to a high level according to the low level of the first node PU. Moreover, the pull-down circuit 160 may pull down the voltage of the first node PU to a low level according to the high level of the second node PDO so that the voltage of the first node PU can be stably at a low level.

In one or more embodiments, referring to FIGS. 22 and 23, the pull-down circuit 160 is electrically connected to the stage transfer output terminal NEXT and the scan output terminal GOUT separately. The case where the valid levels are all high levels is used as an example. The pull-down circuit 160 may pull down the voltage of the stage transfer output terminal NEXT to a low level and pull down the voltage of the scan output terminal GOUT to a low level according to the high level of the second node PDO.

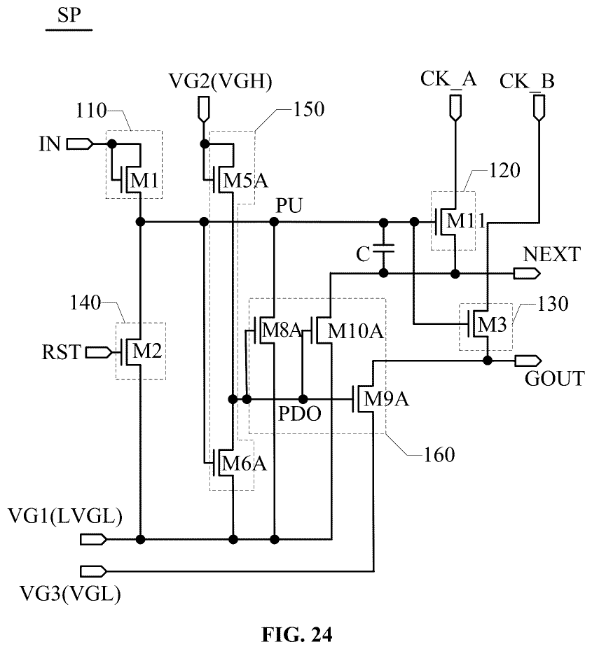

In one or more embodiments, FIG. 24 is schematic diagram five of a circuit structure of a shift register unit according to an embodiment of the present disclosure. Referring to FIG. 24, the pull-up circuit 150 includes a first pull-up control transistor M5A and a first pull-up transistor M6A; the gate and the first electrode of the first pull-up control transistor M5A are both electrically connected to the second voltage terminal VG2, and the second electrode of the first pull-up control transistor M5A is electrically connected to the second node PDO; the gate of the first pull-up transistor M6A is electrically connected to the first node PU, the first electrode of the first pull-up transistor M6A is electrically connected to the first voltage terminal VG1, and the second electrode of the first pull-up transistor M6A is electrically connected to the second node PDO.

The pull-down circuit 160 includes a first node pull-down transistor M8A, a first stage transfer pull-down transistor M10A, and a first scan pull-down transistor M9A, and the gates of the first node pull-down transistor M8A, the first stage transfer pull-down transistor M10A, and the first scan pull-down transistor M9A are all electrically connected to the second node PDO; the first electrode of the first node pull-down transistor M8A is electrically connected to the first voltage terminal VG1, and the second electrode of the first node pull-down transistor M8A is electrically connected to the first node PU; the first electrode of the first stage transfer pull-down transistor M10A is electrically connected to the first voltage terminal VG1, and the second electrode of the first stage transfer pull-down transistor M10A is electrically connected to the stage transfer output terminal NEXT; the first electrode of the first scan pull-down transistor M9A is electrically connected to a third voltage terminal VG3, and the second electrode of the first scan pull-down transistor M9A is electrically connected to the scan output terminal GOUT.

For example, the case where the transistors in the shift register unit SP are all N-type transistors and the valid levels are all high levels is used as an example, the first voltage terminal VG1 and the third voltage terminal VG3 may each provide a low-level signal (VGL), and the second voltage terminal VG2 may provide a high-level signal (VGH). Referring to FIGS. 23 and 24, the first pull-up control transistor M5A may be normally on. When the input signal at the input terminal IN transitions to a high level and the voltage of the first node PU is controlled to be at a high level, the first pull-up transistor M6A is turned on, and the voltage of the second node PDO may be pulled down to the low level of the first voltage terminal VG1. During this stage, the first node pull-down transistor M8A, the first stage transfer pull-down transistor M10A, and the first scan pull-down transistor M9A are all turned off, and the voltages of the first node PU, the stage transfer output terminal NEXT, and the scan output terminal GOUT may be at high levels. When the voltage of the first node PU is at a low level, the first pull-up transistor M6A is turned off, and the first pull-up control transistor M5A may pull up the voltage of the second node PDO to the high level of the second voltage terminal VG2. During this stage, the first node pull-down transistor M8A, the first stage transfer pull-down transistor M10A, and the first scan pull-down transistor M9A are all turned on, and the voltages of the first node PU, the stage transfer output terminal NEXT, and the scan output terminal GOUT are all at low levels.

In addition, the first electrode of the first scan pull-down transistor M9A, which is responsible for pulling down the voltage of the scan output terminal GOUT when the first scan pull-down transistor M9A is turned on, is connected to the third voltage terminal VG3 instead of the first voltage terminal VG1, which is conducive to reducing the fluctuations of the scan signal at the scan output terminal GOUT caused by signal fluctuations and improving the stability and reliability of the circuit.

In an embodiment, the absolute value of the voltage of the third voltage terminal VG3 is less than the absolute value of the voltage of the first voltage terminal VG1.

For example, the transistors in the shift register unit SP are all N-type transistors, the valid level of the stage transfer signal at the stage transfer output terminal NEXT and the valid level of the scan signal at the scan output terminal GOUT are both high levels, and the invalid levels are all low levels; in this case, the voltage of the third voltage terminal VG3 and the voltage of the first voltage terminal VG1 are both at low levels. For example, the signal at the third voltage terminal VG3 may be a normal low-level signal (VGL), the signal at the first voltage terminal VG1 may be an enhanced low-level signal (LVGL), and the voltage of the normal low-level signal (VGL) is greater than the voltage of the enhanced low-level signal (LVGL). In this manner, when the voltage of the second node PDO is at a low level and the first scan pull-down transistor M9A is controlled to be turned off, the gate-source voltage of the first scan pull-down transistor M9A may be less than zero, and the first scan pull-down transistor M9A can be completely turned off, thereby reducing the leakage current, which is conducive to improving the stability of the scan signal at the scan output terminal GOUT.

Similarly, the transistors in the shift register unit SP are all P-type transistors, the valid level of the stage transfer signal at the stage transfer output terminal NEXT and the valid level of the scan signal at the scan output terminal GOUT are both low levels, and the invalid levels are all high levels (not shown in FIGS. 23 and 24); in this case, the voltage of the third voltage terminal VG3 and the voltage of the first voltage terminal VG1 are both at high levels. For example, the signal at the third voltage terminal VG3 may be a normal high-level signal (VGH), the signal at the first voltage terminal VG1 may be an enhanced high-level signal (HVGH), and the voltage of the normal high-level signal (VGH) is greater than the voltage of the enhanced high-level signal (HVGH) so that the first scan pull-down transistor M9A can be completely turned off, thereby reducing the leakage current, which is conducive to improving the stability of the scan signal at the scan output terminal GOUT.

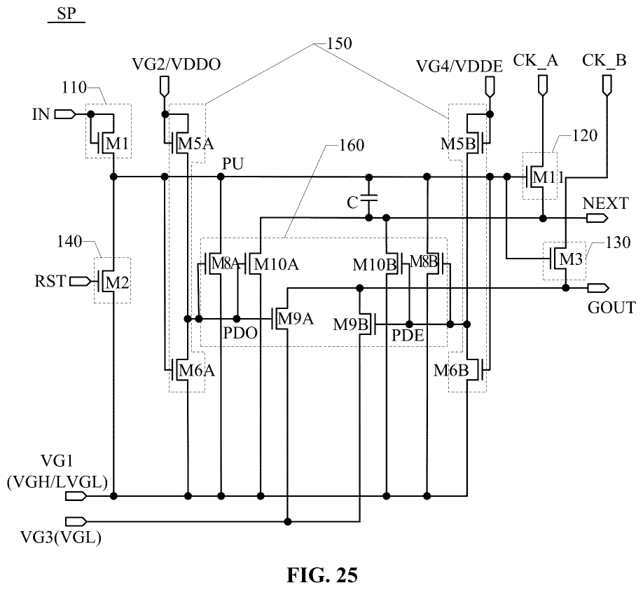

In another embodiment, FIG. 25 is schematic diagram six of a circuit structure of a shift register unit according to an embodiment of the present disclosure. Referring to FIG. 25, the pull-up circuit 150 further includes a second pull-up control transistor M5B and a second pull-up transistor M6B; the gate and the first electrode of the second pull-up control transistor M5B are both electrically connected to a fourth voltage terminal VG4, and the second electrode of the second pull-up control transistor M5B is electrically connected to a third node PDE; the gate of the second pull-up transistor M6B is electrically connected to the first node PU, the first electrode of the second pull-up transistor M6B is electrically connected to the first voltage terminal VG1, and the second electrode of the second pull-up transistor M6B is electrically connected to the third node PDE.

The pull-down circuit 160 further includes a second node pull-down transistor M8B, a second stage transfer pull-down transistor M10B, and a second scan pull-down transistor M9B, and the gates of the second node pull-down transistor M8B, the second stage transfer pull-down transistor M10B, and the second scan pull-down transistor M9B are all electrically connected to the third node PDE; the first electrode of the second node pull-down transistor M8B is electrically connected to the first voltage terminal VG1, and the second electrode of the second node pull-down transistor M8B is electrically connected to the first node PU; the first electrode of the second stage transfer pull-down transistor M10B is electrically connected to the first voltage terminal VG1, and the second electrode of the second stage transfer pull-down transistor M10B is electrically connected to the stage transfer output terminal NEXT; the first electrode of the second scan pull-down transistor M9B is electrically connected to the third voltage terminal VG3, and the second electrode of the second scan pull-down transistor M9B is electrically connected to the scan output terminal GOUT. The phase of the second voltage signal at the second voltage terminal VG2 is opposite to the phase of the fourth voltage signal at the fourth voltage terminal VG4.

For example, the channel types of the second pull-up control transistor M5B and the second pull-up transistor M6B are the same as the channel types of the first pull-up control transistor M5A and the first pull-up transistor M6A, the operating principles of the second pull-up control transistor M5B and the second pull-up transistor M6B are the same as the operating principles of the first pull-up control transistor M5A and the first pull-up transistor M6A, and the second pull-up control transistor M5B and the second pull-up transistor M6B may serve as a replacement group for the first pull-up control transistor M5A and the first pull-up transistor M6A. The channel types of the second node pull-down transistor M8B, the second stage transfer pull-down transistor M10B, and the second scan pull-down transistor M9B are the same as the channel types of the first node pull-down transistor M8A, the first stage transfer pull-down transistor M10A, and the first scan pull-down transistor M9A, the operating principles of the second node pull-down transistor M8B, the second stage transfer pull-down transistor M10B, and the second scan pull-down transistor M9B are the same as the operating principles of the first node pull-down transistor M8A, the first stage transfer pull-down transistor M10A, and the first scan pull-down transistor M9A, and the second node pull-down transistor M8B, the second stage transfer pull-down transistor M10B, and the second scan pull-down transistor M9B may serve as a replacement group for the first node pull-down transistor M8A, the first stage transfer pull-down transistor M10A, and the first scan pull-down transistor M9A.

The case where the transistors in the shift register unit SP are all N-type transistors and the valid levels are all high levels is used as an example. The second voltage terminal VG2 may be connected to a first power supply terminal VDD0, the fourth voltage terminal VG4 may be connected to a second power supply terminal VDDE, and the signal at the first power supply terminal VDD0 and the signal at the second power supply terminal VDDE may alternately be at a high level so that the first group of transistors (M5A, M6A, M8A, M9A, and M10A) and the second group of transistors (M5B, M6B, M8B, M9B, M10B) can be turned on alternately, thereby avoiding the following: the transistors are kept on for a long time, causing hysteresis and threshold voltage drift and affecting the normal operation of the shift register unit SP.

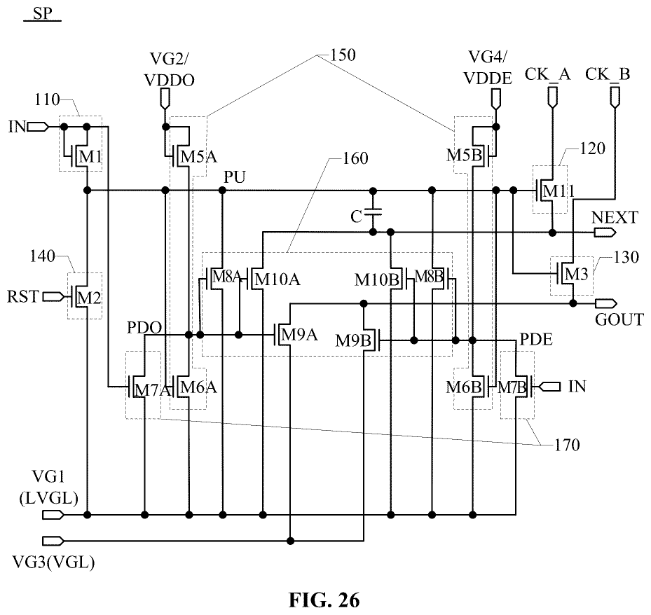

Based on the preceding embodiments, FIG. 26 is schematic diagram seven of a circuit structure of a shift register unit according to an embodiment of the present disclosure. Referring to FIG. 26, the shift register unit SP further includes a noise reduction circuit 170; the noise reduction circuit 170 includes a first noise reduction transistor M7A; the gate of the first noise reduction transistor M7A is electrically connected to the input terminal IN, the first electrode of the first noise reduction transistor M7A is electrically connected to the first voltage terminal VG1, and the second electrode of the first noise reduction transistor M7A is electrically connected to the second node PDO.

For example, the case where the first noise reduction transistor M7A is an N-type transistor and the valid levels are all high levels is used as an example. Referring to FIGS. 23 and 26, when the input signal at the input terminal IN is at a high level and the voltage of the first node PU is controlled to be at a high level, the first noise reduction transistor M7A can be turned on under the control of the high level of the input signal, and the voltage of the second node PDO is pulled down to the low level of the first voltage terminal VG1 so that it is ensured that the transistors in the pull-down circuit 160 are turned off and the voltage of the first node PU is not pulled down, thereby ensuring that the high level of the first node PU is not affected, which is conducive to improving the competitiveness of the first node PU.

In one or more embodiments, referring to FIG. 26, the noise reduction circuit 170 further includes a second noise reduction transistor M7B; the gate of the second noise reduction transistor M7B is electrically connected to the input terminal IN, the first electrode of the second noise reduction transistor M7B is electrically connected to the first voltage terminal VG1, and the second electrode of the second noise reduction transistor M7B is electrically connected to the third node PDE.

For example, the channel type of the second noise reduction transistor M7B is the same as the channel type of the first noise reduction transistor M7A, the operating principle of the second noise reduction transistor M7B is the same as the operating principle of the first noise reduction transistor M7A, and the second noise reduction transistor M7B may serve as a replacement for the first noise reduction transistor M7A.

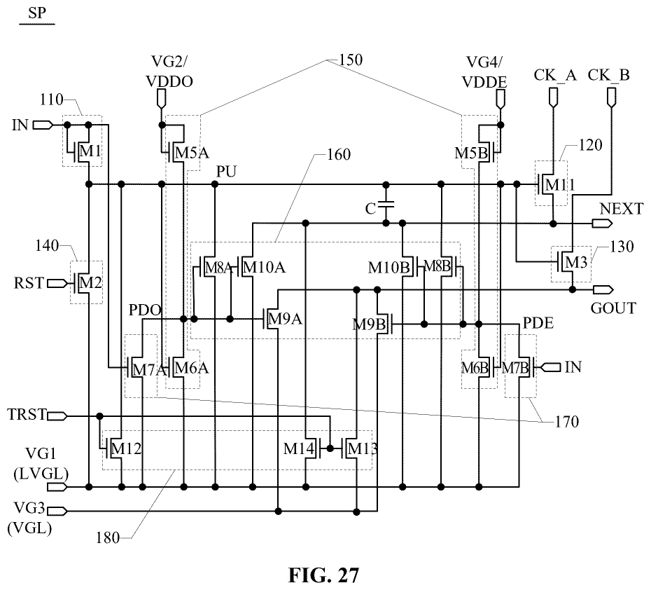

In one or more embodiments, FIG. 27 is schematic diagram eight of a circuit structure of a shift register unit according to an embodiment of the present disclosure. Referring to FIG. 27, the shift register unit SP further includes a restoration circuit 180; the restoration circuit 180 includes a node restoration transistor M12, a stage transfer restoration transistor M14, and a scan restoration transistor M13; the gates of the node restoration transistor M12, the stage transfer restoration transistor M14, and the scan restoration transistor M13 are all electrically connected to a restoration terminal TRST; the first electrode of the node restoration transistor M12 and the first electrode of the stage transfer restoration transistor M14 are both electrically connected to the first voltage terminal VG1, and the first electrode of the scan restoration transistor M13 is electrically connected to the first voltage terminal VG1 or the third voltage terminal VG3; the second electrode of the node restoration transistor M12 is electrically connected to the first node PU, the second electrode of the stage transfer restoration transistor M14 is electrically connected to the stage transfer output terminal NEXT, and the second electrode of the scan restoration transistor M13 is electrically connected to the scan output terminal GOUT.

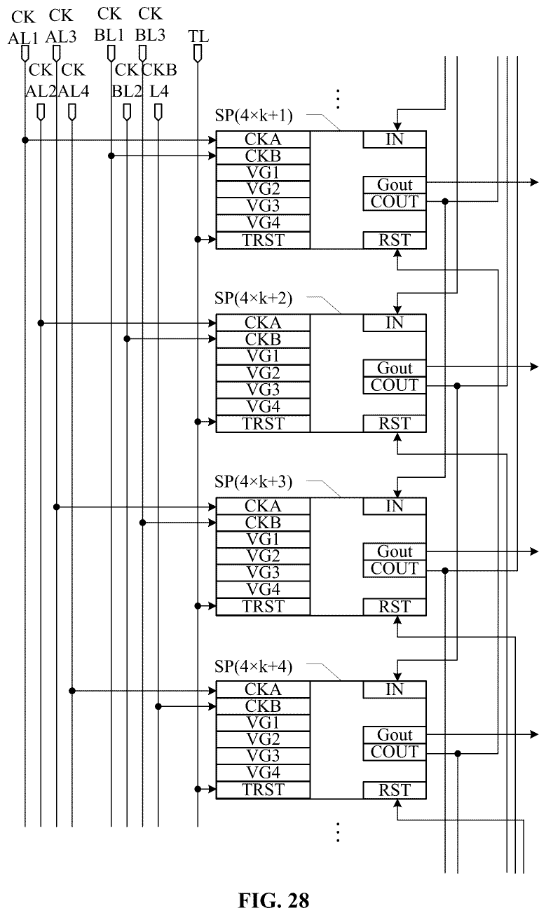

For example, FIG. 28 is schematic diagram five of a circuit structure of a shift register according to an embodiment of the present disclosure. Referring to FIG. 28, the restoration terminals TRST of all the shift register units SP in the shift register VSR may be connected to the same global restoration line TL. After all the shift register units SP in the shift register VSR are driven, or before all the shift register units SP are driven, the restoration circuit 180 can receive the valid levels of the restoration signals at the restoration terminals TRST and control the node restoration transistors M12, the stage transfer restoration transistors M14, and the scan restoration transistors M13 of all the shift register units SP to be turned on to perform a global reset on all the shift register units SP, thereby preventing the shift register from affecting other functions of the display panel, such as gesture detection and touch detection.

In one or more embodiments, the node restoration transistors M12, the stage transfer restoration transistors M14, and the scan restoration transistors M13 of all the shift register units SP may be turned on during the blank time between adjacent display frames or may be turned on after the display panel 001 is powered on and before the display panel 001 is powered off.

In one or more embodiments, the first voltage terminals VG1, the second voltage terminals VG2, the third voltage terminals VG3, or the fourth voltage terminals VG4 of all the shift register units SP in the shift register VSR may be connected to the same signal line to receive the same signal.

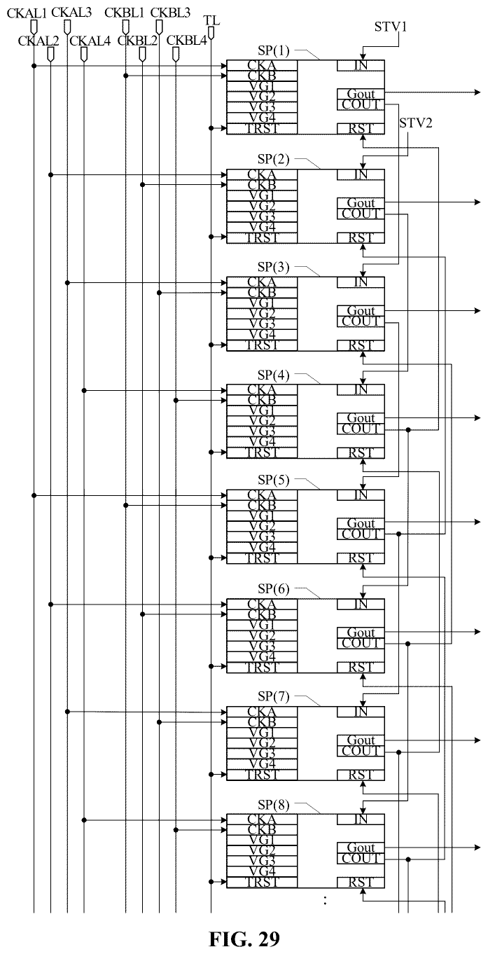

In one or more embodiments, FIG. 29 is schematic diagram six of a circuit structure of a shift register according to an embodiment of the present disclosure. Referring to FIG. 29, the first x shift register units SP receive start signals STV1, . . . , and STVx as input signals, respectively. The setting method for the start signals STV1, . . . , and STVx may include the following: the start signals STV1, . . . , and STVx received by the shift register units SP may be shifted in sequence; or at least two shift register units SP receive the same start signal, for example, STV1 to STVx are the same start signal; or STV1 to STVn are the same start signal and STVn+1 to STVx are the same start signal, where n is a positive integer and 1<n<x; the input signals received by the shift register units SP of all stages except the first x stages are shifted in sequence, and the input terminal IN of the j-th stage shift register unit SP(j) is electrically connected to the stage transfer output terminal NEXT of the (j−x)-th stage shift register unit SP(j−x), where j and x are both positive integers and j>x.

For example, the case where x=2 is used as an example. The first two shift register units SP receive the start signals STV1 and STV2 as input signals, respectively; the start signals STV1 and STV2 may be the same signal, or the start signals STV1 and STV2 may be shifted in sequence; the stage transfer signals at the stage transfer output terminals NEXT of the shift register units SP(1), SP(2), SP(3), SP(4), . . . are shifted in sequence. Starting from the third stage shift register unit SP(3), the input terminal IN of the j-th stage shift register unit SP(j) may be connected to the stage transfer output terminal NEXT of the (j−2)-th stage shift register unit SP(j−2).

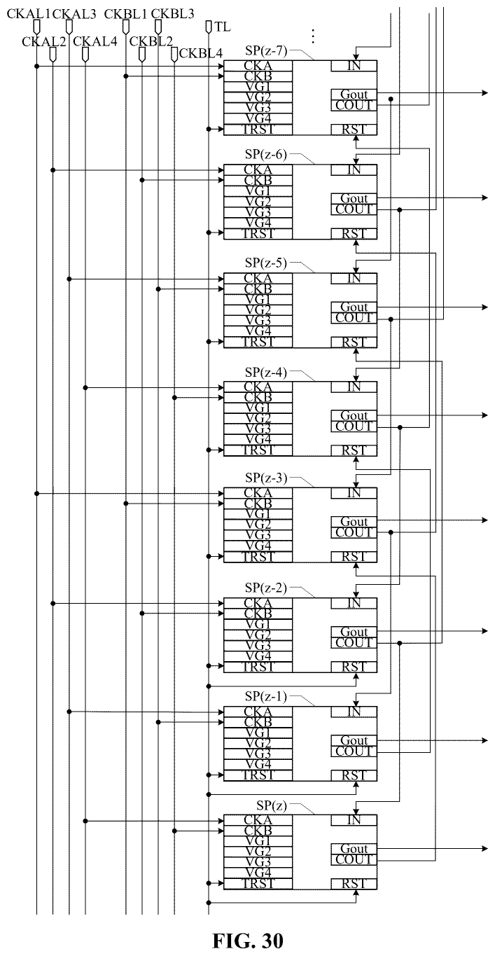

In one or more embodiments, FIG. 30 is schematic diagram seven of a circuit structure of a shift register according to an embodiment of the present disclosure. Referring to FIGS. 27 and 30, the shift register unit SP further includes the reset circuit 140; the reset circuit 140 is electrically connected to the reset terminal RST, the first voltage terminal VG1, and the first node PU separately; the reset circuit 140 is used for controlling, according to the reset signal at the reset terminal RST, the transmission path on which the signal at the first voltage terminal VG1 is transmitted to the first node PU; the reset terminal RST of the j-th stage shift register unit SP(j) is electrically connected to the stage transfer output terminal NEXT of the (j+y)-th stage shift register unit SP(j+y), where j and y are both positive integers. In the shift register VSR, the reset terminals RST of the last y cascaded shift register units SP(z), SP(z−1), . . . , and SP(z−y) are electrically connected to the restoration terminals TRST and receive the restoration signals from the restoration terminals TRST as the reset signals.

For example, the case where the shift register VSR includes z shift register units SP and y=3 is used as an example. Referring to FIGS. 27 and 30, for the first z−3 shift register units SP(1), . . . , and SP(z−3), the reset terminal RST of the j-th stage shift register unit SP(j) may be connected to the stage transfer output terminal NEXT of the (j+3)-th stage shift register unit SP(j+3); the reset terminal RST of each of the last three shift register units SP(z), SP(z−1), and SP(z−2) may be connected to the restoration terminal TRST in the same shift register unit SP and may receive the restoration signal as the reset signal. In this manner, an auxiliary shift register unit or an auxiliary circuit for providing the reset signals for the last y shift register units SP does not need to be provided after the z-th stage shift register unit SP(z), which is conducive to simplifying the timing and circuit.

Based on the preceding embodiments, during the pixel refresh time of one display frame, the start moment of the effective pulse of the restoration signal is after the effective pulse of the stage transfer signal output from the stage transfer output terminal NEXT of the last stage shift register unit SP(z); and/or the start moment of the effective pulse of the restoration signal is after the effective pulse of the scan signal output from the scan output terminal GOUT of the last stage shift register unit SP(z). In this manner, the restoration signals can replace the reset signals of the last y shift register units SP to reset the shift register units SP after the shift register units SP output the effective pulses of the stage transfer signals and the effective pulses of the scan signals.

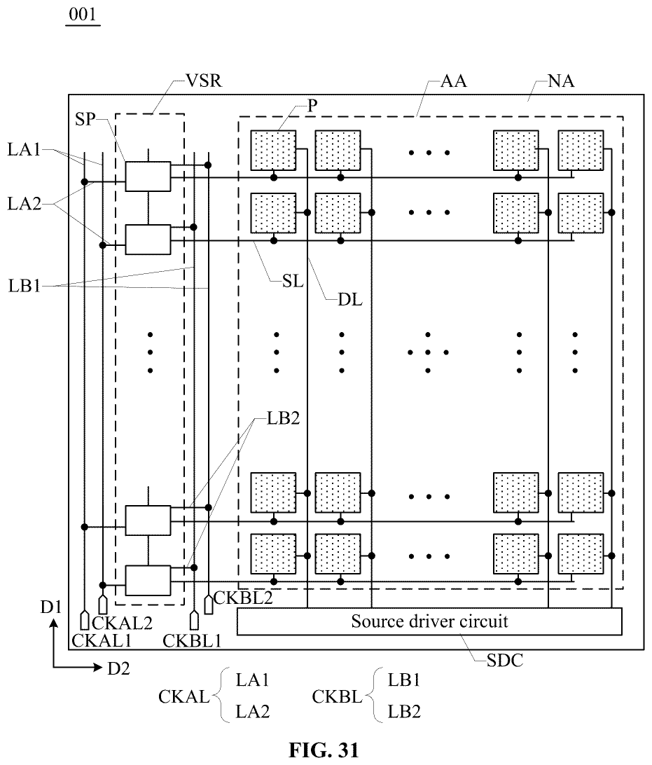

In one or more embodiments, FIG. 31 is top diagram two of a display panel according to an embodiment of the present disclosure. Referring to FIG. 31, in the same shift register VSR, multiple cascaded shift register units SP are arranged along a first direction D1; the stage transfer clock lines CKAL include a first stage transfer wire portion LA1 extending along the first direction D1 and a second stage transfer wire portion LA2 extending along a second direction D2; the scan clock lines CKBL include a first scan wire portion LB1 extending along the first direction D1 and a second scan wire portion LB2 extending along the second direction D2; the second direction D2 intersects with the first direction D1; both the first direction D1 and the second direction D2 are parallel to the plane where the display panel 001 is located.

For example, the case where the first direction D1 is the column direction and the second direction D2 is the row direction is used as an example. Referring to FIG. 31, the shift register VSR is located in the non-display region on one side of the display region AA. Multiple cascaded shift register units SP may be arranged along the column direction. The stage transfer clock lines CKAL include the first stage transfer wire portion LA1 extending along the column direction and the second stage transfer wire portion LA2 extending along the row direction. The scan clock lines CKBL include the first scan wire portion LB1 extending along the column direction and the second scan wire portion LB2 extending along the row direction.

In one or more embodiments, with continued reference to FIG. 31, the first stage transfer wire portion LA1 and the first scan wire portion LB1 are arranged along the second direction D2; the first stage transfer wire portion LA1 of the stage transfer clock lines CKAL and the first scan wire portion LB1 of the scan clock lines CKBL are located on two opposite sides of the shift register VSR.

For example, the stage transfer clock lines CKAL and the scan clock lines CKBL are located on the same side of the display region AA, but on different sides of the shift register VSR. Along the second direction D2, the stage transfer clock lines CKAL, the shift register VSR, and the scan clock lines CKBL are arranged in sequence. In FIG. 31, the case where the stage transfer clock lines CKAL are located on one side of the shift register VSR facing away from the display region AA, and the scan clock lines CKBL are located on one side of the shift register VSR facing the display region AA is used as an example. In other embodiments, the position of the stage transfer clock lines CKAL and the position of the scan clock lines CKBL can be swapped, that is, the scan clock lines CKBL are disposed on one side of the shift register VSR facing away from the display region AA, while the stage transfer clock lines CKAL are disposed on one side of the shift register VSR facing the display region AA. The first stage transfer wire portion LA1 and the first scan wire portion LB1 are located on two opposite sides of the shift register VSR so that the first stage transfer wire portion LA1 and the first scan wire portion LB1, which both extend along the first direction, are farther apart. Moreover, the shift register VSR may be used to form a physical barrier, which is conducive to reducing the signal interference between the first stage transfer wire portion LA1 and the first scan wire portion LB1, thereby avoiding the following: coupling of transitions in the stage-transfer clock signal into the scan clock signal, causing fluctuations of the scan clock signal, affecting the stability of the scan signal, resulting in erroneous refresh of some pixels P or premature stop of refresh, and leading to display distortion.

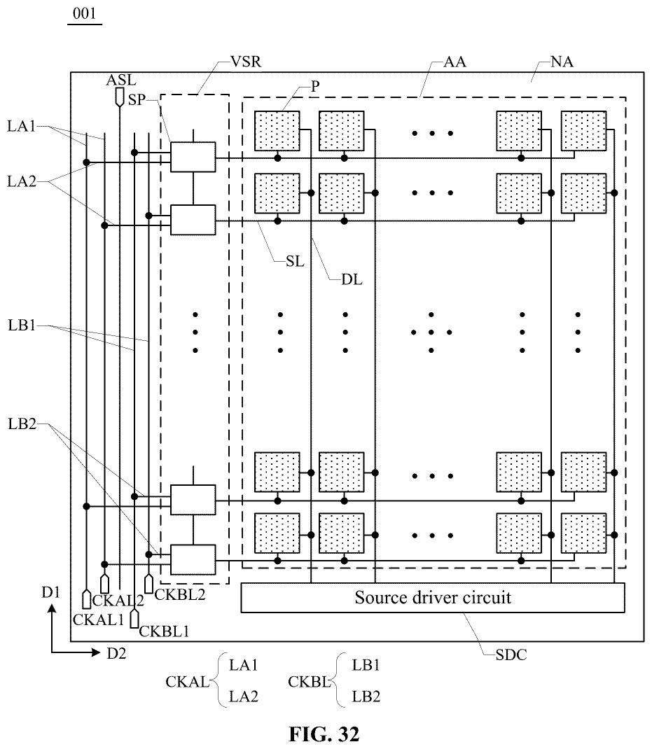

In one or more embodiments, FIG. 32 is top diagram three of a display panel according to an embodiment of the present disclosure. Referring to FIG. 32, the first stage transfer wire portion LA1 of the stage transfer clock lines CKAL and the first scan wire portion LB1 of the scan clock lines CKBL are located on the same side of the shift register VSR; the display panel further includes an auxiliary line ASL extending along the first direction D1; the first stage transfer wire portion LA1 and the first scan wire portion LB1 are located on two opposite sides of the auxiliary line ASL. In FIG. 32, the case where the scan clock lines CKBL are located between the stage transfer clock lines CKAL and the shift register VSR is used as an example. In other configurations, the position of the scan clock lines CKBL and the position of the stage transfer clock lines CKAL can be swapped, that is, the stage transfer clock lines CKAL are located between the scan clock lines CKBL and the shift register VSR.

For example, along the second direction D2 parallel to the plane where the display panel 001 is located, the first stage transfer wire portion LA1 of the stage transfer clock lines CKAL and the first scan wire portion LB1 of the scan clock lines CKBL are located on the same side of the shift register VSR; and along the second direction D2 parallel to the plane where the display panel 001 is located, the first stage transfer wire portion LA1 and the first scan wire portion LB1 are located on two opposite sides of the auxiliary line ASL, and the auxiliary line ASL may be used to form a physical barrier to reduce the signal interference between the first stage transfer wire portion LA1 and the first scan wire portion LB1.

In an embodiment, the auxiliary line ASL is used for transmitting a constant voltage signal; or the auxiliary line ASL is used for transmitting a function signal, which is a constant voltage signal at least during the pixel refresh time of the display frame DF; or the auxiliary line ASL is floating and not connected to other signal terminals.

For example, the auxiliary line ASL may be grounded, electrically connected to the first voltage terminals VG1 of the shift register units SP, or connected to a common voltage signal terminal so that the voltage on the auxiliary line ASL is constant, thereby reducing parasitic capacitive coupling between the first stage transfer wire portion LA1 and the first scan wire portion LB1 and achieving signal shielding; or the auxiliary line ASL may also serve as a global restoration line or a field synchronization signal line in the display panel 001, which is a signal line for transmitting a constant voltage signal during the pixel refresh time of the display frame DF, that is, during the stage when the shift register units SP output the effective pulses of the stage transfer signals and/or the effective pulses of the scan signals, thereby achieving signal shielding.

In another embodiment, the auxiliary line ASL is electrically connected to the shift register units SP.

Specifically, the auxiliary line ASL located between the first stage transfer wire portion LA1 and the first scan wire portion LB1 may also serve as a signal line electrically connected to the shift register units SP, or the signal line electrically connected to the shift register units SP may be disposed between the first stage transfer wire portion LA1 and the first scan wire portion LB1 and may serve as the auxiliary line ASL. In this manner, the number of wires in the display panel 001 can be reduced and the layout design can be simplified.

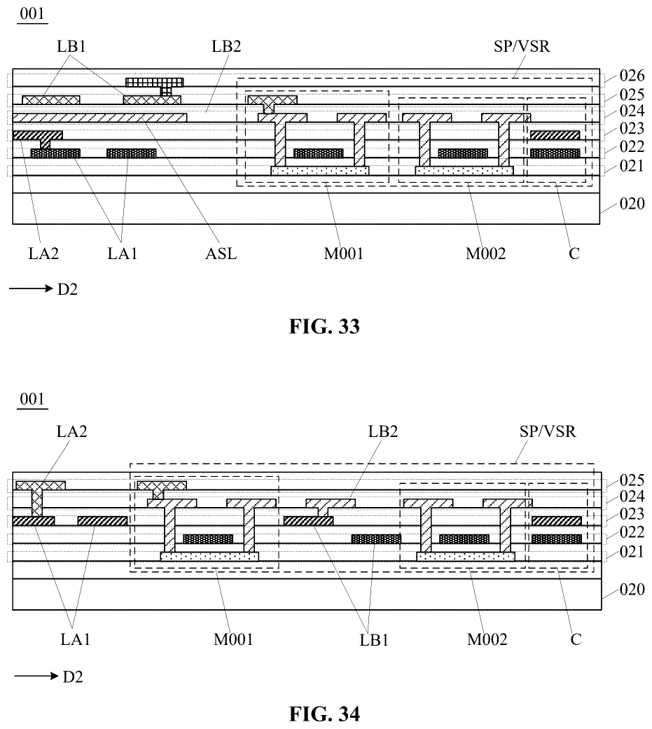

Based on the preceding embodiments, FIG. 33 is schematic diagram one of a film structure of a display panel according to an embodiment of the present disclosure. Referring to FIG. 33, the display panel 001 includes a substrate 020 and multiple conductive layers (021, 022, 023, 024, 025, and 026) located on one side of the substrate 020. Along the second direction D2 parallel to the plane where the substrate 020 is located, the first stage transfer wire portion LA1 of the stage transfer clock lines CKAL and the first scan wire portion LB1 of the scan clock lines CKBL are located on the same side of the shift register VSR. Along the direction perpendicular to the plane where the substrate 020 is located, the first stage transfer wire portion LA1 and the first scan wire portion LB1 are located on two opposite sides of the auxiliary line ASL.

For example, along the direction perpendicular to the plane where the substrate 020 is located, the projection of the first stage transfer wire portion LA1 on the plane where the substrate 020 is located overlaps with the projection of the first scan wire portion LB1 on the plane where the substrate 020 is located, and the overlapping region overlaps with the projection of the auxiliary line ASL on the plane where the substrate 020 is located. In this manner, the auxiliary line ASL can be used to form a physical barrier to reduce the signal interference between the first stage transfer wire portion LA1 and the first scan wire portion LB1. Moreover, the dimension occupied by the stage transfer clock lines CKAL and the scan clock lines CKBL along the second direction D2 parallel to the plane where the substrate 020 is located can be reduced, which is conducive to improving the integration of the display panel 001.

In an embodiment, the display panel 001 includes the substrate 020, a semiconductor layer 021, a gate layer 022, a capacitor layer 023, a source/drain electrode layer 024, a first overlapping layer 025, a second overlapping layer 026, and insulating layers; the insulating layers are disposed adjacent to the conductive layers (021, 022, 023, 024, 025, and 026); the conductive layers and the insulating layers are located on one side of the substrate 020.

For example, the first stage transfer wire portion LA1 of the stage transfer clock lines CKAL may be located in the gate layer 022, the second stage transfer wire portion LA2 of the stage transfer clock lines CKAL may be located in the capacitor layer 023, the auxiliary line ASL may be located in the source/drain electrode layer 024, the first scan wire portion LB1 of the scan clock lines CKBL may be located in the first overlapping layer 025, and the second scan wire portion LB2 of the scan clock lines CKBL may be located in the second overlapping layer 026.

In one or more embodiments, FIG. 34 is schematic diagram two of a film structure of a display panel according to an embodiment of the present disclosure. Referring to FIG. 34, the shift register unit SP includes a first transistor M001 and a second transistor M002. The first transistor M001 and the second transistor M002 in the same shift register unit SP are arranged along the second direction. The first stage transfer wire portion LA1 of the stage transfer clock lines CKAL is at least partially located between the first transistor M001 and the second transistor M002 in the same shift register unit SP, or the first scan wire portion LB1 of the scan clock lines CKBL is at least partially located between the first transistor M001 and the second transistor M002 in the same shift register unit SP.

For example, along the second direction D2 parallel to the plane where the display panel 001 is located, the first stage transfer wire portion LA1 of the stage transfer clock lines CKAL may be located on the same side of the first transistor M001 and the second transistor M002 and closer to the first transistor M001; and the first scan wire portion LB1 of the scan clock lines CKBL may be located between the first transistor M001 and the second transistor M002. In this manner, the first transistor M001 may be used to form a physical barrier to reduce the signal interference between the first stage transfer wire portion LA1 and the first scan wire portion LB1 without the need for an additional auxiliary line. Moreover, at least part of the wire portions (LA1 and/or LA2) of the stage transfer clock lines CKAL and at least part of the wire portions (LB1 and/or LB2) of the scan clock lines CKBL may be disposed in the same layer, which is conducive to reducing the number of films and processes and lowering the manufacturing costs.

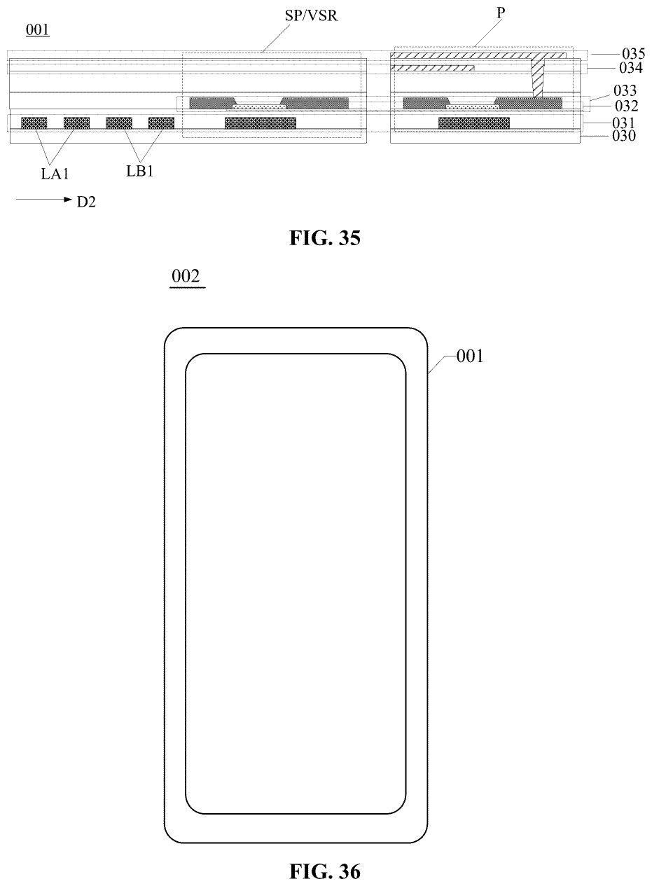

In one or more embodiments, FIG. 35 is schematic diagram three of a film structure of a display panel according to an embodiment of the present disclosure. Referring to FIG. 35, the left figure is a schematic diagram of the film structure of the non-display region, and the right figure is a schematic diagram of the film structure of the pixel P. The film structure of the display panel may include a substrate 030, a gate metal layer 031, an active layer 032, a source/drain metal layer 033, a first transparent metal layer 034, and a second transparent metal layer 035. The gate metal layer 031 may include the gate of the thin-film transistor in the display panel, the scan line located in the display region AA, and the like. In the left figure, the first stage transfer wire portion LA1 and the first scan wire portion LB1 are both located in the gate metal layer 031. The active layer 032 may include the active pattern of the thin-film transistor in the display panel. The source/drain metal layer 033 may include the source pattern, the drain pattern, and the data line of the thin-film transistor in the display panel. The first transparent metal layer 034 may include a common electrode. The second transparent metal layer 035 may include a pixel electrode. In addition, the display panel further includes insulating layers, each of which is located between two of the preceding films. FIG. 35 shows the example in which the first stage transfer wire portion LA1 and the first scan wire portion LB1 are located on the same side of the shift register VSR in the second direction D2. In other embodiments, the first stage transfer wire portion LA1 and the first scan wire portion LB1 may be located on two opposite sides of the shift register VSR, or one of the first stage transfer wire portion LA1 and the first scan wire portion LB1 may pass through the shift register VSR.

Based on the same disclosed concept, embodiments of the present disclosure further provide a display device. FIG. 36 is a structural view of a display device according to an embodiment of the present disclosure. As shown in FIG. 36, a display device 002 includes the display panel 001 provided in any embodiment of the present disclosure. The display device 002 provided in the embodiments of the present disclosure may be a mobile phone shown in FIG. 36 or may be any electronic product having a display function. The electronic product includes, but is not limited to, a television, a laptop, a desktop display, a tablet computer, a digital camera, a smart bracelet, smart glasses, a vehicle-mounted display, a medical device, an industrial control device, or a touch interactive terminal, which is not specially limited in the embodiments of the present disclosure.

It is to be noted that the preceding are only preferred embodiments of the present disclosure and the technical principles used therein. It is to be understood by those skilled in the art that the present disclosure is not limited to the embodiments described herein. For those skilled in the art, various apparent modifications, adaptations, and substitutions can be made without departing from the scope of the present disclosure. Therefore, while the present disclosure is described in detail in conjunction with the preceding embodiments, the present disclosure is not limited to the preceding embodiments and may include other equivalent embodiments without departing from the concept of the present disclosure. The scope of the present disclosure is determined by the scope of the appended claims.

What is claimed is:

1. A display panel, comprising a shift register, a plurality of stage transfer clock lines, and a plurality of scan clock lines, wherein the shift register comprises a plurality of cascaded shift register units, a stage transfer clock line of the plurality of stage transfer clock lines is configured to transmit a stage transfer clock signal, and a scan clock line of the plurality of scan clock lines is configured to transmit a scan clock signal;
wherein a shift register unit of the plurality of cascaded shift register units comprises an input circuit, a stage transfer output circuit, and a scan output circuit;
wherein the input circuit is electrically connected to an input terminal and a first node separately, and the input circuit is configured to control a signal at the first node according to an input signal at the input terminal;
the stage transfer output circuit is electrically connected to the first node, a stage transfer clock terminal, and a stage transfer output terminal separately, and the stage transfer output circuit is configured to control, according to the signal at the first node and a signal at the stage transfer clock terminal, a stage transfer signal output from the stage transfer output terminal, wherein the stage transfer output terminal of the i-th stage shift register unit is electrically connected to the input terminal of the j-th stage shift register unit, i≠j, and i and j are both positive integers; and
the scan output circuit is electrically connected to the first node, a scan clock terminal, and a scan output terminal separately, and the scan output circuit is configured to control, according to the signal at the first node and a signal at the scan clock terminal, a scan signal output from the scan output terminal;
wherein the stage transfer clock terminal is electrically connected to a stage transfer clock line of the plurality of stage transfer clock lines, and the scan clock terminal is electrically connected to a scan clock line of the plurality of scan clock lines.

2. The display panel of claim 1, wherein the display panel supports a multi-frequency drive display mode;
wherein the multi-frequency drive display mode comprises a plurality of display cycles, and a display cycle of the plurality of display cycles comprises a first display frame and a second display frame;
wherein during a portion of pixel refresh time of the second display frame, scan clock signals transmitted on the plurality of scan clock lines comprise effective pulses; and during another portion of the pixel refresh time of the second display frame, the scan clock signals transmitted on the plurality of scan clock lines are all at invalid levels.

3. The display panel of claim 2, wherein pixel refresh time of the second display frame comprises a first period, a second period, and a third period, wherein the first period is before the second period, and the third period is after the second period;
wherein the display panel comprises a first display region, a second display region, and a third display region; in an f-th period, a stage transfer signal output from a shift register unit connected to a pixel circuit in an f-th display region comprises a valid level; wherein f is a positive integer less than or equal to 3;
wherein in the display cycle, the display panel further comprises a low-frequency display region; wherein the low-frequency display region comprises the f-th display region, and in the f-th period, the scan clock signals transmitted on the plurality of scan clock lines are all at invalid levels; and/or the low-frequency display region comprises a z-th display region, and in a z-th period, the scan clock signals transmitted on the plurality of scan clock lines are all at invalid levels, wherein z is a positive integer less than or equal to 3, and z≠f.

4. The display panel of claim 1, wherein during pixel refresh time of one display frame, in at least some of the plurality of cascaded shift register units, the input signal received by the input terminal comprises a first effective pulse, the stage transfer clock signal received by the stage transfer clock terminal comprises a second effective pulse, and the scan clock signal received by the scan clock terminal comprises a third effective pulse;
wherein during the pixel refresh time of one display frame, in a same shift register unit receiving the third effective pulse, a start moment of the first effective pulse is before a start moment of the second effective pulse, and the start moment of the first effective pulse is before a start moment of the third effective pulse.

5. The display panel of claim 4, wherein during the pixel refresh time of one display frame, in the same shift register unit receiving the third effective pulse, an effective period of the second effective pulse and an effective period of the third effective pulse at least partially overlap.

6. The display panel of claim 1, wherein
the stage transfer output circuit comprises a stage transfer output transistor, wherein a gate of the stage transfer output transistor is electrically connected to the first node, a first electrode of the stage transfer output transistor is electrically connected to the stage transfer clock terminal, and a second electrode of the stage transfer output transistor is electrically connected to the stage transfer output terminal;
the scan output circuit comprises a scan output transistor, wherein a gate of the scan output transistor is electrically connected to the first node, a first electrode of the scan output transistor is electrically connected to the scan clock terminal, and a second electrode of the scan output transistor is electrically connected to the scan output terminal; and
the shift register unit further comprises a capacitor, wherein a first electrode of the capacitor is electrically connected to the first node, and a second electrode of the capacitor is electrically connected to the stage transfer output terminal.

7. The display panel of claim 6, wherein a channel width of the scan output transistor is greater than a channel width of the stage transfer output transistor.

8. The display panel of claim 1, wherein an absolute value of a valid level of the stage transfer clock signal received by the stage transfer clock terminal is greater than an absolute value of a valid level of the scan clock signal received by the scan clock terminal.

9. The display panel of claim 1, wherein the shift register is electrically connected to m stage transfer clock lines and n scan clock lines, wherein m and n are both positive integers;
wherein the stage transfer clock terminal of the (m×k+w)-th stage shift register unit is electrically connected to the w-th stage transfer clock line; and
the scan clock terminal of the (n×k+q)-th stage shift register unit is electrically connected to the q-th scan clock line;
wherein k is 0 or a positive integer, w is a positive integer less than or equal to m, and q is a positive integer less than or equal to n.

10. The display panel of claim 9, wherein the display panel satisfies one of the following conditions:
m=n, and the scan clock terminal of the (m×k+w)-th stage shift register unit is electrically connected to a w-th scan clock line;
or m=n×2, and the scan clock terminal of the (m×k+q)-th stage shift register unit and the scan clock terminal of the (m×k+q+n)-th stage shift register unit are electrically connected to the q-th scan clock line;
or m×2=n, and the stage transfer clock terminal of the (n×k+w)-th stage shift register unit and the stage transfer clock terminal of the (n×k+w+m)-th stage shift register unit are electrically connected to the w-th stage transfer clock line;
or n>m; and in m×n continuously cascaded shift register units, a same stage transfer clock line is connected to n shift register units, and a same scan clock line is connected to m shift register units.

11. The display panel of claim 9, wherein an effective duration of an effective pulse of the stage transfer clock signal is greater than or equal to an effective duration of an effective pulse of the scan clock signal.

12. The display panel of claim 9, wherein
during at least part of pixel refresh time of a display frame, in a stage transfer clock line and a scan clock line connected to the j-th stage shift register unit, an effective pulse of a stage transfer clock signal overlapping with an effective pulse of a stage transfer signal output by the j-th stage shift register unit is a j-th stage transfer clock pulse, and an effective pulse of a scan clock signal overlapping with an effective pulse of a scan signal output by the j-th stage shift register unit is a j-th scan clock pulse, wherein j is a positive integer;
wherein a start moment of the j-th stage transfer clock pulse is before a start moment of the j-th scan clock pulse, and/or an end moment of the j-th stage transfer clock pulse is after an end moment of the j-th scan clock pulse.

13. The display panel of claim 12, wherein
in the stage transfer clock line and the scan clock line connected to the j-th stage shift register unit, an effective period of the j-th stage transfer clock pulse of the stage transfer clock signal overlaps with an effective period of the j-th scan clock pulse of the scan clock signal, and the effective period of the j-th stage transfer clock pulse of the stage transfer clock signal also overlaps with an effective period of a next clock cycle of the j-th scan clock pulse of the scan clock signal;
wherein the shift register unit further comprises a reset circuit;
wherein the reset circuit is electrically connected to a reset terminal, a first voltage terminal, and the first node separately, and the reset circuit is configured to control, according to a reset signal at the reset terminal, a transmission path on which a signal at the first voltage terminal is transmitted to the first node;
wherein a start moment of an effective pulse of the reset signal at the reset terminal of the shift register unit overlaps with an effective pulse of a stage transfer clock signal connected to the shift register unit; and
a start moment of an effective pulse of the reset signal at the reset terminal of the j-th stage shift register unit is before a second effective pulse overlapping with the j-th stage transfer clock pulse in the scan clock line connected to the j-th stage shift register unit.

14. The display panel of claim 9, wherein
clock cycles of stage transfer clock signals transmitted on the plurality of stage transfer clock lines are the same; and clock cycles of scan clock signals transmitted on the plurality of scan clock lines are the same;
wherein a ratio of a clock cycle of the stage transfer clock signal to a clock cycle of the scan clock signal is m/n.

15. The display panel of claim 1, wherein the shift register is electrically connected to m stage transfer clock lines and n scan clock lines, wherein m and n are both positive integers;
effective pulses of stage transfer clock signals transmitted on the m stage transfer clock lines are shifted in sequence; pixel refresh time of one display frame comprises a plurality of stage transfer clock cycles, and in a stage transfer clock cycle of the plurality of stage transfer clock cycles, the stage transfer clock signals on the m stage transfer clock lines switch to a valid level in sequence; and
effective pulses of scan clock signals transmitted on the n scan clock lines are shifted in sequence; the pixel refresh time of one display frame comprises at least one scan clock cycle, and in a scan clock cycle of the at least one scan clock cycle, the scan clock signals on the n scan clock lines switch to a valid level in sequence.

16. The display panel of claim 15, wherein m<n; and
the stage transfer clock cycle is less than or equal to the scan clock cycle.

17. The display panel of claim 15, wherein m>n; and
the stage transfer clock cycle is greater than the scan clock cycle.

18. The display panel of claim 17, wherein
a duty cycle of the stage transfer clock signal is equal to a duty cycle of the scan clock signal, and a duration of an effective pulse of the stage transfer clock signal is greater than a duration of an effective pulse of the scan clock signal.

19. The display panel of claim 1, wherein the shift register unit further comprises a pull-up circuit and a pull-down circuit;
wherein the pull-up circuit is electrically connected to a first voltage terminal, a second voltage terminal, the first node, and a second node separately, and the pull-up circuit is configured to control a signal at the second node according to the signal at the first node; and
the pull-down circuit is electrically connected to the first voltage terminal, the first node, and the second node separately, and the pull-down circuit is configured to control the signal at the first node according to the signal at the second node,
wherein the pull-up circuit comprises a first pull-up control transistor and a first pull-up transistor; a gate and a first electrode of the first pull-up control transistor are both electrically connected to the second voltage terminal, and a second electrode of the first pull-up control transistor is electrically connected to the second node; and a gate of the first pull-up transistor is electrically connected to the first node, a first electrode of the first pull-up transistor is electrically connected to the first voltage terminal, and a second electrode of the first pull-up transistor is electrically connected to the second node; and
the pull-down circuit comprises a first node pull-down transistor, a first stage transfer pull-down transistor, and a first scan pull-down transistor, and gates of the first node pull-down transistor, the first stage transfer pull-down transistor, and the first scan pull-down transistor are all electrically connected to the second node; a first electrode of the first node pull-down transistor is electrically connected to the first voltage terminal, and a second electrode of the first node pull-down transistor is electrically connected to the first node; a first electrode of the first stage transfer pull-down transistor is electrically connected to the first voltage terminal, and a second electrode of the first stage transfer pull-down transistor is electrically connected to the stage transfer output terminal; and a first electrode of the first scan pull-down transistor is electrically connected to a third voltage terminal, and a second electrode of the first scan pull-down transistor is electrically connected to the scan output terminal,
wherein a voltage absolute value of the third voltage terminal is less than a voltage absolute value of the first voltage terminal.

20. A display device, comprising a display panel,
wherein the display panel comprises a shift register, a plurality of stage transfer clock lines, and a plurality of scan clock lines, wherein the shift register comprises a plurality of cascaded shift register units, a stage transfer clock line of the plurality of stage transfer clock lines is configured to transmit a stage transfer clock signal, and a scan clock line of the plurality of scan clock lines is configured to transmit a scan clock signal;
wherein a shift register unit of the plurality of cascaded shift register units comprises an input circuit, a stage transfer output circuit, and a scan output circuit;
wherein the input circuit is electrically connected to an input terminal and a first node separately, and the input circuit is configured to control a signal at the first node according to an input signal at the input terminal;
the stage transfer output circuit is electrically connected to the first node, a stage transfer clock terminal, and a stage transfer output terminal separately, and the stage transfer output circuit is configured to control, according to the signal at the first node and a signal at the stage transfer clock terminal, a stage transfer signal output from the stage transfer output terminal, wherein the stage transfer output terminal of the i-th stage shift register unit is electrically connected to the input terminal of the j-th stage shift register unit, i≠j, and i and j are both positive integers; and
the scan output circuit is electrically connected to the first node, a scan clock terminal, and a scan output terminal separately, and the scan output circuit is configured to control, according to the signal at the first node and a signal at the scan clock terminal, a scan signal output from the scan output terminal;
wherein the stage transfer clock terminal is electrically connected to a stage transfer clock line of the plurality of stage transfer clock lines, and the scan clock terminal is electrically connected to a scan clock line of the plurality of scan clock lines.
